(19) United States
(12) Patent Application Publication
(10) Pub. No.: US 2012/0082283 A1
(43) Pub. Date: Apr. 5, 2012

(54) Method of using micro-nano-hetro structures to make radiation detection systems and devices with applications

(75) Inventor: Liviu Popa-Simil, Los Alamos, NM (US)

(73) Assignee: Liviu Popa-Simil, Los Alamos, NM (US)

(21) Appl. No.: 12/924,577

(22) Filed: Sep. 30, 2010

(51) Int. Cl. G21C 17/00; G21D 7/00

(52) U.S. Cl. 376/245; 376/317

(57) ABSTRACT

Method and devices for development of nuclear particle detectors, meant to operate in wide temperature range, with and without cooling that can be integrated in various arrays, able to identify radiation type and provide information on it's parameters as position, mass, energy, direction. The device will operate by enhancing the radiation detection by using materials that generates fission, transmutation and/or directly converting the energy of radiation into photonic or pressure waves, or into electricity, device acting on a plurality of conductor insulator junction making it able to identify radiation type, spectrum, direction and position usable for a large range of electronics from detectors to complex imagers.

The method relies on an assembly of three components with generic function as generator, insulator and absorber, in different aggregation states, dimensioned by calculating the effective length for the specific moving entity i.e. fission products, charged particles, recoiled nuclei, driving to a wide range of micro-nano-hetero structures and applications. The resulted devices are structural and dimensional varieties of method's application in specific configurations. Applications are in thermal nuclear fission reactors, non-proliferation, radioactive fields measurements, space. Liquid materials are used inside the device to serve as damage free absorbers detection scintillation restorer, and carriers of resulted fission products and transmutation nuclei draining them out the reactor's active zone into specialized measurement devices. The electricity generator device uses repetitive nano-hetero-structure generically called “CIci”, and may be used in combinations.

### CROSS REFERENCE TO RELATED APPLICATIONS

This application claims the benefit of U.S. Provisional Application No. 60/748,489, filed on Dec. 7, 2005, which is hereby incorporated by reference in its entirety.

### BACKGROUND

The development of the nuclear energy brings the need for better radiation detection and control. The application of the method of controlling the radiation brings significant advantages in using the same hetro-structures in detecting and controlling various types of radiation. The non-proliferation and safe guards applications require better faster and more sensitive measuring equipments in order to assure the peaceful applications of nuclear power.

FIG. 1A shows an exemplary plot of fission yield as a function of mass number for fission of ²³⁵U, ²³⁸Np, ²³⁹Pu, ^{242m}Am, ²⁴⁵Cm, ²⁴⁹Cf. The horizontal axis represents the mass number of fission products, while the vertical axis indicates the abundance of the fission products. Typically, a thermal neutron with energy of 0.253 eV collides with a uranium-235 nucleus. Then, the compound uranium-236 nucleus splits in two median mass nuclei and typically releases 2 to 3 neutrons as well as energy. When a fast neutron collides a ²³⁵U it induces fission or spallation and the resultant products distribution modifies a little bit showing a “spallation tail”. The process releases more than too neutrons, up to 10 fast neutrons for the fast neutron fission and up to 50 neutrons for spallation. Fast protons, muons, also induce spallation. The released energy may total to around 203 MeV per disintegration: the kinetic energies of 167 MeV and 8 MeV of the fission products and neutrons, respectively, and prompt gamma emission energy of 8 MeV. If the incident particles neutron or charged particle brings more energy the total released energy is higher because of conservation laws applied in the process kinematics and dynamics. As depicted in FIG. 1, the fission yield curve 10 in semi-logarithmic scale shows that the distribution of fission product abundance is symmetrical with respect to the median mass. Some of the most probable fission products are 90-Rubidium and 143-Cesium, and there are about 20 pairs of fission products that have mass numbers and yields close to the Ru—Ce pair. It is noted that the curve in FIG. 1 corresponds to the thermal neutron fission of 235U and not for other fissile materials like 239-Plutonium, 233-Uranium, 241-Americium, 252-Californium and other neutron energy. If a fast n is driving the reaction the fission curve looks different as showed by 12. When a charged particle hits the 235U it may open the fission or spallation channel. The fission curve looks like 12 being slightly modified according to the momentary reaction parameters, and the spallation adds a “tail” 11 to the fission curve, showing heavier nuclei that lost their neutrons.

FIG. 1B shows in more detail the fission products probability distribution released by 239-Plutonium fission on a linear scale. It shows that the relative measurement error is about 1%, and the maximal probability of occurrence has the isotope with mass 135 amu (atomic mass units). The main distribution curve 13 with the error bars 16 of about +/−1% are bordered by the lower 14 and upper 15 envelope curves limiting the likelihood of the occurrence of a certain isotope as a result of ²³⁹Pu fission. The number of released neutrons that could be interpreted on a gausian depending on the incident energy of the incoming neutron is determining the complementary curve of the probability distribution of the lower mass isotope, centered on the half mass 120 amu of the reaction.

FIG. 1C shows another detail of the fission reaction, with respect to the average kinetic energy of the (nₜₕₑᵣₘₐₗ, fission) reaction written short (nₜₕ,f) applied to ²³⁵U and ²³⁹Pu, the most frequent used elements in the present nuclear applications. The total fission products energy in the process is of about 167 MeV, shared according to the impulse and energy conservation rules by the two fission products from which we represented the higher mass for ²³⁵U by curve 17 and of ²³⁹Pu by curve 18.

FIG. 2A shows a plot of fission cross section σ_{f} versus incident neutron energy for various fertile actinide isotope used in nuclear detector like ²³⁸U, ²³²Th, ²⁴⁰Pu and ²⁴²Pu. As depicted 210, the fission cross section has different shapes specific to each isotope. The aspect and behavior of these isotopes used in n measurement devices by fission as an intermediary process has the advantage in being possible to give an indication of the neutron spectrum in a multi-group format with up to 16 energy domains if using only the fission rate information provided by using the 4 isotopes in the FIG. 210.

FIG. 2B shows a another diagram of the neutron yield of fission of the isotopes ²³²Th, ²³³U, ²³⁵U, ²³⁸U and ²³⁹Pu the most used in the actual nuclear energy for each incident neutron absorbed as a function of incident neutron energy. As depicted in the chart 220, the incident neutron energy is varying in a larger interval with 9 orders of magnitude. Using all the isotopes presented up to now in charts 210 and 220 there is possible to detect the neutron flux and its spectrum with up to about 50 energy sub-groups.

FIG. 2C shows as an example a neutron spectrum for a pulsed neutron generator using fissile materials. The chart 230 shows the component of fast neutrons with an average energy of 2 MeV and its thermal component, as an example of what the materials presented above may be used to detect.

Another example of a more complicated spectrum is depicted in FIG. 2D, for the case of spallation reactions, using high energy neutrons. The chart 240 shows the coexistence of several particles and their spectral distribution, in a more complex radiation environment that requires an accurate detection in real time with portable instrumentation. In the chart 240 the energy distribution of several particles as neutrons, protons, pions, deuterons and gamma photons is shown.

FIG. 2E shows an enlarged schematic diagram of several materials of potential interest of being used in the detection process. They do not produce fission particles but selectively absorbs the neutron flux allowing an increase of the multi-group number and accuracy a spectrum is depicted. The chart 250 shows the total cross section in barns of several materials in logarithmic scale. The ordinate shows only the domain limits of σₜ for each material, without showing scale proportionality among the materials, because the intent was to show the differences among them with respect to incident neutron energy shown on abscise. The materials are ⁶Li, that shows a good thermal and epithermal cross section, 27Al that exhibits a low cross section with the exception of several nuclear resonance in hard neutron spectral domain, and certainly recommending it for structural material. Other isotopes are ⁵³Mn, ¹⁹⁷Au, ²⁰⁸Pb, ²⁴¹Am each being different.

FIG. 2F shows the spectrum of proton induced fission in ²³³U and ²³⁸U as a function of incident proton energy. The chart 260 is important in spallation targets and accelerator driven transmutation systems. It also shows a low and uniform sensitivity of proton energy making this process small in the presence of neutrons.

FIG. 2G shows the fission cross section variation in hard neutron spectrum for 10 materials of interest that are ^{nat}W, ²⁰⁹Bi, ^{nat}Pb, ²³²Th, ²³³U, ²³⁷Np, ²³⁸U, ²³⁹Pu, ²⁴⁰Pu, ²⁴³Am. Each of them exhibit different fission cross sections versus incident neutron energy. The chart 270 also shows the possibility of differentiating in the high energy of neutrons using non-actinide materials as Pb, W, etc. This shows the possibility of having more than 100 sub-groups in the multi-group neutron energy measurement device.

FIG. 2H shows the usage of other materials in (n,γ) processes to characterize the neutron spectrum. These materials may be used as removable absorbers in the measurement in order to better characterize the neutron spectrum. The chart 280 shows the usage of ²⁷Al for ultra-hard neutrons, ¹¹⁵In for fast, fission just-released neutrons, ⁹⁸Mo for hard, sub-fission neutrons on a broad domain down to epithermal energies, ¹⁹⁷Au, ⁷⁵As, ¹⁸⁷Re, ⁵⁹Co for thermal and epithermal neutron energies.

FIG. 2H shows a combined chart 190 where three main neutron fluxes—inside the irradiation channel of a Boiling Water Reactor (BWR) 291, an Epithermal flux 292 inside a Fast Breeder Reactor, Na cooled (FBR) and fission neutron energy spectrum 293 are put together on the same chart with the fission cross sections of the main elements used as detectors like 239Pu 235 U 294, and 238 U are presented. The reaction rate is simply the product of the specific flux with specific material cross section and its specific Loschmidt number.

The figure also illustrates some terminology aspects, and some kinematics aspects of the nuclear reactions, as basis of the future developments.

### SUMMARY

According to the main embodiment, a method to design nuclear detectors assembly for nuclear applications that includes: multiple elemental modules customized on/for a moving entity taking part in the nuclear reaction as fission products, decay products, knock-on electrons and recoils, made of three components with generic function as generator; insulator and absorber and their interfaces, dimensioned for each moving entity by calculating the effective lengths of each component. The moving entity specific modules are used one into another or separately driving to the design of a large variety of nuclear materials for better handling nuclear reactions as fission, fusion, decay and transmutation. The method applied to fission products drives to the design of a neutron and hard gamma detector, using fission products end of range thermal spike discharged in a scintillator or electro-sensitive material. The scintillator may be fluid in a smooth flow around the fissionable beads draining the fission products and their effects along to a detection or damage recovery unit.

According to another embodiment, the method is applied to knock-on electrons produced from stopping the moving entities drives to the design of a device for converting fission energy into electrical energy that includes: a detector layer for generating fission products by fission reactions; one or more CIci layer units stacked on the detector layer, each CIci layer unit including a first conductive layer “C”, a first insulating layer “I”, a lower than the first conductive layer electron density layer “c”, and a second insulating layer “i”; and an electrical circuit coupled to the conductive layers and operative to harvest electrical energy. The fission products or other moving particles generate electron showers in the first layer that may contain nuclear detector also while the low electron density layer absorbs the electron showers.

According to yet another embodiment, the method is applied to knock-on electrons produced from stopping the moving entities drives to the design of a tile for converting particle and radiation energy into electrical energy includes: a first layer including one or more CIci layer units, each CIci layer unit including a first component, a conductive layer with high electron density among available conductive materials “C”, a first insulating layer “I”, a lower electron density than the first component, layer “c”, and a second insulating layer “i”, the first layer being operative to absorb a first portion of particles and radiations moving toward the surface thereof and to convert the energy of the first portion into electrical energy; a second layer formed over the first layer and including one or more CIci layer units and being operative to absorb a second portion of particles and radiations that have passed through the first layer and to convert the second portion into electrical energy; and a third layer formed over the second layer and including one or more “CIci” layer units and operative to capture neutrons that have passed through the first and second layers and to convert the energy of neutrons into electrical energy.

According to still another embodiment, the method is applied to knock-on electrons produced from stopping the moving entities drives to the design of a device for converting fusion energy into electrical energy includes: a chamber having a wall comprised of at least one “CIci” layer unit, the CIci layer unit including a high electron density layer among the available conductive materials “C”, a first insulating layer “I”, a lower than the first conductor electron density layer “c”, and a second insulating layer “i”, the wall having at least two holes facing each other. The wall absorbs fusion products generated by the fusion reactions and converts the energy of fusion products into electrical energy, simultaneously measuring it.

According to a further embodiment, the method is applied to nuclei recoils produced from absorbing the moving entities drives to the design of a nuclear pellet includes: a generally cylindrical cladding layer; a metal grid covering a first transverse cross section of the cladding layer; a lower support covering a second transverse cross section of the cladding layer; and nuclear detector grains filling a space bounded by the cladding layer, metal grid and lower support and capable of generating transmutation reactions. The liquid flows through the cladding layer and thereby washes the grains and carries recoils generated by the transmutation reactions to an analyzer/separator unit that may deliver information on the radiation field inside by analyzing the transmutation products signatures.

The three main processes may use a plurality of materials and configurations to create process customized detector arrays to characterize the radiation fields directly in real time by analyzing instantaneous response of the sensors or by accumulation and sampling analyzes at different time intervals in remote specialized units.

The detectors may be made as complex systems integrating a continuous flow multi-material, multi-sensor scintillation detector with. Direct Energy Conversion Matrix plate detectors, and nano-structured direct extraction detector units. This represents an advance in Particle Detector Technology—with emphasis to Nuclear physics detecting and analyzing charged particles, neutrons, and energetic neutral atoms providing information on their initial charge (ionization level), energy, mass and direction and incidence position for each particle.

Direct Energy Conversion Matrix plate is a solid state device, looking like a CCD plate, but containing electronics embedded into a nano-hetero-structure that directly harvests the kinetic energy of the particle and converts it in electric charge with high efficiency. The interaction parameters provided simultaneously by the plate represents an important advantage for complex radiation characterization.

There are the following parameters that are measured:

time (event mode detection) (t)

position of incidence (x,y,at detector surface)

initial charge (I)

range (R)

ionization power deposition along range I(x;y;z) (20-2000 values)

inside direction (x,y,range=0)-(x,y,R)

and by calculations

particle mass (m)

particle's kinetic energy (K)

particle's refined direction (0, cp)

particle possible decay (mainly, beta, alpha) for short decay halving times<1s (measured as a sudden energy generation at R, after a time delay). In this way it detects n and X, Gamma interactions. The data processing will separate the type of interaction. Loading the structure with specific high cross-section materials may modify the detector's sensitivities. The advanced structures may be able to track n, gamma, X depending on detector's parameters.

### BRIEF DESCRIPTION OF THE DRAWINGS

FIG. 1A shows an exemplary plot of fission yield as a function of mass number for thermal fission of the main fissile materials U-235, Np-238, Pu-239, Am-242m, Cm-245, Cf-249.

FIG. 1B shows an exemplary plot of fission yield as a function of mass number for thermal fission of Pu-239 for the heavier masses.

FIG. 1C shows an exemplary plot of the average kinetic energy as a function of mass number for thermal fission of U-235 and Pu-239, for the upper masses.

FIG. 2A shows a plot of fission cross section for conventional nuclear detectors as a function of neutron energy.

FIG. 2B shows a schematic diagram of neutron multiplication factor in fission—neutron yield per neutron absorbed as a function of incident neutron energy for main fissile isotopes.

FIG. 2C shows an example of neutron spectrum for pulsed reactor systems.

FIG. 2D shows a diagram of flux of particles generated in spallation processes.

FIG. 2E shows a diagram of total cross section of few materials used in nuclear applications as function of neutron energy.

FIG. 2F shows a diagram of fission cross section for U233 and U-238.

FIG. 2G shows a diagram of fission cross section of several materials of nuclear interest as function of the incident neutron energy.

FIG. 2H shows a schematic diagram of the usage of various neutron absorber materials for the neutron flux characterization.

FIG. 2I shows a diagram of main neutron flux and fission cross sections of several materials of nuclear interest.

FIG. 3A shows a numerical simulation of Cs ion trajectories in an urania target.

FIG. 3B shows a plot of energy deposition in the detector lattice by ionization and collisions of Cs ions with the lattice's nuclei.

FIG. 3C shows a schematic diagram of the kinematics of main nuclear reactions.

FIG. 4A shows numerically simulated trajectories of ions injected into a bi-material urania 10 microns, LBE 5 microns target by SRIM 2008.

FIG. 4B shows a distribution of density of stopping ions in a bi-material target.

FIG. 4C shows a distribution of recoil energy deposited in a bi-material target.

FIG. 4D shows a distribution of phonon energy deposited in a bi-material target.

FIG. 5 shows how to determine detector thickness or dimension in accordance with the main embodiment of the present invention.

FIG. 6 is a schematic cross sectional diagram of an embodiment of nuclear detector in accordance with the present invention.

FIG. 7 is a schematic cross sectional diagram of another embodiment of detector microstructure in accordance with the present invention.

FIG. 8 is a top view of yet another embodiment of detector microstructure having a web structure in accordance with the present invention.

FIG. 9 is a schematic perspective view of still another embodiment of detector microstructure having a meshed felt structure in accordance with the present invention.

FIG. 10A is a schematic diagram of an embodiment of a detector tube section in accordance with the present invention.

FIG. 10B is a schematic diagram of another embodiment of a detector tube section in accordance with the present invention.

FIG. 11A is a schematic diagram of yet another embodiment of a detector tube section in accordance with the present invention.

FIG. 11B is a schematic cross sectional view of nuclear material structure contained in the detector tube in FIG. 11A.

FIG. 12A is a schematic cross sectional diagram of still another embodiment of a detector tube in accordance with the present invention.

FIG. 12B is a cross sectional view of a central portion of the detector tube in FIG. 12A.

FIGS. 13A and 13B are respectively schematic transverse and longitudinal cross sectional diagrams of an embodiment of a reactor channel detector module in accordance with the present invention.

FIG. 14 shows a plot of a volumetric dilution factor as a function of a volumetric parameter, showing how detector material reactivity may be adjusted by compressing the sensitive structure.

FIG. 15 shows a complex detector type based on fissionable materials in scintillating environment.

FIG. 16A is a schematic cross sectional diagram of an embodiment of a nuclear detector elementary fission bead structure in accordance with the present invention.

FIG. 16B is a schematic cross sectional diagram of an embodiment of a nuclear detector elementary fission micro-fluidic channel structure in accordance with the present invention.

FIG. 16C is a schematic longitudinal diagram of an embodiment of a nuclear detector elementary fission micro-fluidic channel structure in accordance with the present invention.

FIG. 16D is a chart showing the variation of the micro-flow and temperature along the micro-channel in accordance with the present invention.

FIG. 16E is a schematic cross sectional diagram of an embodiment of a nuclear detector elementary fission micro-beaded mesh structure in accordance with the present invention.

FIG. 17A shows a schematic diagram of one embodiment of a nuclear detector detection systems in accordance with the present invention.

FIG. 17B shows a schematic diagram of one embodiment of a nuclear detector detection systems used in spallation sources characterization in accordance with the present invention.

FIG. 18A shows a plot of exemplary trajectories of fission products penetrating a multi-materials thin nano-target.

FIG. 18B shows a plot of energy deposition by ionization in the target of FIG. 18A.

FIGS. 18C and 18D respectively show plots of phonon energy and recoil energy in the target of FIG. 18A.

FIG. 18E shows a schematic diagram of an embodiment of a device for direct conversion of fission—fusion energy into electrical energy in accordance with the present invention.

FIG. 18F shows a chart with the specific power deposition of an alpha beam in materials to be used in direct conversion of fission—fusion energy into electrical energy in accordance with the present invention.

FIG. 18G shows a schematic diagram of a thickness calculation of an elementary unit for direct conversion of fission—fusion energy into electrical energy in accordance with the present invention.

FIG. 18H shows a schematic diagram of the main processes inside the unit for direct conversion of fission—fusion energy into electrical energy in accordance with the present invention.

FIG. 18I shows a schematic diagram of the knock-on electron shower trajectories inside an elementary unit for direct conversion of fission—fusion energy into electrical energy in accordance with the present invention.

FIG. 18J shows a schematic diagram of the knock-on electron shower charge density distribution inside an elementary unit for direct conversion of fission—fusion energy into electrical energy in accordance with the present invention.

FIG. 18K shows a schematic diagram of the nano-layer thickness optimization process of an elementary unit for direct conversion of fission—fusion energy into electrical energy in accordance with the present invention.

FIG. 18L shows a schematic diagram of an example of elementary unit for direct conversion of fission—fusion energy into electrical energy in accordance with the present invention.

FIG. 18M shows a schematic diagram of an elementary unit for direct conversion of fission—fusion energy into electrical energy in accordance with the present invention.

FIG. 19 shows a schematic diagram of an embodiment of a device for direct conversion of fission—fusion energy into electrical energy in accordance with the present invention.

FIG. 20 shows a schematic cross sectional diagram of another embodiment of a device for direct conversion of fission energy into electrical energy in accordance with the present invention.

FIG. 21 shows a schematic cross sectional diagram of yet another embodiment of a device for direct conversion of fission energy into electrical energy in accordance with the present invention.

FIG. 22A is a schematic cross sectional diagram of still another embodiment of a device for direct conversion of fission energy into electrical energy in accordance with the present invention.

FIG. 22B is an enlarged schematic cross sectional view of a voxel in FIG. 22A

FIG. 23A is a schematic cross sectional diagram of a further embodiment of a device for direct conversion of fission energy into electrical energy in accordance with the present invention.

FIG. 23B is a schematic cross sectional diagram of another further embodiment of a device for direct conversion of fission energy into electrical energy in accordance with the present invention.

FIG. 24 is a schematic diagram of the structure to adjust the electric parameters of yet further embodiment of a device for direct conversion of fission energy into electrical energy in accordance with the present invention.

FIG. 25 is a schematic diagram of the general electric scheme to gradually adjust the electric parameters of the harvested electricity, another embodiment of a device for direct conversion of fission—fusion energy into electrical energy in accordance with the present invention.

FIG. 26 is a schematic diagram of an embodiment of a examples of multi-sector nuclear detector in accordance with the present invention.

FIG. 27 is a schematic cross sectional diagram of an embodiment of a tile for measuring by harvesting fission/fusion/cosmic ray energy in accordance with the present invention.

FIG. 28A shows a schematic diagram of tile space application another embodiment of a tile for measuring by harvesting fission/fusion/incident beam/cosmic ray energy in accordance with the present invention.

FIG. 28B shows an enlarged schematic diagram of a portion of the tile in FIG. 28A.

FIG. 29A shows a schematic diagram of an electronic circuit used to read the charges harvested by the direct conversion structures an embodiment of a device radiation measurement in accordance with the present invention.

FIG. 29B shows the electronic circuit used to measure the radiation field by using direct conversion structures an embodiment of a device for in accordance with the present invention.

FIG. 29C shows a schematic diagram of a part of the circuit used to accumulate the charges harvested by the direct conversion structures an embodiment of a device radiation measurement in accordance with the present invention.

FIG. 29D shows a schematic electronic diagram of uni-dimensional module to measure the radiation and its direction an embodiment of a device radiation measurement in accordance with the present invention.

FIG. 29E shows a schematic electronic diagram of bi-dimensional module to measure the radiation energy, type and its direction an embodiment of a device radiation measurement in accordance with the present invention.

FIG. 29F shows a schematic electronic diagram of tri-dimensional module to measure the radiation energy, type and its direction an embodiment of a device radiation measurement in accordance with the present invention.

FIG. 30A shows a schematic diagram of several elementary “CIci” units connected in series outside the structure in accordance with the present invention.

FIG. 30B shows a schematic longitudinal section through several elementary “CIci” units connected in series outside the structure in accordance with the present invention.

FIG. 30B shows a schematic longitudinal section through several elementary “CIci” units reconfigured as connected in series inside the structure in accordance with the present invention.

FIG. 30B shows a schematic longitudinal section through several elementary “CIci” units morphed in embedded nano-beads dielectric structures in accordance with the present invention.

FIG. 31 shows a schematic diagram of an embodiment of a device for measuring the radiation field by combining the micro-beads scintillation measurement with nano-structures energy harvesting measurement in accordance with the present invention.

FIG. 32A shows a plot of exemplary trajectories of recoil products escaping from a target.

FIG. 32B shows a plot of recoiled nuclei as heavy-ion ranges in the target of FIG. 32A.

FIG. 32B shows an artistic view of the nano-cluster and the main nuclear processes used to measure the radiation field by nuclear transmutation in accordance with the present invention.

FIG. 33 shows a cross sectional view of nano-sized grains immersed in collector liquid in accordance with one embodiment of the present invention.

FIG. 34A shows an embodiment of a nano-hetero nuclear reactor fluence measurement pellet in accordance with the present invention.

FIG. 34B is a schematic enlarged view of a portion of the pellet in FIG. 34A.

FIG. 35 shows a cross sectional view of nano-sized grains immersed in collector liquid embedded into micro-size beads immersed into a scintillator fluid in accordance with one embodiment of the present invention.

FIG. 36 shows a cross sectional view of measurement reactor pipe combining the effects of nano-sized grains direct separation of transmutation products with micro-sized grains fission products spike scintillation measurement in accordance with one embodiment of the present invention.

FIG. 37A shows a cross sectional view of sealed micro-hetero structure with embedded nano-sized grains in accordance with one embodiment of the present invention.

FIG. 37B shows a schematic cryogenic partitioning for measurement process of a sealed micro-nano-hetero structured pellet in accordance with one embodiment of the present invention.

FIG. 38 shows a chart with direct extraction efficiencies of nano-sized grains immersed in collector liquid in accordance with one embodiment of the present invention.

FIG. 39 shows a chart for transmutation materials to be used in various nano-sized grains immersed in collector liquid neutron field measurement in accordance with one embodiment of the present invention.

### DETAILED DESCRIPTION

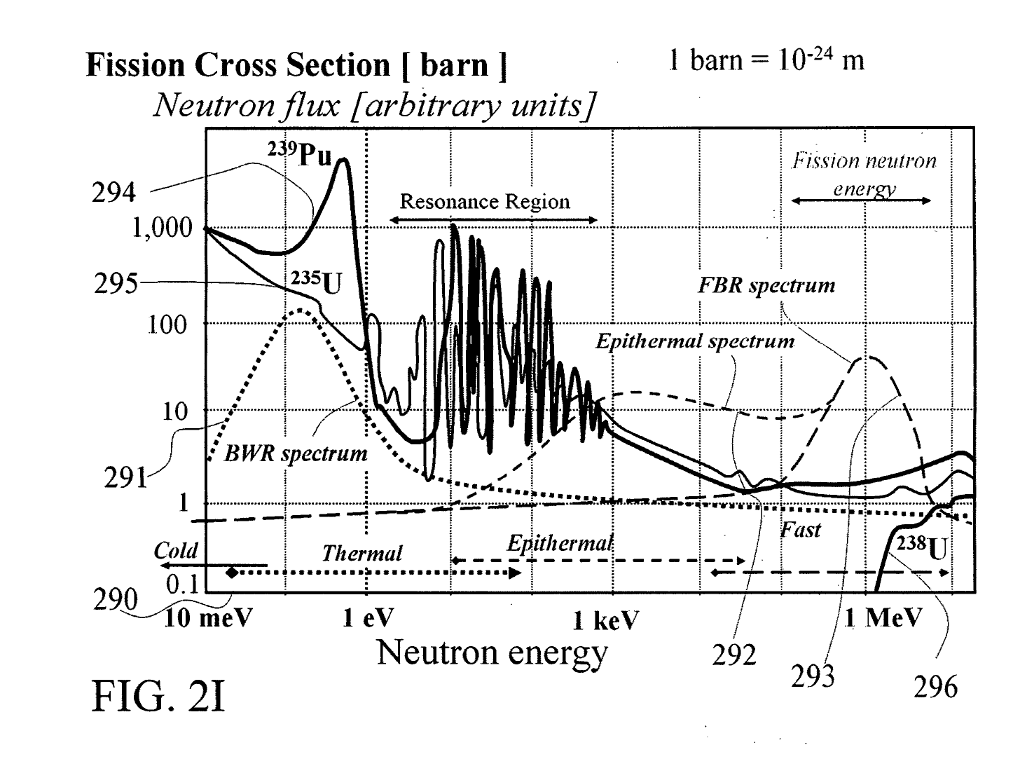

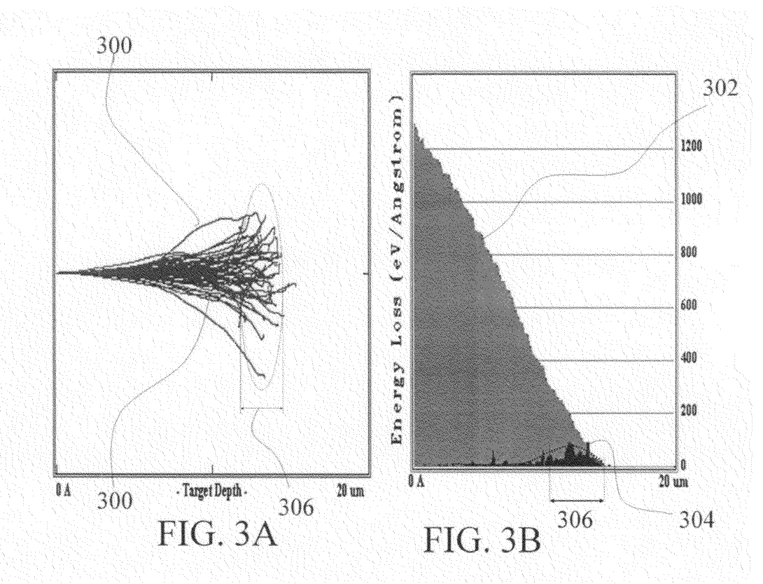

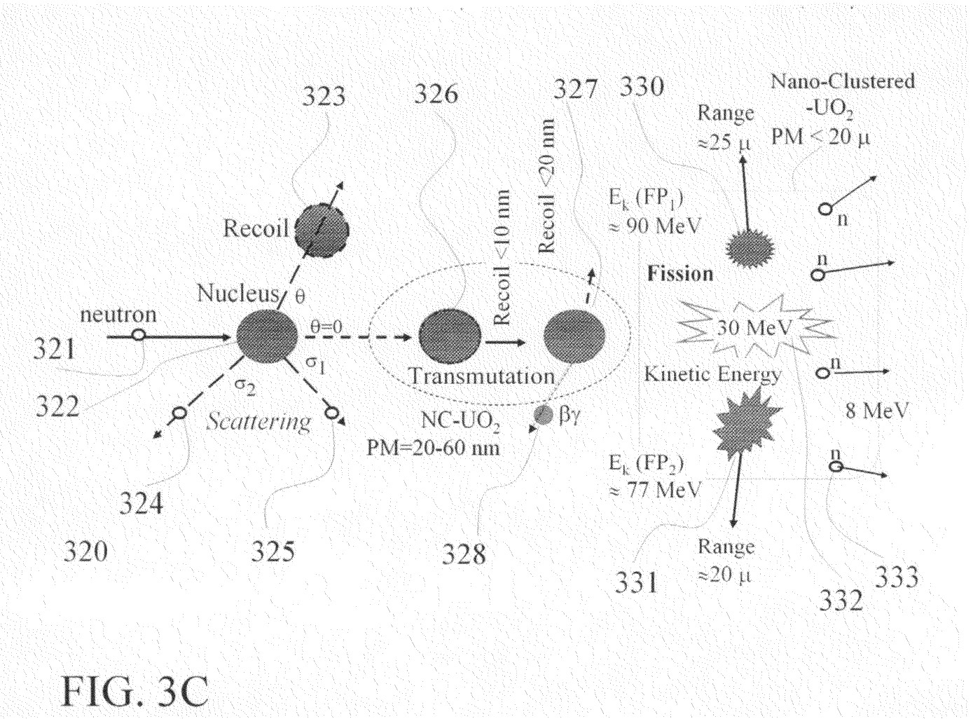

FIG. 3A shows a numerical simulation of Cs ion trajectories 300 in a target, wherein the Cs ions are injected into nuclear detector target formed of uranium dioxide (or, shortly urania) with 100% compaction (no porosity). The simulation is performed by use of the conventional Simulations of Reactions of Ions with Matter (SRIM) software. It can be noticed that most of the Cs ions decelerate to rest in about 14-15 micrometers 306 from the target surface while the lateral straggling ranges about 3-4 microns. It is noted that these dimensions are material, material structure and ion type and energy dependent.

FIG. 3B shows a plot of energy deposition in the detector lattice by ionization and collisions of Cs ions with the lattice's nuclei, called recoil. A numerical simulation is performed to obtain the curves 302 and 304. The curve 302 represents the ionization energy deposited by Cs ions with an entry kinetic energy of 100 MeV as a function of distance from the target surface. The dotted curve 304 represents an envelope of the nuclear recoil energy distribution. As depicted, the curve 304 has a peak in the region 306 between about 10 microns from the target surface and the end of ion penetration. As such, the maximum nuclear recoil damage takes place in the region 306. The chemical properties and reactivity of Cs ions, typical fission products, enters into force at about 12 microns from the detector surface, i.e., Cs ions strongly interact with urania in the weakest zone, like inter-grains boundaries, of the detector. The recoil damage may be reduced if the detector dimension is slightly less (say 5%) than the distance between the surface of the detector and the onset of the region 306. The figure is important showing that all along the stopping range the main interaction with lattice is by ionization and only in the last 20% of the range the main nuclear collision with associated dislocation damage takes place.

FIG. 3C shows a schematic diagram of the nuclear reaction 320, where a neutron 321 called incident particle is colliding with a nucleus 322 and the first reaction channel being scattering. If the scattering process is elastic there are two kinematical schemes that drives to the same angle θ of the recoiled nucleus 323, but different angles σ of the scattered particle driving to two different energies of the recoiled nucleus 323. There is a third possibility of the head on collision when θ=0 and σ=π but its occurrence is small but gives the maximum impulse transfer. In the case that the incident particle is back-scattered under the angle σ₁ 324 the recoiled nucleus 323 energy is bigger than in the case the incident particle, said neutron is forward-scattered under the angle σ₂ 325. The scattering process is instantaneous and takes less than 1 ps to produce.

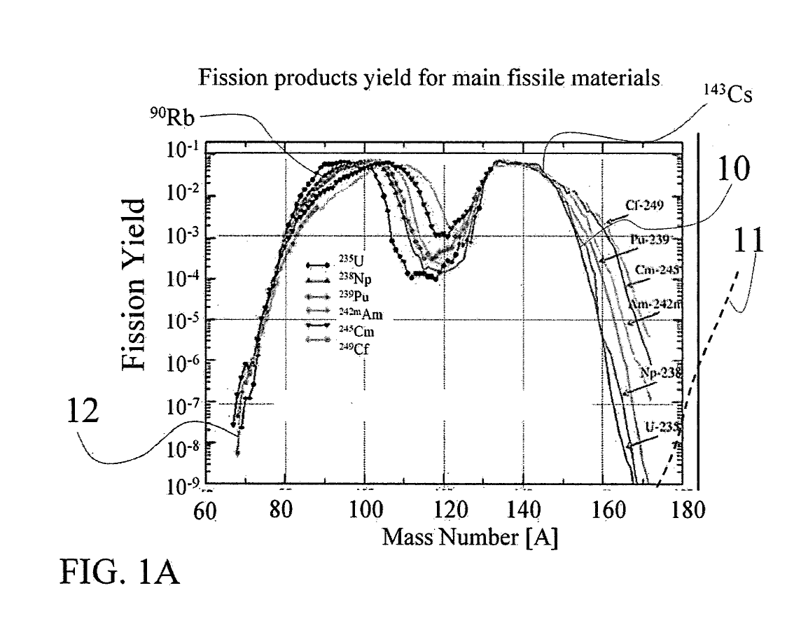

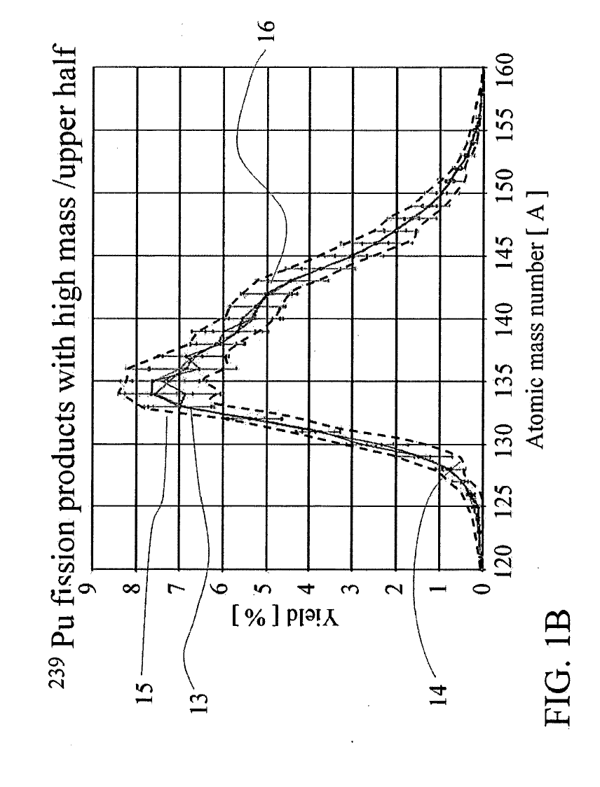

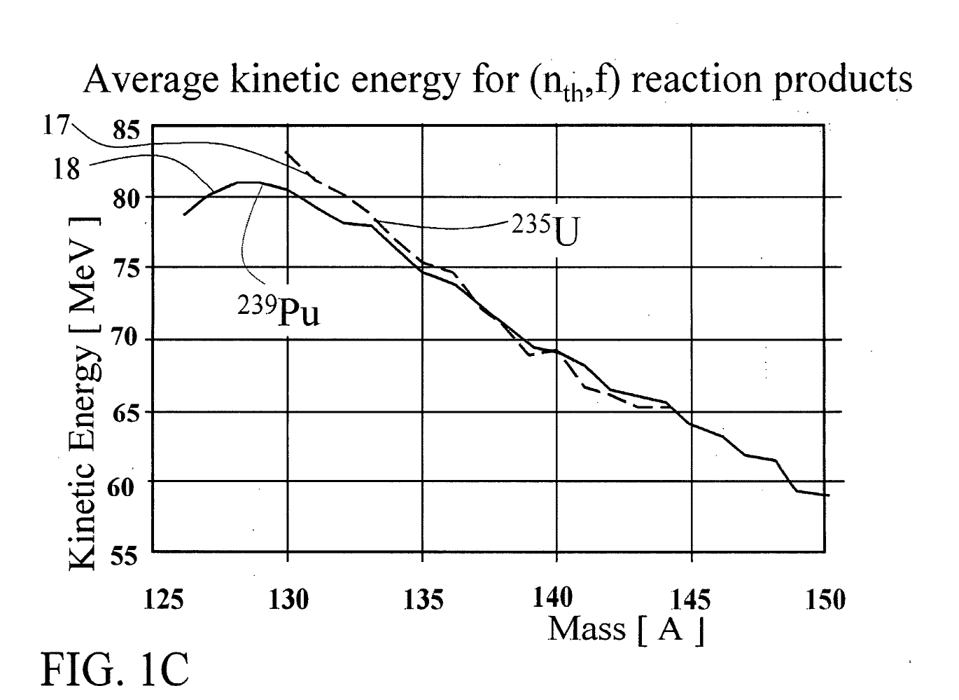

The other nuclear channel that opens in the first femtoseconds (fs) is the incident particle absorption. The compound nucleus 326 recoils and meanwhile other nuclear channels selection take place. It may release a particle 328 transmute and decay, or go into fission process. The decay process is opening various reaction channels. One could be the release of a particle identical with the incident particle but with different energy—called inelastic scattering, or release of a gamma ray and the compound nucleus loose some excitation energy. All the energy release also generates nuclear recoil that for example in the case of alpha decay generates about 86 keV recoil energy for about a 5 MeV alpha. The recoiled nucleus induces a several nm recoil damage in the surrounding lattice creating over 10,000 dislocations in the process of energy degradation in the first 100 ps, creating a local spike—that anneals in about 1 micro-second reducing the defect and dislocation size. Another path, is to disintegrate—generating most frequently two isotopes with the probability distribution according FIG. 1A, 330 and 331 sharing about 167 MeV and stopping in the surrounding matter few microns away. In the first fs after the fission a burst of about 8 Mev gamma rays 332 and about 8-10 MeV of neutron 333 energy is released. Some other 8 MeV of neutrino are accompanying the beta decay of the excited fission products that a flying through the lattice similar to accelerated heavy ions. Towards the end of the stopping range they inflict the maximum radiation damage by nuclear collisions producing up to several hundred thousands of dislocations, called fission spike. In the first 50 ps. There is only the recoil spike, than up to several hundred of ns the lattice recovers and give birth to a thermal spike, that comes into equilibrium in about 0.5 micro-seconds and thermodynamics laws enter in force, the energy now is heat and removed by heat flow.

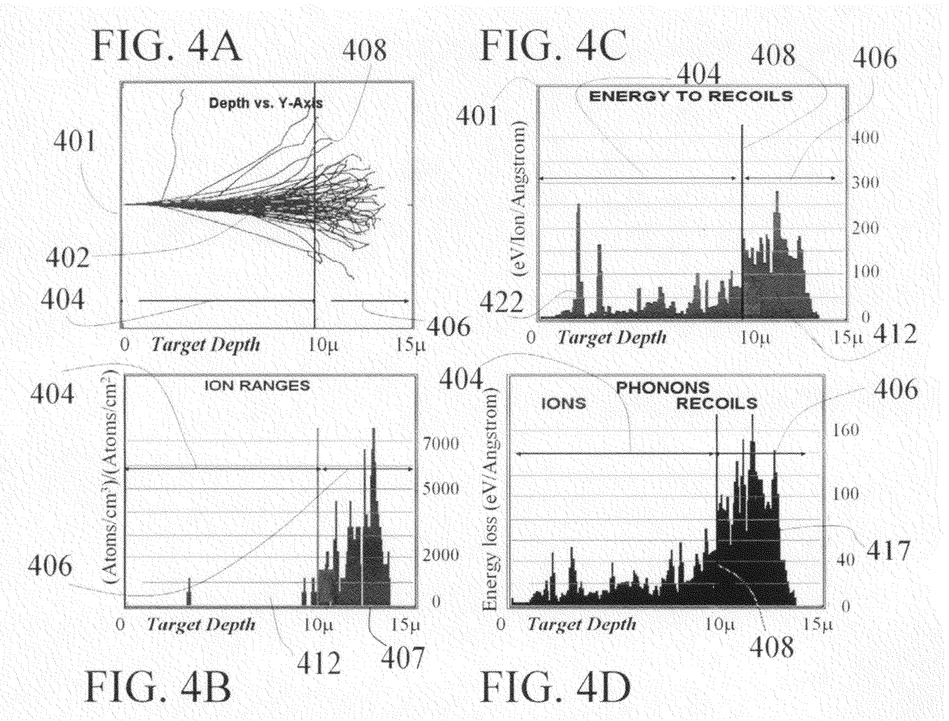

FIGS. 4A-4D show numerical simulations of various quantities associated with Cs ions injected into a bi-material target having urania and lead-bismuth eutectic (LBE) liquid. FIG. 4A shows numerically simulated trajectories 402 of ions injected into a bi-material target including urania 404 and lead-bismuth eutectic (LBE) liquid 406, wherein the thickness of the urania and LBE liquid are 10 microns and 5 microns, respectively. The line 408 represents the boundary between the urania 404 and LBE liquid 406, where the horizontal axis represents the distance from the urania surface 401. As depicted, most of the fission products decelerate to rest in LBE 406. Being a liquid, the LBE 406 may not be affected by nuclear recoil damages that, in solid lattices, may induce stress and grain fragmentation. LBE liquid 406 has also a higher thermal conductivity than urania 404, which makes the detector remain at lower temperature. LBE has been taken as an example, it may be remover and replaced with another liquid producing scintillations and pressure shock waves similar to micro-cavitations during the fission spike that takes place at the end of the range.

FIG. 4B shows a distribution of density of stopping [in the unit of atoms/cm²] as a function of distance from the urania surface. Except few atoms 412 having nuclear collisions, most of the ions pass through the urania 404 and interface 408 and stop in the LBE liquid 406. The average penetration distance for this case is about 14 μm, with a straggling width of +/−1 μm. The quantitative value of the stopping density 407 is shown on the lateral scale. In this region to the spectrum of the scintillation is added the spectral contribution of the fission product electronic orbital reactions according to its various excitation states it transits during stopping.

FIG. 4C shows a distribution of recoil energy deposited in a bi-material target by Cs ions injected with 100 MeV entry energy. As depicted, the deposited recoil energy 422 shows a peak at the location 412 (shown in FIG. 4B) where nuclear collisions occur. Also, the deposited recoil energy becomes significant in the region where the distance from the detector surface 401 exceeds 12 microns.

FIG. 4D shows a distribution of phonon energy (or, shortly phonons) deposited in a bi-material target, where the phonons are quasi-particles associated with temperature and heating. In general, the energy deposited in phonons is about ⅓ of the deposited recoil energy shown in FIG. 4C. The distribution 417 of phonon energy is similar to that of recoil energy in FIG. 4C, with a slight difference that this energy is deposited immediately before the particles come to rest in LBE liquid 406 and is smaller in urania 404 and interface 408. That means that a small portion of the outer crust of the particles adjacent the interface 408 is heated more than the central portion of the urania 404 but less than the surrounding LBE liquid 406, which drives mainly to a uniform temperature distribution inside the urania 404 and reduces the high stress present in conventional detector pellets. It is important to observe that the most of the heat is deposited outside of the detector bead in a better conductive material that is the liquid metal.

The bi-material detector may be made from other suitable pairs of materials insofar as the pairs have the similar characteristics as discussed in conjunction with FIGS. 3A-4D. In general, the first material 404 may be called “generator” because it is the source of the fission products, while the second material 406 may be called “absorber” as it stops and absorbs the generated fission products. To resolve chemical incompatibility and material adhesion issues, a supplementary interface, called “insulator,” may be interposed between the generator and absorber.

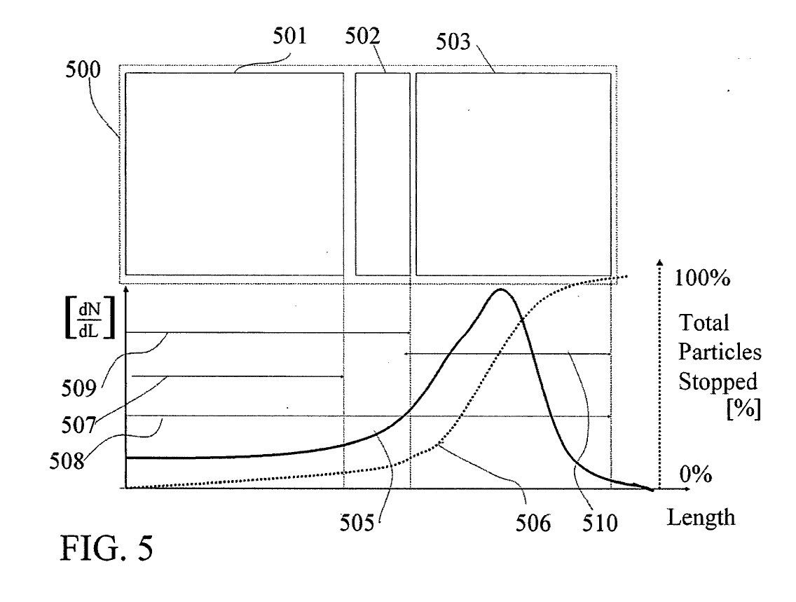

FIG. 5 shows the method of how to determine detector thickness or dimension in accordance with the main embodiment of the present invention. As depicted, the approach described with reference to FIG. 5 is based on an exemplary assembly 500 having three layers or components, generator 501, insulator 502, and absorber 503, wherein each component has a generic functionality. The assembly may form an elemental module that can be stacked repeatedly in certain applications. The “generator” 501 is formed of material that can generate the particles of interest, such as fission products, knock-on electrons, or recoils. In practice, the generator 501 is formed of alloys or mixtures containing fissile material, such as Uranium, Plutonium, Neptunium, Americium, Californium, or other actinides. The generator 501 can be also formed of liquid material. A knock-on electron(s) is generated by an electromagnetic collision of a moving entity, such as fission product, ion, electron, radiation, neutral atom or molecule with a material lattice, wherein the material has preferably high electron density. For recoils, the end of range takes place pulling out the recoiled particles from the generating material like depleted uranium, etc. nano grains into the collector material.

The insulator 502 operates as an electrical, a chemical, or a molecular separator for separating the generator 501 from the absorber 503 and is associated with either the generator 501 or the absorber 503. The insulator 502 may be in the form of a layer, molecules, or clusters. The insulator 502 assures the separation properties enhancing the material interface properties by faceting or coating. In the case where both the generator 501 and absorber 503 are liquids, the insulator 502 may be used to provide the mechanical stability. The insulator 502 is invisible to the moving entities, such as fission products, electrons, recoils and other particles including molecules, ions, photons (X, gamma), and cosmic rays.

The absorber 503 is formed of a material, a material compound, chemical combinations, or alloys and is designed to stop the particles produced by the generator 501. For the fission products, knock-on electrons, and recoils, the absorber 503 functions as a stopping device and its material is mainly selected based on the capability of performing the deceleration process without major structural and chemical changes in time. The materials may be liquids, liquid metals, salts, solids, or gases. For the knock-on electrons, the absorber material is selected such that the absorber is able to stop the electrons without generating other electrons in interaction with the generator agent. The material may be conductor or superconductor with low electronic emissivity. Preferably, the material has low electronic density and is in the form of solid, liquid, or plasma. Conventional low-electron density materials may be included in the absorber 503. For recoils, the absorber 503 is formed of material that has different chemical properties than the recoils and stabilizes the recoils so as to make them easy to collect, concentrate, and separate from the absorber material.

The absorber may be made by a transparent material or a combination of materials transferring the local fission spike photon excitation into a high transmission band able to be transferred with minimal losses to wave guides. It may also immobilize the charges and ionization that may be transported by the flow to charge collectors.

Upon selection of materials for the three components 501, 502, 503, a linear dimension, called “effective length” can be defined by weighting the effects of interest, wherein the effects of interest occurs within the effective length. In the case of generator 501, the generated objects are not self-absorbed within a reasonable range, “effective length of the generator (EfLG) 507,” with or without the maximization of the desired phenomenon: “the generation”. The curve 505 represents the number of absorbed particle per unit length. As can be noticed, the generator 501 absorbs a small fraction of particles. As such, in practice, EflG 507 is determined considering the self-absorption of particles as well as other technological conditions, such as maximization of generation, mechanical stability, chemical stability, self-repairing, clusterization, etc. In the case of the absorber 503, the desired phenomenon is the maximization of the absorption of the product generated by the generator 501 with the optimization of other effects, such as minimization of the production of particles, maximization of stability, minimization of structural damage, maximization of current transport, heat, particles, etc. The curve 506 represents the total number of particles stopped as a function of distance from a surface of the generator 501. The effective length of the absorber (EfAL) 510 represents a characteristic length for producing absorption to a desired extent. Due to the fact that calculations are performed considering the whole assembly of materials, EfAL 510 of the absorber 503 becomes the difference between the absorption effective length EfLA 508 and EfLG 507 and the insulator thickness EfGI 509, truncated at a technological value. The technological value refers to a dimension that can be technologically obtained and is stable in time.

In practice, the optimization is performed considering a sequence of optimization conditions and the effective lengths are calculated iteratively. The effective lengths are, in the case of fission products, in the micrometric domain while, in the case of electrons and recoils, the effective lengths are in the nanometric domain. In the case where both fission products and electrons/recoils are considered simultaneously, the effective lengths are in the nano-micro domain and a hybrid structure is obtained.

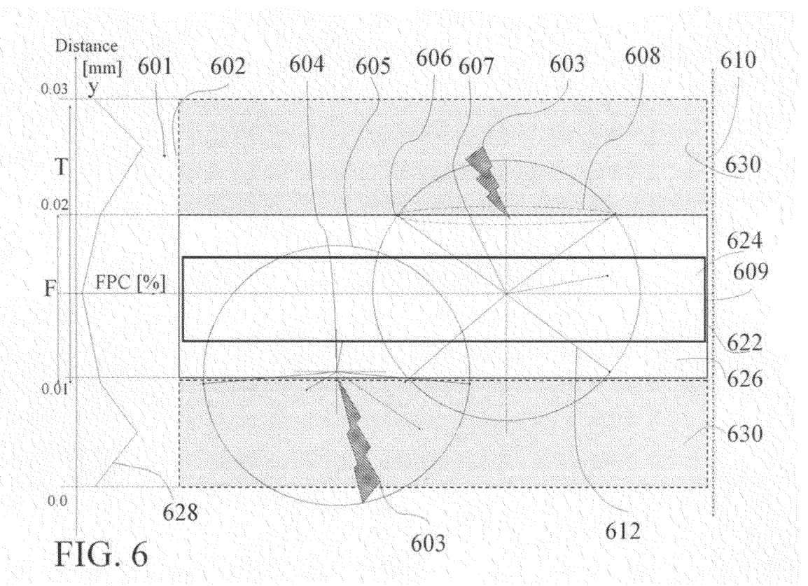

FIG. 6 is a schematic cross sectional diagram of an elemental module according to FIG. 5 being an example of the application of the “effective length” method on one dimension only (the thickness), generating a layered structure, being an embodiment of nuclear detector in accordance with the present invention. As depicted, the detector 622 is surrounded by drain liquid 630 and includes two layers: a core 624 made of nuclear detector and an insulating layer 626. For brevity, only one detector layer 622 and two drain liquid layers 630 are shown in FIG. 6, even though the overall detector assembly includes alternating strata of detector and drain liquid layers. The effective lengths have been calculated in the ordinate (y) direction only, i.e., the thicknesses of the detector 622 and the drain liquid 630 in the y-direction have been calculated. The core or middle portion 624 is formed of metallic material or chemical compositions, such as N—Nitride or C-Carbide, while the insulating layer 626 is formed of a large variety of materials including metals, Ti, W, Graphite, carbides, oxides, fulerens, other structures. The heterogeneous structure of the detector 622 may be achieved by electro-deposition technique, or molecular vapor deposition technique based on plasma spray, or a combination of molecular beam technique and selective reaction accelerator assisted deposition technique. Methods like chemical vapor deposition with various chemical reaction initiations may be used to achieve a high productivity. The simplest fabrication method may be chemical electro-deposition in adjacent baths, creating a closed loop tape or an endless tape (Mollus tape) that is drawn through the electro-deposition baths, until it reaches a critical dimension. To assure stability, the borders of the tape can be channeled and coupled to cladding material. The drain fluid layers 630 can be deposited with the detector layers 622 because at the deposition temperature, the drain liquid may be in the form of solid. Any conventional fissile material, such as Th, U, Pu, Np, Am, and Cf, may be used as detector 622. The isotopic enrichment factor may play an important role in determining the thickness ratio of layers so as to meet the criticality conditions for a given reactor structure.

The drain fluid 630 is a liquid scintillator that does not chemically interact with the detector 622. There are several materials for the drain liquid, such as Na, K, NaK, Al, Zr, ZrNb, Pb, Bi, PbBi, etc. The type of drain liquid determines the temperature range where the detector operates. The exact calculations for a nuclear reactor application require the knowledge of the neutron properties in all materials, material purity, mixing ratios, shapes, etc. for non-influencing the criticality in the reactor structure.

The insulating layer 626 increases the passivity of the detector towards the drain liquid 630, allows the operational temperature to increase, and also reduces the rim effect due to the burnup. For structural reasons, the detector 622 is tightly secured to lateral supports, such as cladding, i.e., both sides 601, 609 of the core 624 as well as the porous walls 602 and 610 are secured to the lateral supports (not shown in FIG. 6). During operation, one lateral support facing the porous wall 602 provides drain liquid flow through the wall 602, while the contaminated drain liquid is drained through the porous wall 610 into another lateral support facing the porous wall 610. If this structure is built in a large scale, the drain liquid 630 has a tendency to inflate the surface and shear. That is why bounding detector or structural filaments are drawn vertically in the detector, interconnecting the layers of detector, in a similar way the lateral cladding is drawn. This can be achieved by masking procedures or by using mili/micro-beam accelerators to build the detector micro-wires.

During the operation of the reactor, the fission reaction occurs in various locations 604, 607, for instance. The spheres 605, 606 represent the ranges that fission products can travel through the detector 622 and drain liquid 630. The radii of the spheres 605, 606 depend on the material type, concentrations, type and energy of fission product, etc. The fission product paths, which are represented by arrows 612, depend on the energy and pulse conservation at the fission point 607. The stopping process takes about few pico-seconds, and at the end of the range, some other type of energy release may happen (like beta disintegration of the fission product, being accompanied by neutrino and gamma release).

The fission spike 603 that take place during the first 50 ps after the fission is generating an optical emission due to more than several hundred collisions of the fission product with the scintillator liquid or colloid and several tens of thousands collisions of the absorber internal collisions. A spatial charge is also generated that may recombine fast in conductive materials or may be preserved, transported by flow and detected with charge sensitive systems and the fluid charge restored. The thermal spike in its development in about 1 micro-second emits an ultrasonic signal similar to micro-cavitations discharge that travels in soliton mode or like a pressure wave depending on conditions of generation and materials.

The dimension of detector 622 in the y-direction is shorter than the stopping range so that most of the heat, lattice damage, and beta release occur in the drain liquid 630. Assuming that the detector and drain liquid have a same stopping power and the distribution of the range locus has a spherical shape (605, 606), it is found that only a portion of the fission products flying within the solid angle 608 can escape the detector 622 and decelerate to rest in the liquid 630. So the drain efficiency of the planar structure is about 50%.

A plot 628 represents a distribution of the predicted fission product concentration in an arbitrary unit (horizontal axis) along the vertical axis. The F, T letters denominate the detector thickness and the total thickness of a pair of detector-drain liquid layers, respectively. The thickness of the detector is set to about 80-90% of the particle range in the detector, where the range is about 14 microns for conventional urania detector. The stopping in scintillating drain liquid is even harder than in other fluids so their thickness have to be adjusted accordingly. As an example, a modulus of 10-1-10 microns of Actinide-Insulator—Fluid may be used in the detector assembly shown in FIG. 6 to make a neutron, hard gamma or energetic proton, deuteron, muon detector based on using induced fission to generate a measurable entity like light spark, charge cloud or ultrasound pressure wave.

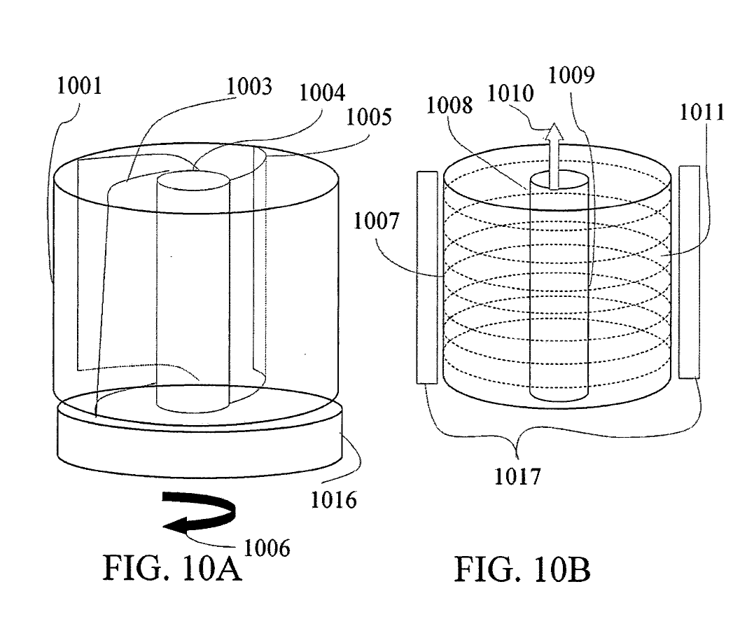

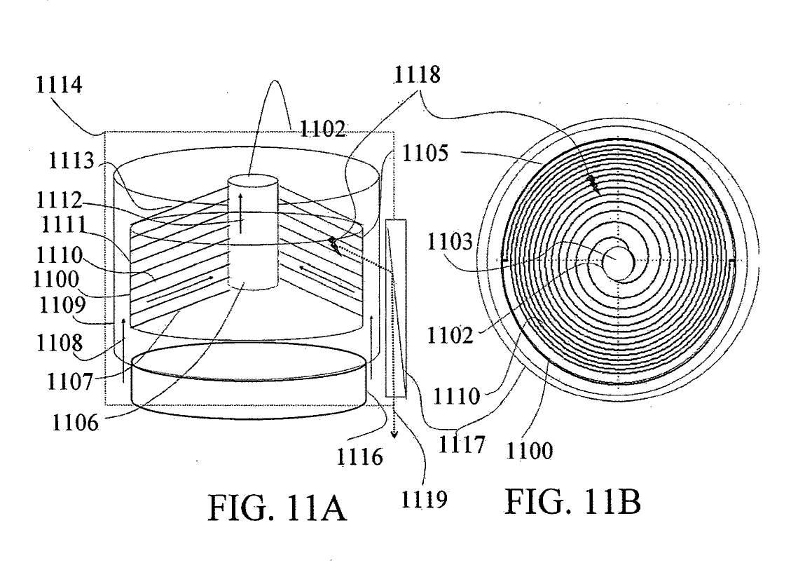

The detector may be fabricated by selective excitation vapor deposition in one of the following shapes: 1) planar shape (see FIG. 10) of a condenser structure with vertical stability connections, and 2) conical shape (see FIG. 11) when the object is tilted and spins. The detector structure may be:

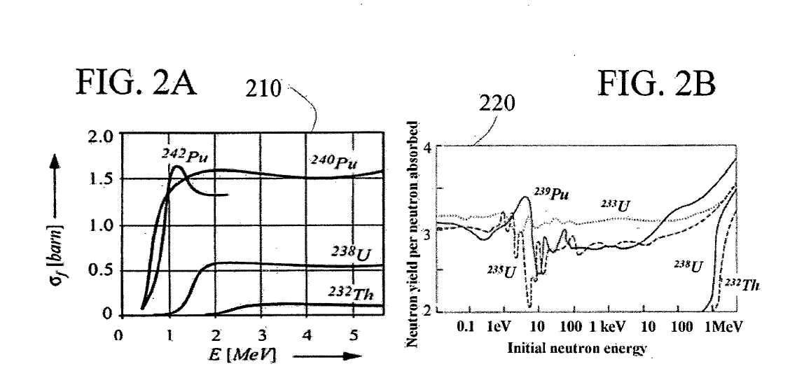

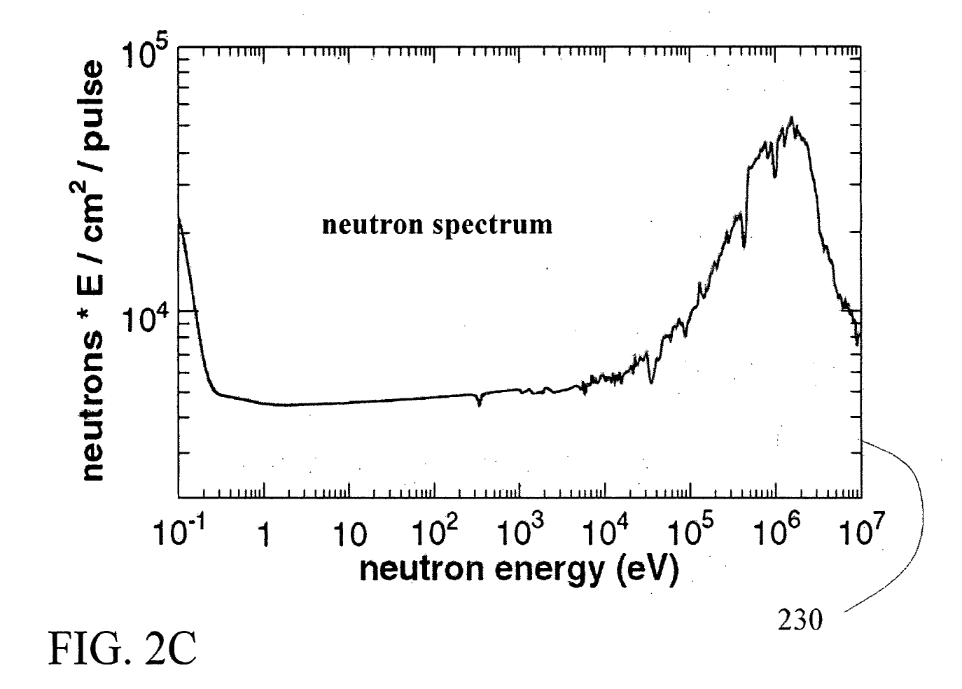

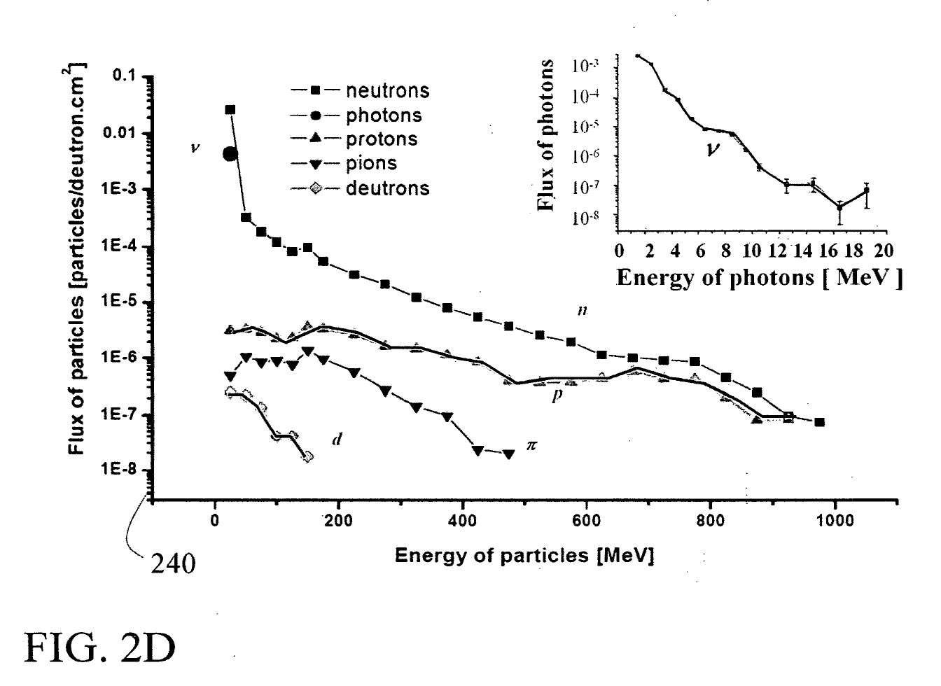

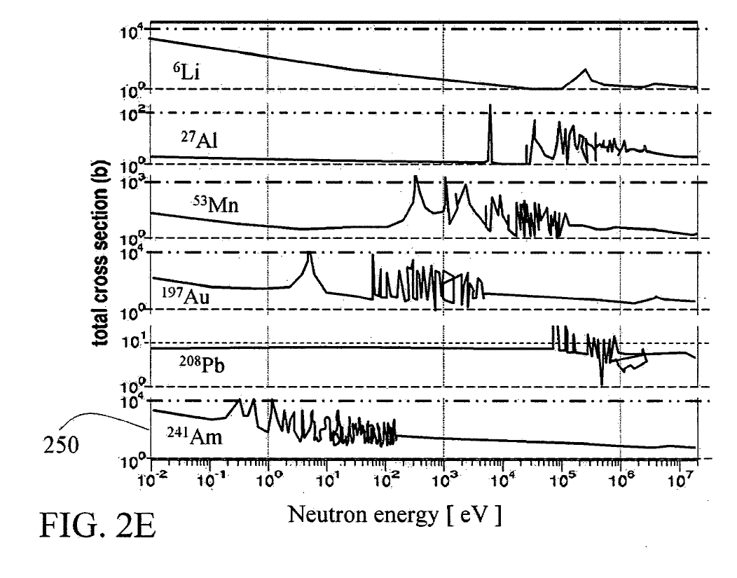

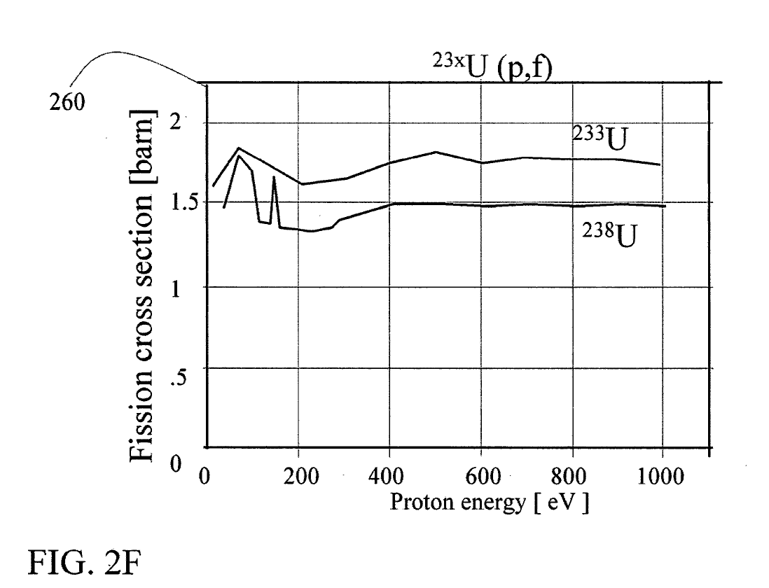

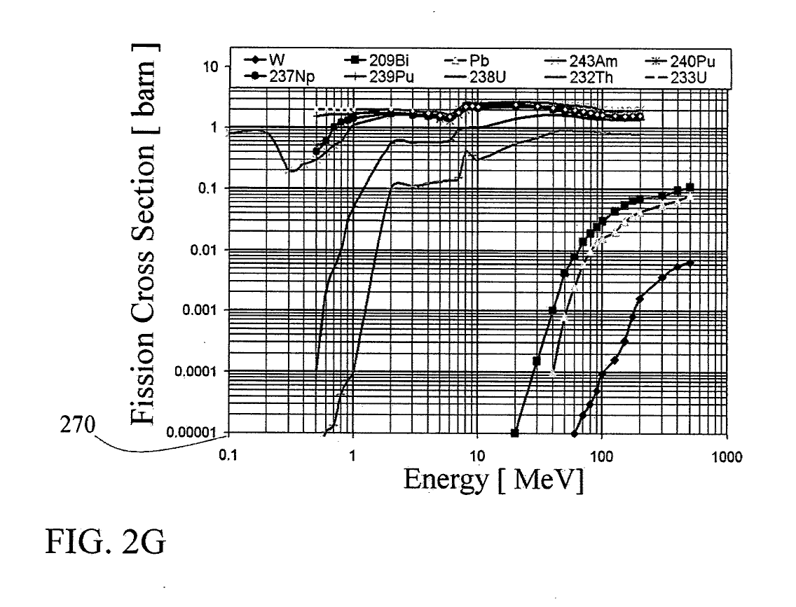

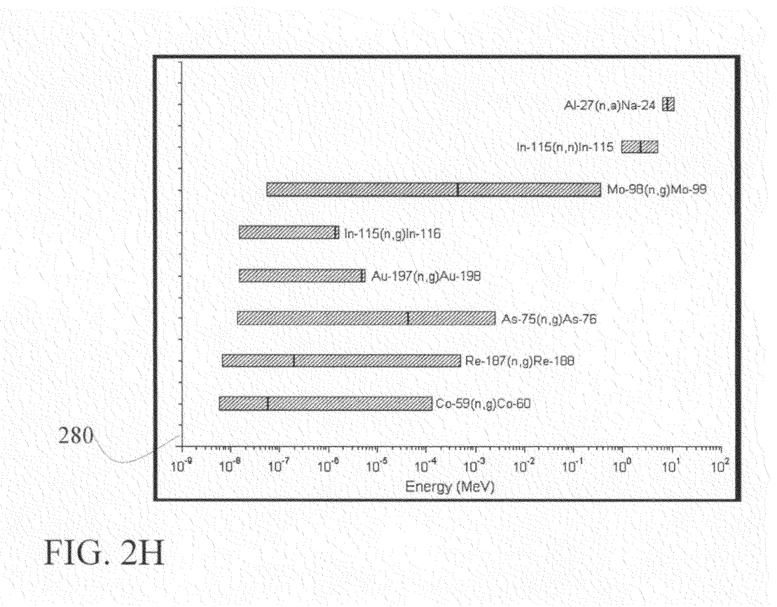

1) low temperature structure when the detector is made from metallic compounds like U—Pb; Pu—Ga/PbBi, AmU/Pb,
2) medium temperature structure when the detector is made from Urania, Thoria, Plutonia in tungsten lattices and the LBE drain fluid is encapsulated in stainless steel cladding for NaK or LBE cooling, or
3) high temperature structure when the detector is made from ceramics of UCWTi and self sustained in a WCTi cladding with Zircalloy drain liquid and He cooling.
Other combinations may be also used according to the basic information presented in FIGS. 1 and 2, in order to obtain a plurality of simultaneous real-time information.

For the reactor detector channel design, the positions and directions of the detector structure need to be considered. As an example, for a drain liquid, due to high static pressures, a horizontal and low tilted structure or a short structure is recommended, while for dielectric drain liquid, orientation may not be important because the static pressure drop is relatively small, but may have charge recombination loss due to high buoyancy of thermal spike affected volume.

The shape of the structure is of micro-wires or planar micro-foils. Their mechanic stiffness are imposing some dimensional limitations.

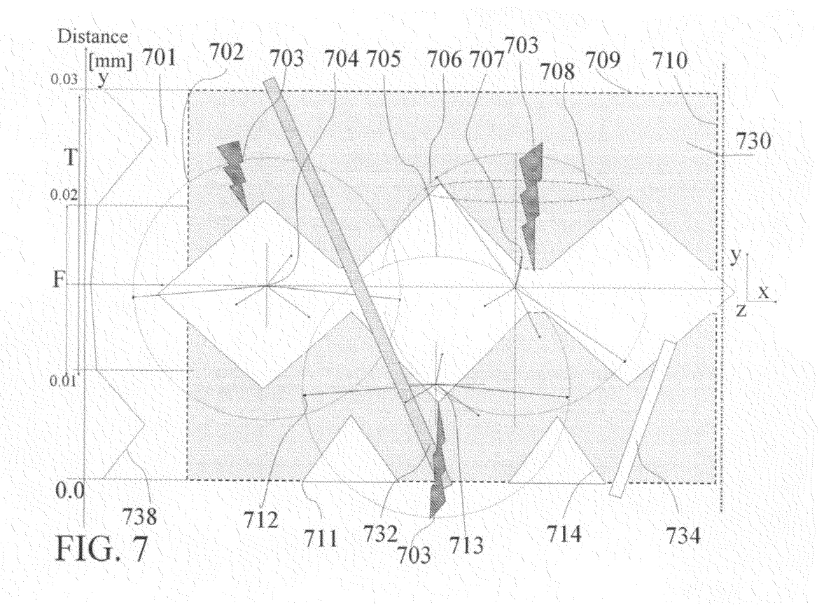

FIG. 7 is a schematic cross sectional diagram of an elemental modulus according to FIG. 5 being an example of the application of the “effective length” method on two directions only (the thickness), generating a wire like or profiled layer structure, 709 being another embodiment of detector having a bi-dimensional structure in accordance with the present invention. To enhance the fission product escape angle (608 in FIG. 6) and thereby to increase the drain efficiency and mechanical stability of the solid detector lamella, the detector 701 has a varying thickness and includes prism-shape portions. The detector 701 may be generated by controlled plasma spray technique, CVD technique using masks, or heterogeneous electric field electrochemical bath deposition. The effective length principium in FIG. 5 has been applied twice to determine the dimensions in the x and y directions.

As depicted in FIG. 7, the detector lamella has a profile of connected prisms along the z axes to enhance mechanical strength and escape angle. The effective escape angle of the detector 701 may exceed 70% of the total solid angle and more than 80% of the detector fission products are released into drain fluid 730 surrounding the detector 701. The spheres 705, 706 represent the penetration ranges of fission products 712 generated at locations 704, 707, and 713. Assuming the detector 701 and drain liquid 730 have a same stopping power, the escape angle 708 is significantly greater than that of the detector 622 in FIG. 6. The dimensions of the detector and drain liquid determine the stopping power and ranges, and, as a consequence, the escape factor, wherein the escape factor is the number of the fission products stopping outside the detector per the total number of fission. The stiffness of the detector 701 increases by using random vertical connection interfaces 732, 734 between the layers 701 and 714 and channeled or porous cladding connection 702, 710.

The fission spike 703 has variable visibilities for an external optical signal collector as optic fiber or prism reflector, depending on the visibility of the location and its potential reflections of the insulator interfaces. The optical indices are important to be matched too at the creation of this bumpy micro-foil or profiled/variable section wire. The charge collection and the possibility of its accumulation on interfaces changing the liquid affinities become important parameters to match too.

The detector 701 may be manufactured by controlled vapor deposition of solid drain detector on micromeshes, then by annealing and compressing the drain detector to be removed or by electro-deposition of metallic structures. For high temperature reactors, tungsten or titan carbide based structures may be used. The detector 701 may be formed of a mixture of metal and carbides with structural material. As in the case of FIG. 6, the drain fluid 730 may pass through the porous walls 702 and 710. A plot 738 represents a distribution of the predicted fission product concentration in an arbitrary unit (x axis) along the y axis.

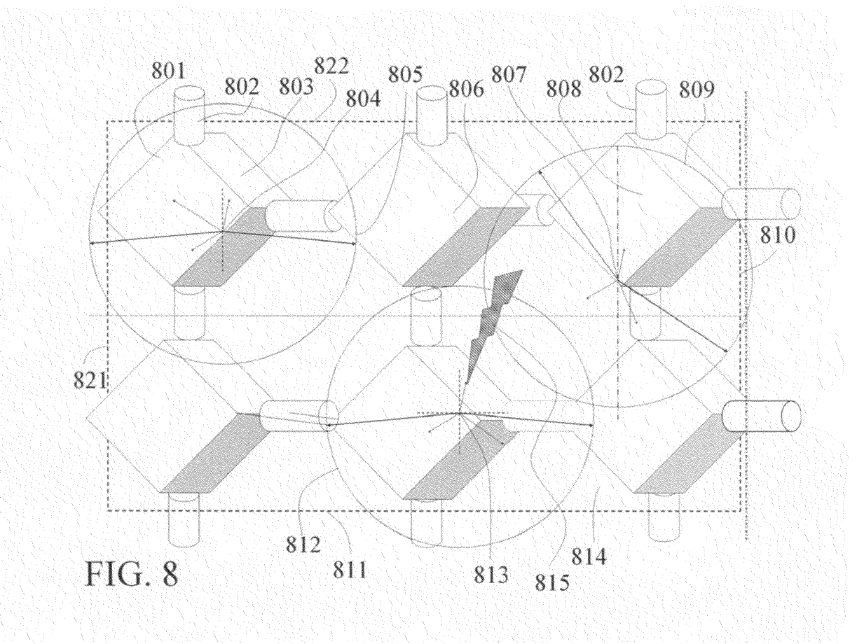

FIG. 8 is a top view of yet another elemental modulus according to FIG. 5 being an example of the application of the “effective length” method on three directions generating a beaded structure or profiled wire, being an embodiment of detector having a web structure in accordance with the present invention. As depicted, the fissionable detector grains or beads 801, 806, 808 are connected by meshes 802. The meshes or filaments 802 are made of tungsten, titanium, steel, etc. and have a thickness in the micron range and are spaced apart from each other by about 20-50 microns. The detector beads 801, 806, 808 are placed on the mesh knots. The beads may be fabricated by hot molding or by vapor deposition of fissile material, such as urania, metal uranium, and plutonium, or carbides or nitrides of the fissile material. To stabilize the meshes, micro-beam electron welding may be used.

The detector has vertical stabilization points 810 to prevent the webs from skidding under the flow of the drain fluid 814. The drain fluid 814 may pass through the porous walls 810, 811, 821. In this structure, the escape factor is increased up to 90%, but is strictly dependent on the dimensions of the detector and meshes. For diluted detectors made from high-enriched uranium (HEU), plutonium, or americium, and embedded in the drain fluid, the escape efficiency may increase up to 99%.

The tungsten mesh stand up to 3200° C. and, if the detector beads are chemically coated by C implantation or carbon plasma discharge, the entire structure may stand over 2000° C.

The fission products are generated at locations 804, 807, 813 and their penetration ranges are represented by spheres 805, 809, 812, wherein the spheres mainly end in the drain fluid 814. The interface 803 between the detector bead 801 and the drain liquid 814 increases the structural stability. It is noted that only six beads are shown in FIG. 8. However, it should be apparent to those of ordinary skill that any suitable number of beads may be surrounded by the porous walls 810, 811, 821, 822.

The fission spike 815 as presented in this structure of 6 beads 801 of about 10 microns diameter of actinide fissile material according to FIG. 2 is released in the liquid and have good visibility from many observation directions being possible to accurately localize it and its counterpart. The usage of a spectrometric equipment with the optical tri-directional image localization, and ultrasound and charge detection may provide useful complementary information for fission prompt gamma measurement devices as LANSCE's FIGARO and DANCE, and in general for radiation fields measurements, containing radiations able to trigger fission.

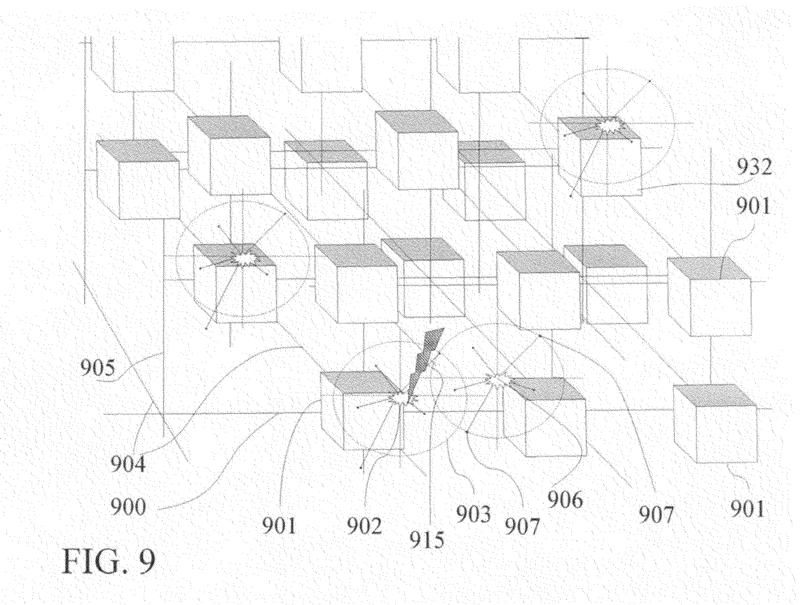

FIG. 9 is a schematic perspective view of still another embodiment of detector layer having a meshed felt structure in accordance with the present invention. As depicted, the detector microstructure in FIG. 9 is quite similar to that of FIG. 8, with the difference that a denser network of wires 900, 904, 905 is used in place of the vertical structural fixture of webs in FIG. 8, creating a highly resistant felt structure. The 3D structural wires or meshes may be created by chemical vapor deposition, or by plasma spray deposition, connecting each 2D web mesh to a third wire 905, wherein the detector beads 901 are located on the knots of the 2D web mesh formed by wires 900, 904.

During operation, the fission act occurs in various locations 902, 906 and the detector nucleus splits generating 2-4 neutrons and two middle mass fission nucle±907 that travel through the detector into the drain fluid 932. The fission products decelerate to stop at the end of the penetration range, creating loci or spheres of probabilities 903. When stopped by the drain liquid 932, a fission product produces a regional dislocation to generate a micro pressure shock wave, and may or may not react with the drain liquid to create a suspension. The detector to drain liquid interface needs to be specially treated to prevent the suspension from clogging. The prevention may be obtained by deposition of delta layers that create a compact structure in the detector. An example is the action of Gd in Pu lattices. PuC or PuGdC coated with a gold delta layer repels the fission products towards the drain liquid. Other structures may be built too. The detector microstructure shown in FIG. 9 is flexible and stable under irradiation. It allows a good ration fissile material to detection absorber material.

The fission spike 915 delivers spherical pressure waves interfering with the lattice beads and in part being channeled on the three directions of the microstructure. The localization may be very accurate at nm level fission spot localization by using the differential time of flight of the pressure waves and light signature. It may tell where in the bead and what fission products has been created and correlate with prompt gamma emission.

FIG. 10A is a schematic diagram of an embodiment of a detector tube section in accordance with the present invention. As depicted, the detector 1005 has a shape of curved plate 1005 (a foil/fabric like detector structure as depicted in FIG. 6 (layer), FIG. 7 (profiled layer of wires), FIG. 8 (mesh)) aligned along the longitudinal axis of a drain tube 1004, wherein the detector 1005 and drain liquid 1003 are contained in a cladding tube 1001. The drain fluid 1003 passes through the porous wall of the drain tube 1004. To compress the structure, the drain tube 1004 and detector 1005 may be rotated in the direction 1006. The detector 1005 has one of the structures described in FIGS. 6-9.

The imaging and detection plate 1016 is delivering a radial localization of the fission spike while the lateral detection bar may give the height information. This may become the elemental module of a nuclear reactor neutron flux measurement system, being able to interrogate other detector rods on the actinide content using prompt and delayed neutrons triggered fission in the measurement rod. The rim effect and heterogeneous composition may drive to accurate spectral description and direction of neutron identification. Using radiation robust optical fiber may do the signal transmission outside the active zone.

FIG. 10B is a schematic diagram of another embodiment of a detector tube section in accordance with the present invention. As depicted, the detector has a shape of multiple circular disks 1011 that are stacked along a drain tube 1008, where the detector 1011 and drain tube 1008 are contained in a cladding tube 1007. The drain tube 1008 has a porous sidewall 1009, through which the drain fluid passes through. Then, the drain fluid flows along the drain tube in the axial direction 1010. It is noted that the present invention may be practiced with other suitable number and form of disks. For example, funnel-shaped disks (see FIG. 11) may be used in place of the circular disks 1011. The detector 1010 has one of the structures described in FIGS. 6-9.

FIG. 11A is a schematic diagram of yet another embodiment of a detector measurement tube in accordance with the present invention. FIG. 11B is a schematic cross sectional diagram of the conical detector disks 1110 taken along the line 1111 in FIG. 11A. As depicted, detector is embedded in the disks in a spiral mesh form. The multiple conical disks 1110 are contained within a pellet porous tube 1100. Each detector disk is shaped like a funnel, creating a helical surface inside. Also, by moving the radial levers 1107, 1113 in the vertical direction, the detector disks 1110 can be compressed within the pellet tube 1100 in order to vary its reactivity and to compensate for the loss of detector and poison accumulation effect due to the burnup. The detector disks 1110 are tightly bound to the pellet porous tube 1100 and the central porous tube 1102. The central tube or drain tube 1102 is used for draining out drain fluid 1103 that contains fission products. The drain liquid 1103 comes from an equipment located outside the external detector tube case 1114, enters the outer tube channeling 1109 in the vertical direction 1108, flows along the space between the detector disks 1110 to collect fission products, passes through the porous wall of the central tube 1102, and flows along the detector tube in the direction 1112 to exit the case 1114, and is sent to a separation unit that is located outside the reactor. In the separation unit, the drain liquid is cleaned up and recycled, while the fission products are separated.

The radial levers 1107, 1113 are attached to and actuated by external levels 1105. From the mechanical point of view, the radial levers 1107, 1113 form discontinuous surfaces and anchor the detector disks 1110 to allow radial diameter modification, cone angle sharpening and twisting the disks into helical shapes, thereby to assure the maximum detector compression with minimal friction between the wall of the pellet tube 1100 and the external lever 1105 and radial levers 1107, 1113. There are other compressible structures, such as squares, hexagons, or other polygons, which assure the compression and shape transformation of the detector pellet during operation. Drawing out the entire reaction channel and using the other end to unlock the detector, by removing all and refilling with appropriate material, may prevent the embitterment and incompatibility of the detector structure. The detector case 1114 and the detector pellet 1111 may have a cylindrical shape, and the small pellets having cylindrical shape are simply added in the cladding tube and kept in contact by the compression force made by the lid devices mounted at the extremes of the cladding tube 1114. In this configuration the porous tube continuously contacts the cladding by guiding fins 1109. The cladding tube 1114 may have a variable cross section to form a frustum. In this case the pellet tube 1100 is discontinuous and together with the guiding fin 1109 creates a longitudinal lever 1111, and assures the pellet's external surface stability.

The disc detection plate 1116 may detect pressure waves or light emerging from the fission spike 1118 or both while the height detection bar may detect its vertical localization. It represents another type of detector like radiation-detection element where a combination of conic and cylindrical geometry is used to improve the detection performances and to have the immersion liquid smoothly flowing unperturbed by buoyancy effect of the thermal component of the spike.

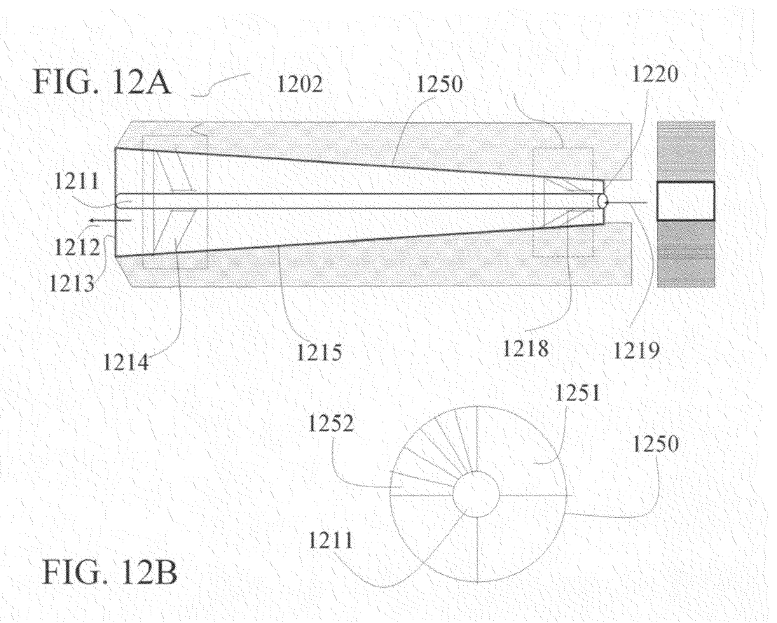

FIG. 12A is a schematic longitudinal diagram of still another embodiment of an entire detector measurement tube 1250 having a variable section in accordance with the present invention. FIG. 12B is the cross section of the detector tube 1250 shown in FIG. 12A. The structure presented in FIGS. 12A and 12B represents a mode of assembly of the detector in order to maintain constant reactivity along the reaction tube with the possibility of taking out the detection signal while maintaining a cylindrical geometry. The volume of the detector versus liquid varies with the longitudinal position in the detector, to assure about the same reactivity all along the height. Itis designed not to modify or perturb the criticality of the nuclear structure is immersed in by being a perfect mimic of a water or detector by previously adjusting the measurement tube reactivity.

The reactor detector tube 1250 includes: a conical channel wall 1215, preferably double-channeled; permeable lids 1213, 1220 used to recirculate the fluid, central tube 1211 closed end and having a porous wall and forming a passageway for drain fluid that is injected through one open end 1219; and a stack of detector meshes or conical disks 1214 that are similar to the disks 1110 shown in FIGS. 11A-11B. The drain fluid passes through the porous wall of the central tube 1211, in direction 1219 flows through the space between detector layers to collect fission reactions byproducts, and exits 1212 through the permeable lids 1213, 1220 forming an open end and a closed end. It may also flow in the opposite direction. The cross sectional shape of the cylindrical wall 1215 may be circular, rectangular, hexagonal, or polygonal. The channel wall 1215 is shaped to reduce pressure drop of the drain fluid within the tube 1250.

The detector tube 1250 behaves like a variable density tube for compensating the criticality. It makes room for the fission transmission circuits as electric optic and pressure sensors.

The angle of the detector meshes inside the measuring tube is continuously varied from the entry 1214 to the end of cycle 1218. The mesh, felt, or web containing detector beads described in conjunction with FIGS. 6-9 are distributed on the mesh or conical disk in such a manner that the compression is performed at high levels to maintain the criticality.

As in FIG. 12B that shows a cross section through the conic reaction tube 1250. It shows the central tube 1211 used to circulate the drain scintillator fluid through the beaded-mesh structure. The circular section cam be divided in sectors 1251 and each sector may be sub divided in material type sub-sectors 1252 with the purpose of measuring simultaneously the spectrum shape and the directional non-homogeneity. This non-homogeneity may be detected both by the preferential asymmetry in the fission spikes as well as differences among sectors. The spectrum shape may be determined by the ratio of the indication among sub-sectors.

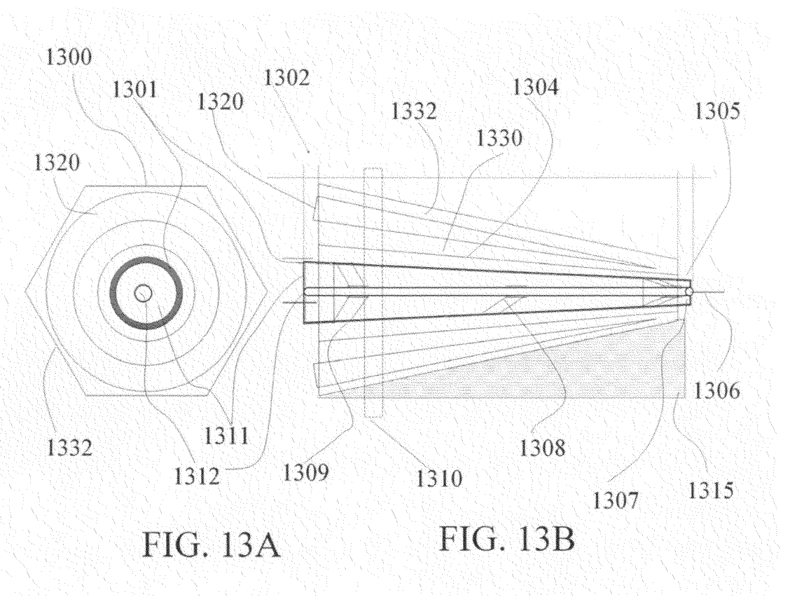

FIGS. 13A and 13B are respectively a schematic transverse and longitudinal cross sectional diagrams of an embodiment of a reactor channel measurement module in accordance with the present invention. As depicted, the module 1300 has an outer hexagonal structure 1332 and an inner variable section detector tube 1309. The hexagonal profile serves only as an example. A rectangular or triangular profile can be also used. The shape and dimension of the outer structure 1302 may be changed from case to case while the profile of detector tube 1309 may remain unchanged. The reactor channel module 1300 may also contain safety devices which prevent overheating or melting of the structure and measure the heat flux from the tube 1309.

As depicted in FIGS. 13A-13B, the variable section detector tube 1309 is similar to the tube 1250 in FIG. 12A and includes: a loading lid 1311 for loading the detector pellet 1308; and an unloading lid 1307 for unloading the used detector meshes or pellets. Drain liquid flows into the inlet 1306 (the open end), while the loading lid 1311 acts like an open end and has pores through which the drain fluid passes flow to exit the tube 1309. Cooling fluid flows through a passageway 1304 formed around the tube 1309. A structural element 1330 may be located around the passageway 1304. The central tube has the porous lid 1312. A technologic space 1320 surrounds the structural element 1330, wherein the space 1320 may include neutron absorbers, control rods, etc. A structural element 1332 surrounds the technological space 1320 and may have a hexagonal cross section. The detector tube 1301 is fixed in the hexagonal reactor module 1300 and is loaded/unloaded by robotic arms in the area 1302 and 1305. From the reactor tube element the reactivity calculations are taking in account the entire section and its variation have to preserve the reactivity versus burnup. The detector is displaced to compensate its burnup along the reactor channel.

As describe in conjunction with FIG. 12A, the adjustment of detector density to a preset value is externally driven by a variable step screw or by a device for advancing the radial drive lever, toward the tip of the tube 1309.

The lateral conic system 1215 complementing the conical inner tube is used for sensor connections as optical wave-guides, electric cables for charge, pressure transducers and other measurement devices inserted in the measuring detector rod.

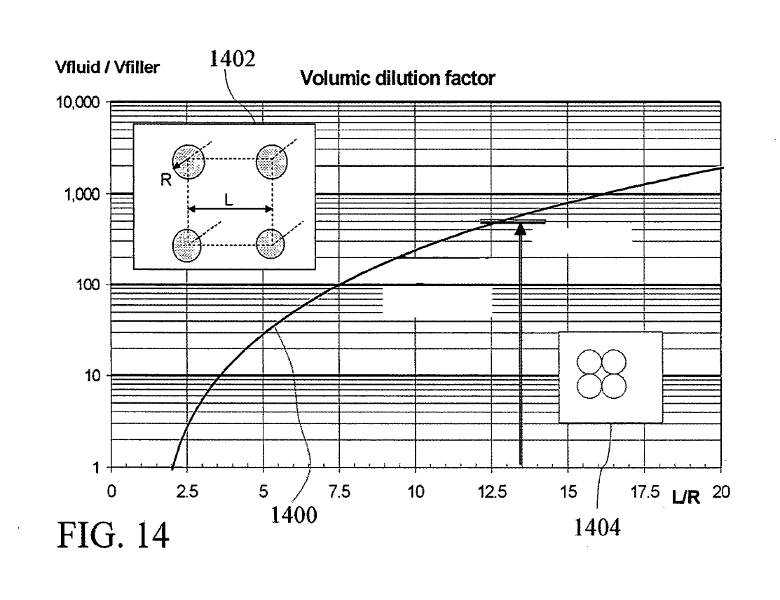

FIG. 14 shows a plot of volumetric dilution factor 1400 as a function of a volumetric parameter L/R, where L and R is the distance between two detector beads and the radius of the detector beads, respectively. An inset drawing 1402 shows the initial and final conditions of an exemplary cube, wherein the cube includes laterals made of imaginary compressible springs and detector beads that are placed at the corners and have a diameter D. Initially, the corners are separated by a distance L that is greater than D and the distance L gets reduced by compression until the beads touches each other, i.e., L equals D. It is supposed that during burnup the diameter D of the beads do not change while the fissile material is removed from the bead, until the bead includes only the insulator shell. For the purpose of illustration, each bead is assumed to have an inner portion and an outer coating layer. The inner portion of the bead is a generator formed of fissile material and generates fission products. A coating layer that insulates the generator from the surrounding environment, such as liquid metal, and is preferably a carbide nano-layer protects the bead. Thus, in the present example, the beads are incompressible and consume the inner fissile material until they become empty shells. The variation of the distance L between the centers of the beads drives to the exclusion of the filling liquid from the volume inside, which corresponds to the variation of the concentration defined as the volumetric ratio between the drain fluid and fissile bead filler called generator, Vfluid/Vfiller.

The plot 1400 shows the ratio Vfluid/Vfiller as a function of the ratio L/R as the ratio varies from 2 to 20. As can be noticed, the ratio Vfluid/Vfiller varies by a factor of 2000 while the distance ratio changes by a factor of 10. This means that in the case of the lowest dilution at which the criticality needs be compensated, a variation of the ratio L/D from 15 to 2 yields a change of Vfluid/Vfiller by a factor of 1000, covering a wide range of concentration and thereby enhancing the burning ratio up to 99%. As an example, consider the case of Uranium Dioxide (urania) for which the beads diameter may be around 10 micrometers. The initial startup distance L may be 300 micrometers, while the ending distance may be 25 micrometers. During this entire compression path 99.9% of the uranium has been consumed. In reality, a burning factor of about 90% or higher might be achieved considering other safety factors applied to this detector. Compared to conventional burning factors, the detector usage is increased by a factor of 10.

The inset diagram 1404 shows the chosen detector cells. Other elementary cells may be chosen to assure better compression factors. Also a combination of 1 part UC in 2 parts of UO₂ may be chosen to have a consumable cell eliminating CO₂, while the fission occurs, bringing a positive criticality variation due to the modification of the total neutron cross sections as a consequence of the burning, to compensate for the partial fission product retention in the bead.

As discussed in conjunction with FIGS. 6-14, various embodiments of detector structure and detector tubes include a detector and drain/cooling liquid. Accordingly, the effective thermal conductivity of detector may be different from conventional detectors.

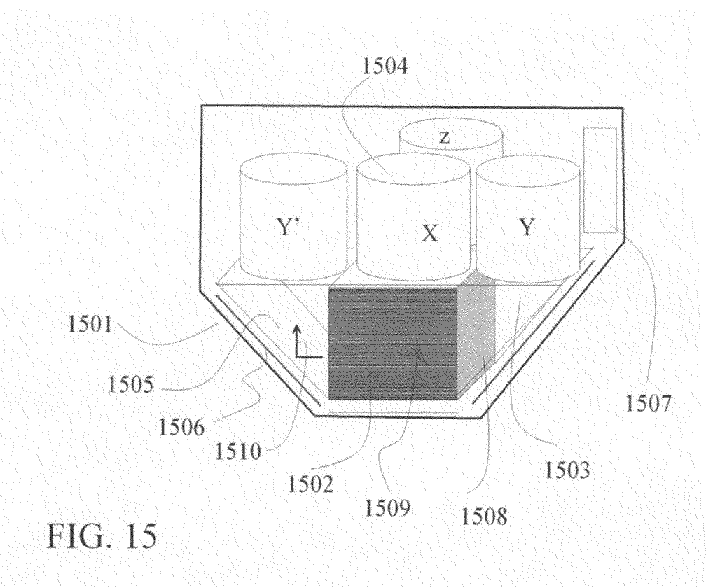

FIG. 15 shows a multi-radiation detection module based on a high geometry fission enhanced detector, able to measure the neutron flux spectral components intensities at once its direction and additional gamma and charged particles. It may be design to be used in fluid environments and vacuum.

The detector assembly package 1501 contains a set of fission prone hetero structured mixture of detector and scintillator fluid 1502 and a system of optical guides 1505, ultra-acoustic sensors and charge sensitive preamplifiers 1508 that localizes the fission act and may be capable of isotopic recognition. The optical scintillation 1509 image is detected using the facets of the hetero-structure micro-beaded system 1502. The total reflection prisms 1506 are driving the signal 1510 to a photo-cathode or micro-channeled plates 1504 able to amplify the optical signal and identify its spectral signature.
Versions of this equipment can be built. The lateral sites may contain gamma detectors 1503 while the facets are plated with charged particle detectors 1506.

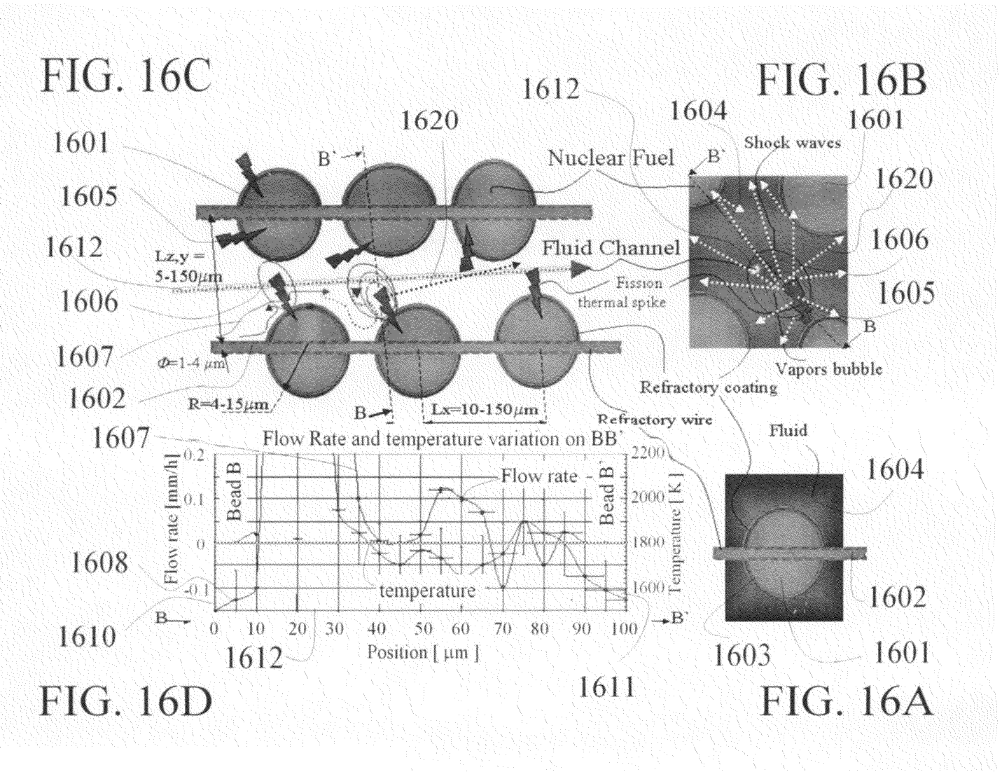

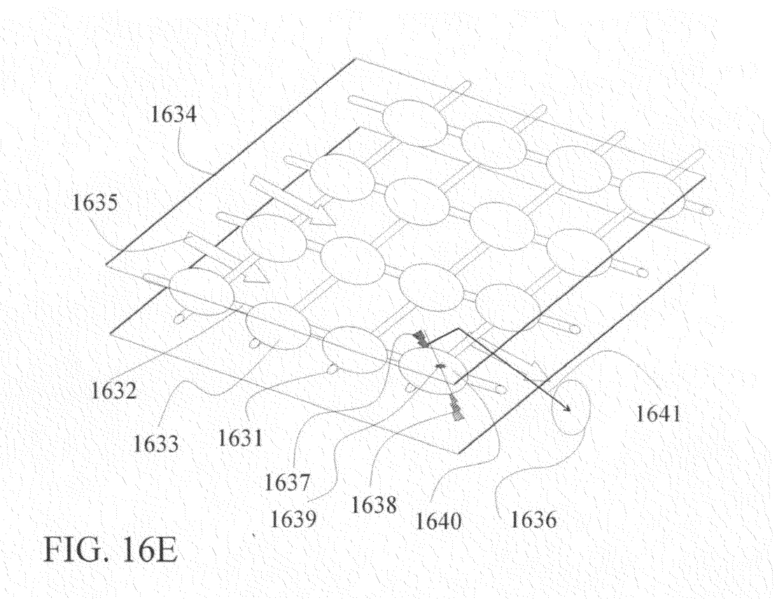

FIG. 16A is a schematic cross sectional diagram of a micro-hetero-structured bead 1601 containing the fissile material, supported on a micro-wire 1602 having good refractory and radiation resilience properties. The bead is coated in a thin nano-layer 1603 mainly to improve the chemical stability and liquid interface. It also has a role in radiation damage containment and recovery. The bead is immersed in a liquid that usually is optically transparent and has a high scintillation capability. A glassy material may be used too, but it may have shorter lifetime and properties degradation with dose due to immobilization of the fission products.

FIG. 16B is a schematic cross sectional diagram of a micro-“hydraulic” channel formed by the vicinity of 4 wires with beads 1601. When fission occurs, its spike 1605 gets out of the bead discharging its charge and collision damage into the fluid. The discharge produces a shock wave 1606 that propagates like a solitron or ultrasound acoustic wave being accompanied by an optical micro-flash 1620 that can be detected from the borders of the detector pack. It also reflects on the surrounding beads coating, giving some interference patterns. The spectral composition consists in about 10,000 photons specific to the fission product and its molecular instantaneous combinations with the scintillator, and over 100,000 photons emitted by the scintillator. The matching of the scintillator, reflective beads coating is a very important technological aspect.

The liquid scintillator flows smoothly inside the micro-fluidic channel with irregular shape and drains out the damaged fluid by the fission spike.

FIG. 16C is a schematic longitudinal section of a nuclear detector fission enhanced micro-fluidic channel as seen in the direction BB′. A plurality of micro-beads 1601 are deposited on a micro-wire 1602 being subject to particle (neutron, gamma or charged particle) induced fission. The fission products generates the spikes 1605 getting out of the bead in positions dependent to the fission initiation location. A central fission will produce equal small spikes while an off center fission will produces asymmetrical, un equal spike discharges 1605, accompanied by optical waves 1620 along the channel. The smooth flow 1607 of the scintallator fluid takes out any remnant damage due to fission products, and it transports the pressure wave 1606 along the micro-fluidic channel 1612.

FIG. 16D is a chart representing the variation of the flow 1607 and the temperature along the fluidic channel 1612. On the left scale 1610 it is represented the flow rate 1607 in mm³/h as function of the relative length 1612 in [%] along the micro-flow geometric direction 1612. On the right scale 1611 is represented the temperature in [° F.] along the same fluidic channel 1612. It is observed that when crossing the fission spike shock waves 1606 both the flow and temperature runs out of scale, and come back shortly after that.

FIG. 16E is a schematic cross sectional diagram of a nuclear detector fission micro-hetero structure building detail in accordance with an embodiment of the present invention. The structure is formed by a metallic wire 1631 coated with photo-resist or oxide that is stacked together by electron welding or spot welding in a mesh 1632. Around the contact points the photo resist is removed and allows the growing of a fissile material bead 1633 by electrochemical deposition or CVD. The beaded mesh is further coated by thermo-chemical diffusion in carbide or nitrite nano-layer that stabilizes the structure. For the reader indication the wire mesh has a thickness of about 4-6 microns in diameter, the bead is of about 10 microns in diameter if made from metallic uranium, and the mesh step is of about 50 microns, all the mesh in the image being content in a volume of 200×200×50 microns.

The beaded mesh is fixed between two reflective metallic foils 1634 possibly aluminum and a scintillator fluid 1635 is introduced between the said aluminum foil. The structure is further packed to create a sensitive detection volume. For each channel is added an optical signal collector 1636.

As depicted, when a fission 1639 occurs in a bead the two fission spikes are simultaneously leaving the bead 1640 stopping in the scintillator liquid. The upper spike 1637 and the lower spike 1638 are equal if the fission 1639 takes place in the center of the bead 1640. If the fission is off center one spike is bigger than its opposite, and the ration of their signals may be a good position indicator.

The fission products in contact with the scintillator liquid are producing a optical pulse 1641 containing eigen frequencies of the fission product covered in scintillator liquid specific frequencies carried away for spectral pulse analysis by the optical collector and carrier 1636.

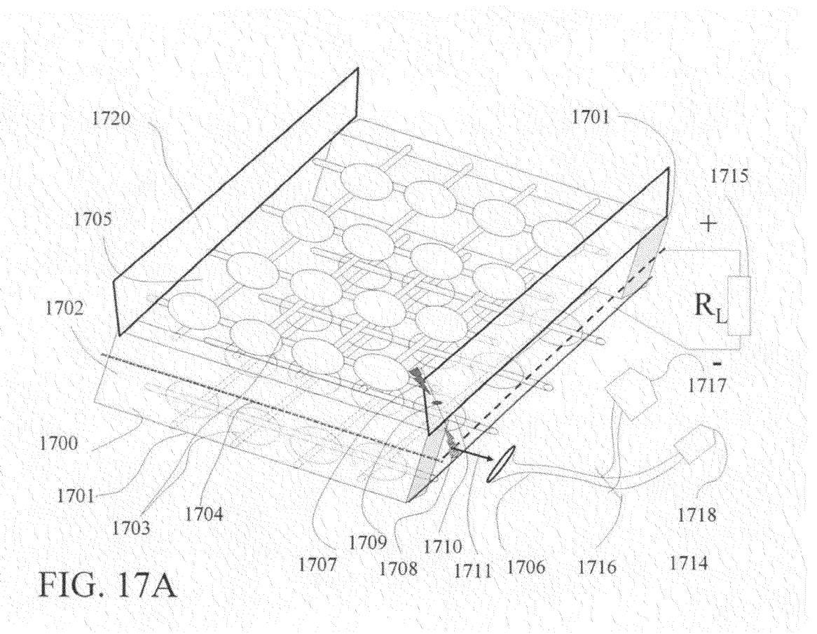

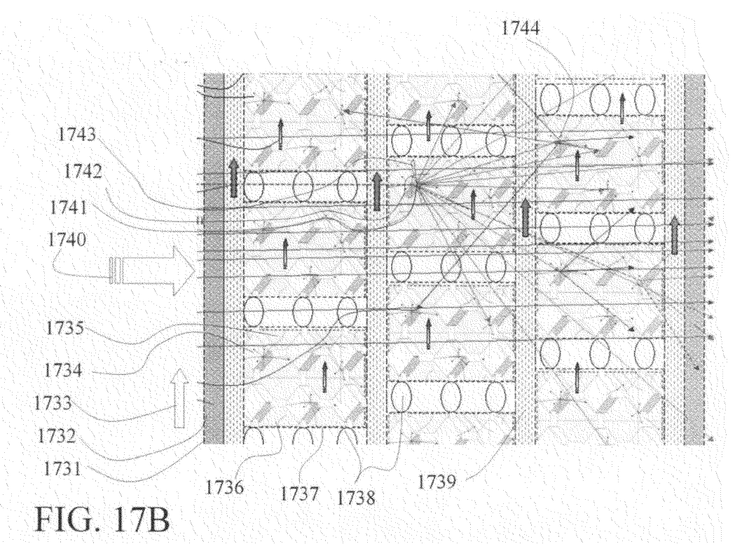

FIG. 17A shows a schematic diagram of the same mesh from FIG. 16E packed in a two layered micro-hetero-structure in accordance with one embodiment of the present invention. The two reflective metallic foils 1704 possibly aluminum are electrically insulated from the micro-beaded mesh 1701 by using a dielectric transparent supports 1702 that may or may not incorporate the optic collector 1706. The scintillator fluid 1705 is introduced and may flow between the metallic reflective foil said aluminum foils surrounding the beaded-mesh and forming a capacitor connected electrically to the external resistor load R_{L} 1715 that can be a charge pulse amplifier that may detect the moment when a fission occurs and the voltage between the mesh acting like a grid and the foils changes. A differential connection is also possible to show the size of the discharge outside the bead and its asymmetry. The structure that may be as large as few inches, depending on the parameter optimization is further packed to create a sensitive detection volume. For each channel made between the conductive foil the raw of beads in the mesh is added an optical signal collector 1706, that may be an optic fiber 1706 or a reflection prism. Also, in actual detector setups, each element may have a suitable multiplicity, shape, dimension and position according to the design requirements.

The embodiment of the current detection array may have one or more of the following features. Firstly, the detector without the compressibility feature to compensate for reactivity may be used in actual designs if the detector pellets channels are modified accordingly. Secondly, controlling the poisons and actinides burning can be done in dedicated channels because of the burnup and reactivity issues. Thirdly, the fission products are to be continuously removed.

The detector setup body 1700 contains the detector mesh dielectric supports 1701 with the drain scintillator liquid intake 1705.

The nuclear detector volume contains a lower detector mesh 1703 inside the conductive separator foils or grids 1704 stabilized mechanically by the supports 1702. Because the detector operates on various fission regimes heat released by fission have to be removed by a combination of conductive foils or Peltier junction 1720.

The fission 1709 produced inside the bead 1710 releases in the scintillator liquid 1705 two opposite spikes 1707 and 1708 that generates light signal 1711 collected by the optical cable 1706 accompanying the electric and acoustic pulse. The thermal component is cooled down by thermal conductivity of the conductive foil 1704 that may be also made by graphite nano-foils metallically plated for optical reflectivity reasons. The optical signal travels the optical cable 1706 towards a beam splitter 1716 that drives the signal to a optic pulse detector 1718 and to a spectroscopic equipment 1717. The multi-channel emission spectroscopy identifies the type of fission product and its initial excited states. The length of the electric pulse is of about few ns while the optical pulse may take a longer time due to scintillator specific excitation transfer processes.

FIG. 17B shows a schematic diagram of the same detection mesh from FIG. 16E packed in a spallation target fission enhanced detector zoomed section. The dimensions of the detector section 1731 are about 0.1×0.1 mm². It may be fabricated in cylindrical or rectangular pellets of various dimensions having the outer cladding wall 1732 cooled by an external flow system 1733.

The detector assembly contains fissile micro-beads 1734 embedded in the scintillator fluid 1735. The micro-beads arrays are grouped together in a sub-cell containing several tens micro-beads raws 1736, bordered by permeable, transparent walls 1737 that lets the scintillator fluid flow through. In the near vivinity there are placed optical guides and pressure wave sensors 1738, and electric charge collectors and depolarization grids. Supplementary inner cooling fluid channels 1739 that maintain the detector array cooled at the right operation temperature separate the cells.

The accelerator beam 1740 made of high energy protons or deuterons hit the sensor and the target triggering spallation reaction 1741. A bunch of neutrons pops out 1742 and frequently two middle mass fission products or only one 1743. Its light spark and its pressure shock waves are detected in nearby signal collectors 1738 and driven to transducers outside the irradiation zone. Some of the neutrons are producing supplementary fissions 1744 in the fissile beads or simply scatter or are absorbed in the material.

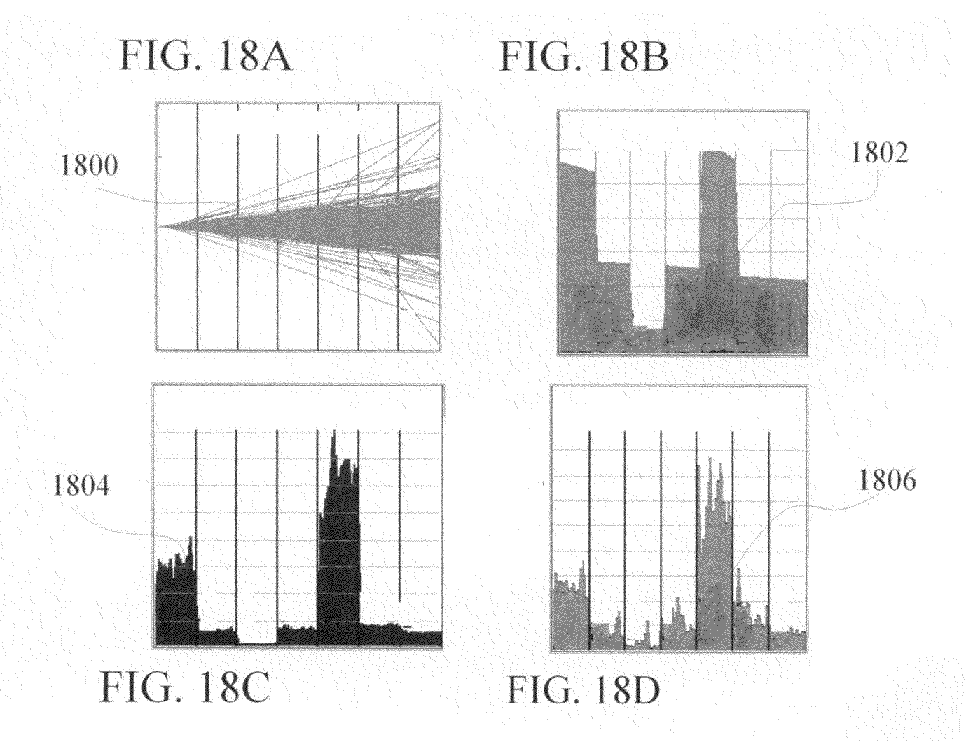

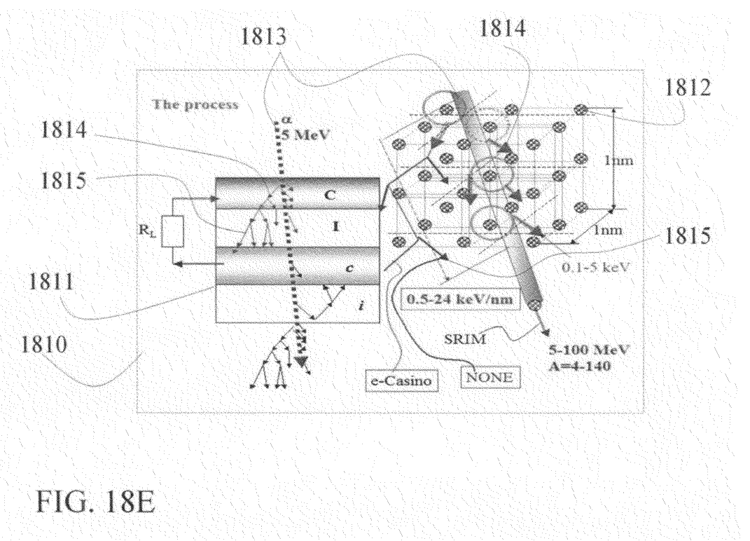

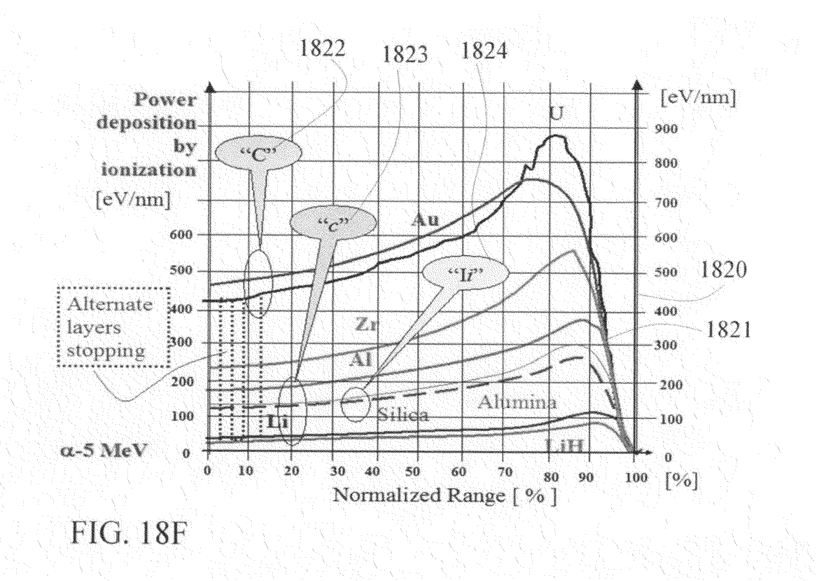

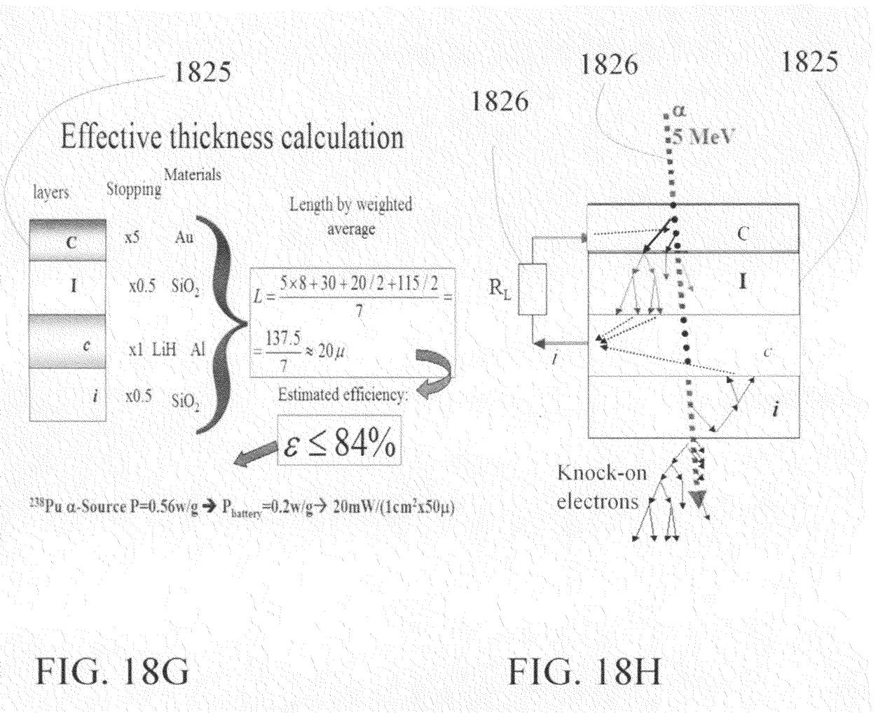

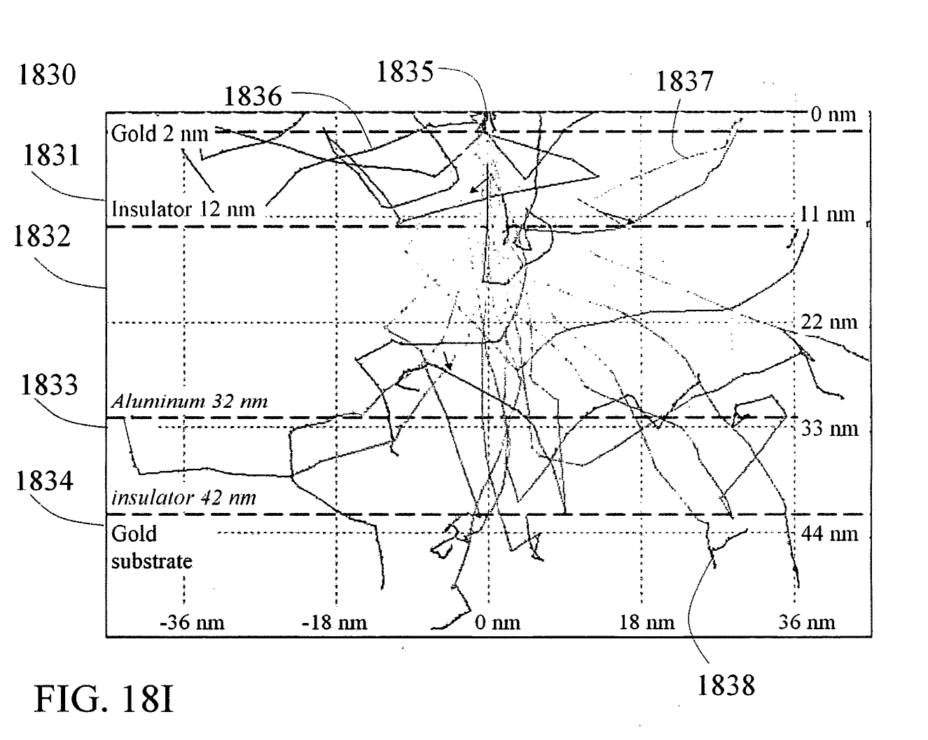

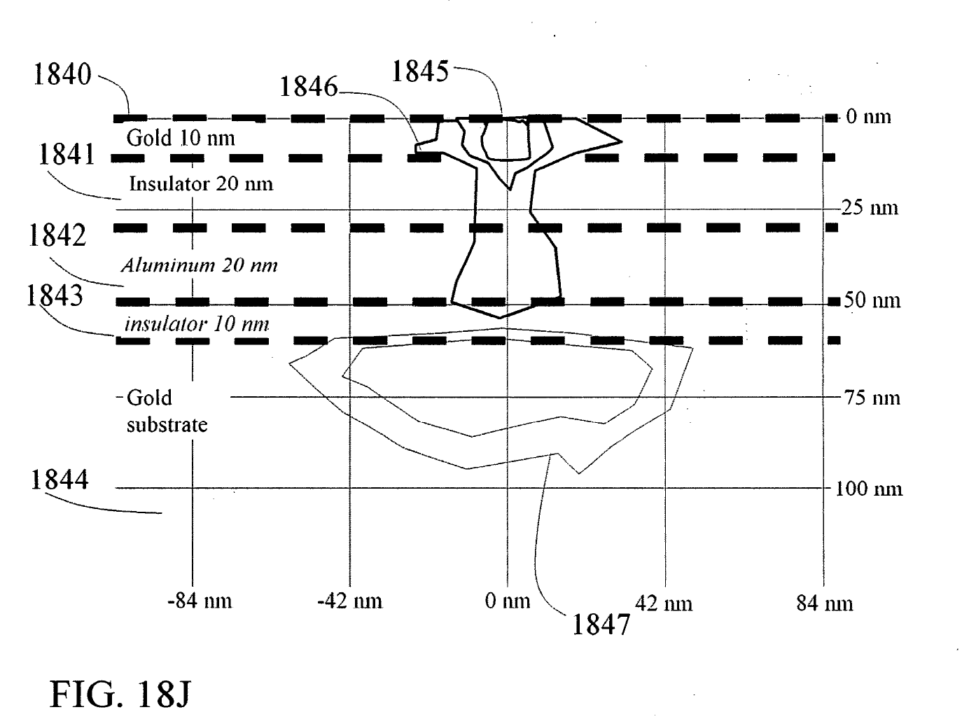

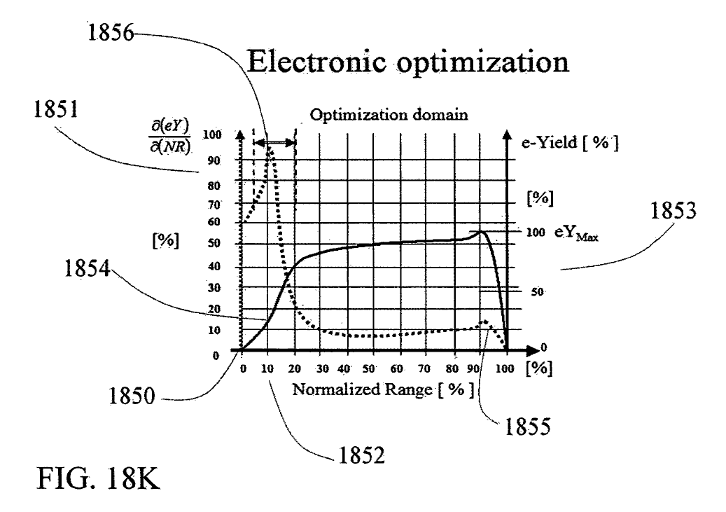

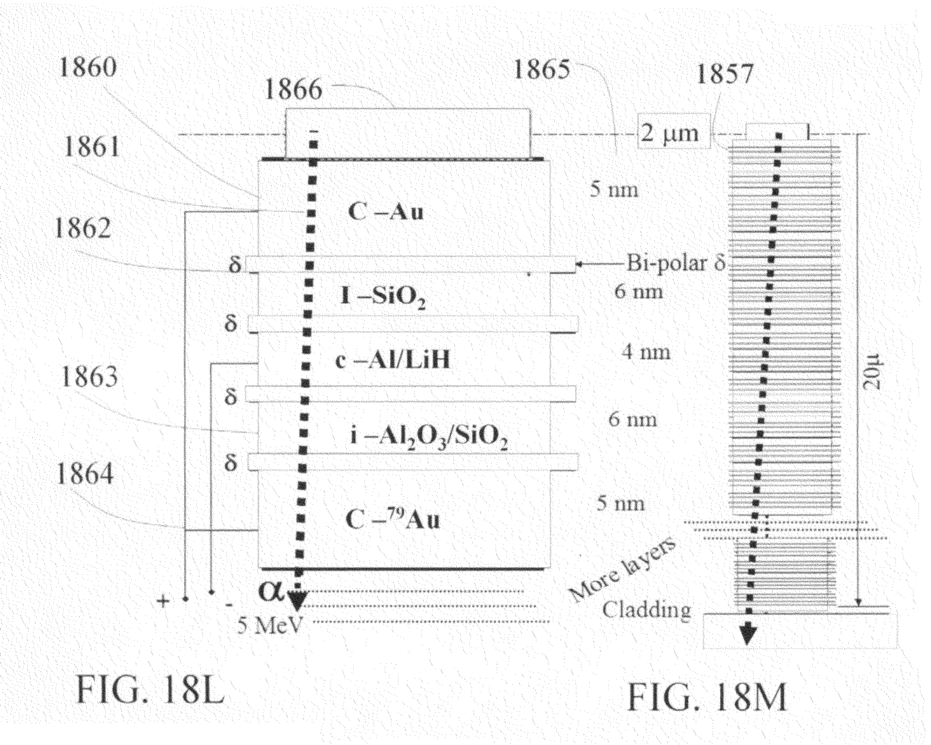

FIG. 18A shows a plot of exemplary trajectories of fission products, 100 MeV 140-Cesium atoms, showed in FIG. 1C as having about 68 MeV, 1800 penetrating a target that has multiple nano-layers made from various materials. The energy difference makes little difference in these first nano-layer energy deposition used for exemplification, due to a constant ionization rate at these high energies. The first and fifth layers have high electronic concentrations while the third layer has a low electronic concentration and the rest are insulating layers, such as Teflon layer. As depicted, for thin layers of 500 nanometers thick, lateral straggling or angular deviations due to the interaction with the target electronic structures weakly perturb the trajectories of the fast moving nuclei.

FIG. 18B shows a plot of energy deposition by ionization 1802 in the target layers of FIG. 18A. A large difference between the “generator” type layers, the first and fifth layers, and the “absorber” type layer, the third layer, can be noticed. The “insulator” type layers have an average interaction with the nuclear particles.

FIGS. 18C and 18D respectively show plots of phonon energy (or, energy transferred to phonons) 1804 and recoil energy (or, energy transferred to recoils) 1806 in the target layers of FIG. 18A. As depicted, layers having actinides take less recoil compared to the layers having lead, even though both layers have high electronic densities. The figures also show that the energy to phonons and to recoils is less than 0.1% of the energy transferred to electrons and ionization. This means that the electronic transfer efficiency is greater than 99%. As such, a proper sequence in the target layers may reduce heat release to the target and allow cryogenic structures to become potential energy conversion devices.

FIG. 18E shows a schematic diagram of a system 1810 for direct conversion of a moving particle 1813 kinetic energy into electricity showing in parallel the energy deposition process 1811 and the actual computer simulation capabilities 1812 an embodiment of a device for direct conversion of fission—fusion energy into electrical energy in accordance with the present invention.

The moving entity 1813 a charged particle or fission product crosses the “CIci” structure 1811 interacting through ionization and generating primary knock-on electrons 1814 that leave the “C” layer positively charged. Inside the layer they interact with other electron 1815 sharing their energy and impulse and forming an electron shower.
The figure in the right is a zoom in 1 nm³ of the “C” layer 1812 showing the moving entity track 1815 and its interaction, The simulation software used was srim-2008 for moving entity and e-casino for electrons, using the interaction files in common.

FIG. 18F shows a chart with the specific power deposition of an alpha beam in materials to be used in direct conversion of fission—fusion energy into electrical energy in accordance with the present invention. The chart shows the ionization specific energy deposition 1820 in [eV/nm], for a 5 MeV alpha particle specific to actinide decay, for various stopping materials 1821 as function of the normalized range. It is seen that some materials are qualifying for “high electron density” conductir layers “C” 1822, another group for “c” 1823 and other with dielectric properties for insulators “Ii” 1824. The chart shows the alternance of the energy deposition in a “CIci” structure showing a 1:8 variation of the energy deposition from a “c” layer to a “C” layer used as charge deposition mechanism.

FIG. 18G shows a schematic diagram of a thickness calculation of an elementary unit for direct conversion of fission—fusion energy into electrical energy in accordance with the present invention. It is shown a calculation example for the layer thickness based on Monte-Carlo simulation data and previous experiments. It is shown that an efficiency of conversion of 84% is expected for normal incidence alpha beams.

FIG. 18H shows a schematic diagram of the main processes inside the unit for direct conversion of fission—fusion energy into electrical energy in accordance with the present invention. The right image shows the effective path of the radiation 1826 in the “CIci” structure 1825, that polarizes the layers and make them deposit the power as electricity in the load resistor R_{L}.

FIG. 18I shows a schematic diagram of the knock-on electron shower trajectories inside an elementary unit for direct conversion of fission—fusion energy into electrical energy in accordance with the present invention. The chart 1830 shows a perpendicular section through the “CIci” nano-layer structure along the beam, showing the E-Casino plot for 1 keV incident electron beam 1835.

The primary knock-on electrons 1835 interact with other atomic and molecular electrons sharing their energy and generating secondary electrons 1836 backscattered in the first 2 nm layer of gold. The electrons produces second generation electrons 1837 that may backscatter or go forward through “I” layer 1831 and stopping in the “c” layer 1832. There are still few electrons passing through the “i” layer 1833 stopping into the next “C” layer 1834 of the next cell. The weight of these is small under 1% based on the energy distribution of the knock-on electrons.

FIG. 18J shows a schematic diagram of the knock-on electron shower charge density distribution inside an elementary unit for direct conversion of fission—fusion energy into electrical energy in accordance with the present invention. The plot 1840 shows the distribution of charge density resulted from a high energy 5 keV electron 1845 that is deposited in various layers of the “CIci” structure showing the iso-levels 1846. It is visible that very few electrons are stopping in the insulator “I” 1841, more are stopping in the “c” layer 1842, and almost none in the layer “i” 1843. Because the primary knock on electron was taken so large about 5 keV it is seen that they engage a second “CIci” cell stopping in the next “C” layer 1844, and creating the distribution 1847 that shows that the cascade is practically formed in this layer, and its thickness have to be customized accordingly in order to assure about same current across all the “CIci” layers, for an uniform voltage per cell distribution.

FIG. 18K shows a schematic diagram of the nano-layer thickness optimization process of an elementary unit for direct conversion of fission—fusion energy into electrical energy in accordance with the present invention. The chart 1850 shows the principle of the nano layer experimental and by computing optimization. It starts considering the integral electron yield 1854 curve as function of the normalized range 1952, or simply its thickness showed on right ordinate 1853. From the measurements it is extracted the partial derivative vs. length 1855, represented on the left ordinate 1851. It is seen that somewhere between 5 and 20% of its range 1856 the function reaches its maximum. Here the worth of layer surplus is determined and an optimum is made in order to maximize the efficiency by minimizing the layer self absorption and maximizing the layer emission or in other words the absorption in the next layer “c”. In fact it is a trade-off between voltage and current that drives to the optimal construction.

FIG. 18L shows a schematic diagram of an example of elementary unit 1860 for direct conversion of fission—fusion energy into electrical energy in accordance with the present invention. The figure shows the case of a alpha-battery, a case closely related to the capability of detector to measure radioactive powders 1866. The detector is made of a “C” layer with the dimension in the figure, a delta layer 1862 with chemical stability and efficiency increase functions, and so on. The alpha particle 1863 crossing the unit is depositing only a fraction of its energy into detector, and the conductive layers “C” and “c” are connected by nano-wires to the output poles.

FIG. 18M shows a schematic diagram of an elementary unit for direct conversion of fission—fusion energy into electrical energy in accordance with the present invention. The structure 1857 is giving an idea or the dimensions of a single detector unit able to detect 5 MeV of alpha particles made of the “CIci” structures from FIG. 18L. It takes about 20 microns and over 100 units to completely stop the alpha particle. To obtain its identification and energy there is necessary of creating at least 10 sub-groups and identifying the energy deposition with the plots in FIG. 18F.

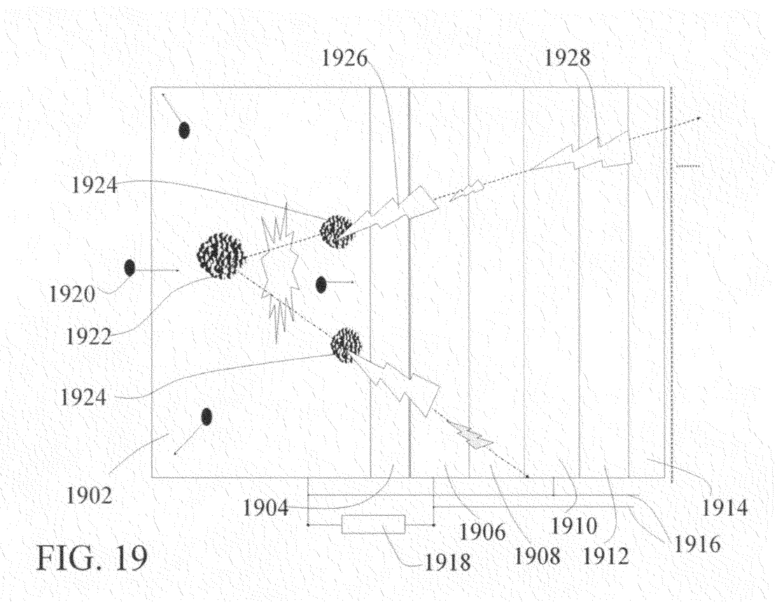

FIG. 19 shows a schematic diagram of a system for direct conversion of fission energy into electrical energy in accordance with the method described in FIG. 5 applied to the moving entity knock-on electrons, an embodiment of the present invention. As depicted, the system includes: nuclear detector 1902 including actinides and operative to generate fission reaction; insulating layers 1904, 1908, 1912; low-electronic density layers 1906, 1914; and high-electronic density layer 1910. As the high-electronic density and low-electronic density layers are conducting layers, the stack of layers 1904-1914 are referred to as “CIci” (Conductor-Insulator-conductor-insulator) layers. For brevity, only seven layers are shown in FIG. 19. However, the direct conversion structure may have any suitable number of CIci layers. Hereinafter, the term G^{fp-c} refers to a material which generates fission products and electrons, a double generator, and is also a conducting material that has high electron density, the term I^{exponent} refers to an insulator material and the exponent shows the type of insulation it provides, while the exponent may be fp, for fission products or e, for electrons. The term A^{e}, A^{fp} refers to a conducting material that has lower electron density among the available materials. The electron density is defined as number of electrons per volume when the volume is infinitesimally small. Typically, the high-electronic density material includes which have high collision cross section for the interaction moving particle knock-on electron, while the low-electronic density material includes material where this interaction is practically very small The electronic density vary from about 20 to 3000 electrons per cubic nanometer being an important parameter in knock-on electron yield. As depicted in FIG. 19, a neutron 1920 hits a fissile nucleus 1922 in the detector 1902 and induces the fission reaction. The fission products 1924 fly apart taking about 80% of the reaction energy. The fission products 1924 may or may not take electrons with them but they interact with the neighboring atom's electronic shell to induce a shower 1926 of knock-on electrons. The fission products 1924 pass through the insulating layer 1904, together with the induced electron shower 1926. The fission products and electron showers enter into the absorption layer 1906 that stops the electrons to absorb the electronic shower and become polarized with a negative charge. The absorption layer may not interact with the flying fission products. The flying fission products 1924 pass through another insulating layer 1908 with no or minimal interaction, and enters into a generator or high-electron density layer 1910 that may or may not content fissionable products. The high-electron density layer induces a new electronic shower 1928 that tunnels through the insulating layer 1912 and stops in the next low-electron density layer 1914. The process of generation and absorption of electron showers repeats until the fission products 1924, which are ionization agents, loose all their kinetic energy and stop.

The “generator” layer with high electronic density remains polarized positively as it looses electrons, while the “absorber” layer with low electron density polarizes negatively as it stops the electrons. If the charges generated in these layers are not removed, an electrical potential builds up to the insulator's breakdown limit. If a suitable circuit 1918 is coupled to the plus (generator) and minus (absorber) layers by electrical connections 1916, an electrical energy can be directly harvested. To make effective CIci layers, it may be necessary to produce stable material interfaces, which can be realized by use of proper shapes.

The thickness of each layer may be in the nanometer range. For example, the thickness of a generator or high electron density, layer, if made of Gold (¹⁹⁸Au), is about 30-55 nm, with an insulating layer made of SiO₂ or Al₂O₃ and having a thickness of about 5 nm, and an absorber or low electron density layer made of Ti or Al and having a thickness of 15-25 nm. These layers may be repeatedly stacked in a thickness-decreasing pattern to form a CIci structure that has an effective thickness of about 12 microns or more and terminates in PbBi liquid. The CIci structure may be manufactured by an ion beam assisted chemical vapor deposition technique, alternating the processes of gun deposition and ion etching. Another approach is to produce the generator layer from an actinide based superconductor that has both semiconductor properties and high electron density and is capable ofgenerating electron showers and fission products, wherein the actinides and super-conducting material are structurally interlaced.

The electronic cloud belonging to various atoms of the detector is strongly perturbed by the fission product movement and associated radiation. The main process is ionization of the nuclei. While Fermi level is around few eV, the ionization energy drop is of about several KeV/Angstrom. Typically, an atom has a diameter of several angstroms. This simply means that the interaction of fission products with matter perturbs internal electrons in the loweir orbits of the matter atoms and in turn removes the internal electrons from the atoms. As each electron has enough energy to share with the other electrons on its path, a nano avalanche, or equivalently electron shower, is created mainly in the direction of the flight path of fission product for impulse conservation reasons. Some other measurements show that when the energy of electrons reaches under a hundred eV, the path length basically becomes independent of the energy and becomes a measure of the Debye length. All the process of fission product stopping and electronic shower absorption is taking place in few pico-seconds, while the de-excitation and the equilibrium are reached in nano-seconds, being based on the return of the dislocated electrons back in structure under the action of the electric forces created by the polarization induced by the dislocations. The concept of direct conversion also relates to the interruption of the path of electron nano loops by use of a CIci structure. Generator, absorber and insulator materials have nanometric dimensions in order to be effective. For electrical polarization reasons, the network is insulated at element level, allowing the voltage to be accumulated as in a capacitor. The conversion efficiency is given by the ratio of the difference between the two avalanches over the total created charge. Typically, the insulator has a high breakdown margin to accommodate substantial accumulation of charges in the generator and absorber layers. The electrical potentials are in the domain of milli-Volts. In the interface between a cluster and an insulator, the quantum behavior may favor the exciton-phonon interaction, harvesting energy from all the possible modes and putting it in electric energy or making the polarization effects vanish. Moreover, the path is preferably short, because the volume distributed conduction is competing with the low resistance path conduction.

It is noted that the CIci layer can be applied to the detector described in conjunction with FIGS. 6-9. For instance, the detector bead 801 may be coated with the CIci layer to directly convert fission energy into electrical energy and the wires 802 can be used to collect the electrical energy.

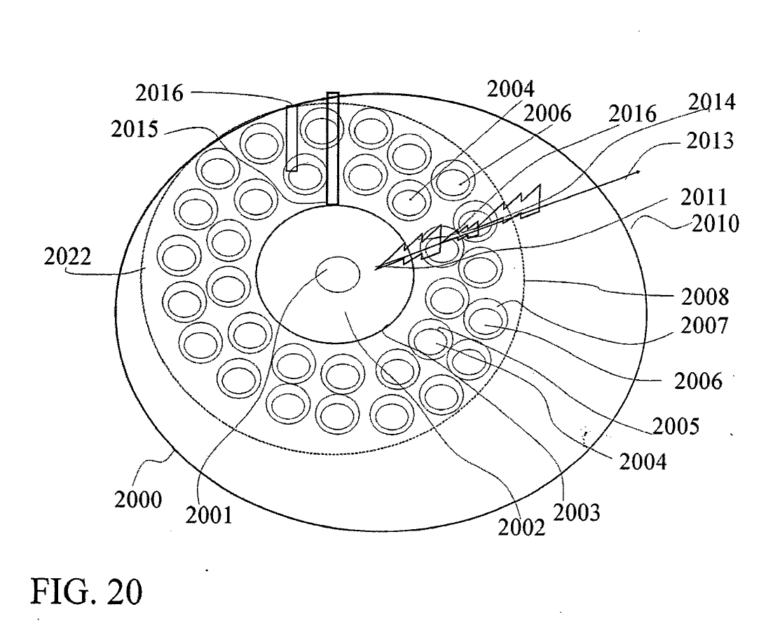

FIG. 20 shows a schematic cross sectional diagram of another embodiment of a device for direct conversion of fission energy into electrical energy in accordance with the present invention. The detector spherule 2000 is encapsulated in an outer shell and surrounded by a drain liquid 2010 that finally stops the fission products. The radius of the outer shell 2000 may be about 90% of the effective fission range. The detector spherule 2000 has the fissile material inner core 2002 made on various fissile materials as shown in FIG. 2 depending on the spectrometric purpose, surrounding a hard core 2001 made from mechanical support materials like tungsten wires like 802 (FIG. 8), conductive materials, same fissile material as 2002 or can remain empty. As variations, the core 2001 may be an empty space or a conducting material that serves as a conducting wire for harvesting electrical energy. The dimension of detector 2001 is of several microns, surrounded by an insulator and delta layer 2003 for potential adaptation. The detector spherule 2000 also include one or more low-electronic density components 2004 that are made from electron absorber material, have a nano-wire like structure, and are surrounded by insulating layers 2005. The term “nano-wire like structure” represents the structure depicted in FIG. 9, wherein the wire thickness is in the nanometer range and may not be cylindrically shaped like conventional wire. The low electron density components 2004 may be also made of nanocrystals. The detector spherule 2000 also includes high-electronic density components 2006 that are made from electron generator material, wherein the generator components have the same structure as the absorber components. Insulators 2007 that have a high transmission and a relatively high breakdown voltage surround the generator components 2006. The inner shell 2008 is designed to assure mechanical and electrical stability. The inner shell 2008 is made from conducting material and spans over one or more fission-to-electronic-flow transformation repetitive layers and provides an iso-potential as well as mechanical support for the contents therewithin. This “CIci” structure 2004, 2005-2007, 2006, 2007 repeats itself many times (10-20 times for each micron) until it reaches the borders where the fission products absorbent layer 503 (FIG. 5) begins. For the fission products the core 2003 is the generator 501 (FIG. 5) and all the direct conversion structure following it near the outer margin is a larger insulator 502 (FIG. 5) which integrates the border layer 2000, which stops the outer fission product absorber 2010 similar to 503 (FIG. 5) to reach inside the structure.

Fission products generated somewhere 2011 in the fissile detector 2002 may have a flight path 2013 and generate an electronic avalanche 2014. Then the fission product penetrates the electrons absorber component 2004 it stops the previous electron shower that tunneled through the insulator 2005-2007 but, generates small avalanche 2016 or no-avalanche, and reaches the electron generator components 2006 to generate a strong avalanche 2014. For brevity, only one layer of A^{e} electron-absorber components and one layer of G^{e} electron generator components are shown in FIG. 20, even though other suitable number of layers can be used without deviating from the spirit of the present teachings. For a detector spherule having multiple layers of I^{e} and G^{e} components, the fission products may travel through one or more of the layers until they reach the drain fluid 2010. All over the path 2013, the polarization 2006, 2007 appears due to charge dislocation and accumulation. An electrical circuit including the electric conductors 2015 and 2016 transports the accumulated charges outside the detector spherule 2002 to harvest the electrical energy.

The detector spherule 2000 may be fabricated by ion beam assisted chemical vapor deposition on small targets. Starting from tungsten, gold, Cu micromesh, the vapor deposition of detector, such as Uranium or Plutonium, is made for a thickness of several microns. Over an electron beam, stimulating the formation of carbide layers, deposits it, a several nanometers of dielectric material, such as carbon layer. Then, a metallic layer is deposited followed by formation of insulation by reaction with oxygen, carbon, iodine and formation of dielectric material. Then, a stabilization element is added that reduces diffusion and layer degradation. A new conducting layer is deposited with a thickness of several nanometers, followed by formation of dielectric material and stabilization. A short electron beam or laser selected frequency is applied to anneal the layer, clusterize, and stabilize the structure.

A masking technique may be applied to make asymmetric depositions so that all the layers of one type are in contact with an end of the fissile bead. One type of material is in contact with an interior support conductor while the other is in contact with the exterior. An annealing process may be used to create a nano-wire like structure that will maintain the group conductivity. A several centimeter long wire with beads of detector surrounded by the nano-wire like structure may be produced. The central nano-wire conductor is made of conducting material, such as Au, Ag, or Cu, has a diameter less than 1 micron and able to carry a current of several microamps. Then, a bead structured fissionable material having a radius of several microns is deposited, followed by a hundred of repetitive “CIci” layers connected to the center and the exterior. A very thin conductive exterior layer 2022 is deposited to cover the entire structure, wherein the conductive layer increases the electric contact with the drain liquid that serves as an electrode.

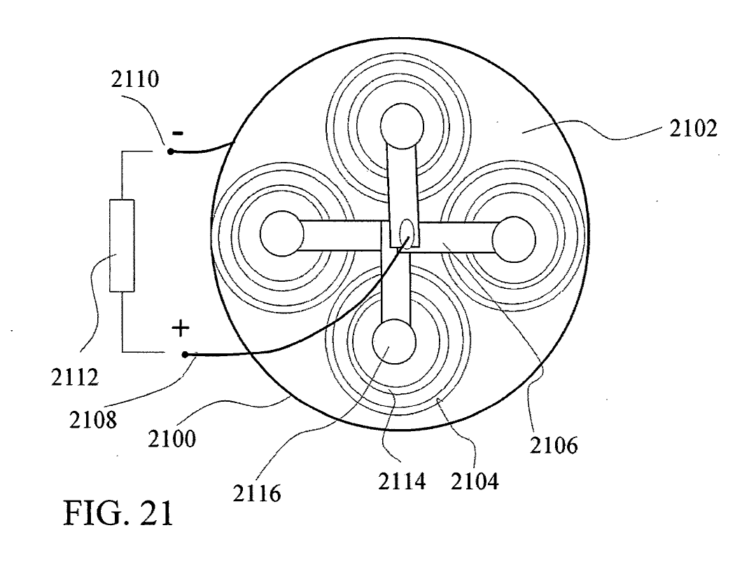

FIG. 21 shows a schematic cross sectional diagram of yet another embodiment of a device for direct conversion of fission energy into electrical energy in accordance with the present invention. As depicted, the device includes a shield 2100 that contains drain fluid 2102 and a plurality of detector spherules 2104. The shield 2100 may have a nano-layered structure and be formed from a conducting or dielectric material. Each detector spherule 2104 have the similar structure as the spherule 2000 in FIG. 20 with a hot wire core 2106 made of conducting material. In the present embodiment, the core of the spherule 2116 corresponds to the core 2001 in FIG. 20 and is filled with conducting material and connected to the hot wire 2106. The hot wire 2106 are connected to each other in parallel and coupled to an electrode 2108. The drain fluid 2102 is connected to the conducting wire, such as 2116 in FIG. 20, that is coupled to the low-electron density component in the detector spherule 2114. The drain fluid 2102 is also connected to an electrode 2110. A circuit or conversion 2112 unit for harvesting electrical energy may be connected to the two electrodes 2108, 2110, wherein the two electrodes are oppositely polarized.

For brevity, only four spherules connected in parallel are shown in FIG. 21. However, it should be apparent to a skilled artisan that other suitable number of spherules can be used without deviating from the spirit of the present teachings. Antennas extending from the bead's low conductive shunts serve as springs in creating the detector's 3D elastic structure, which allows dynamic reactivity adjustments by varying the amount of drain fluid 2102 contained in the shield 2100.

The polarization of the electrodes 2108, 2110 in this super-capacitor structure is transmitted through the wires to a conversion unit 2112. To have a power level of 1 w for each cubic millimeter, an activity around 1 Curie is required, but the capability of existing materials for carrying current is limited. In such cases, cryogenic super-conductive structures can be considered. A practical delivery parameter can be 10 A at 10 mV, which corresponds to the limit of existing materials having a cross sectional area of 1 mm². Supra-conductive technology opens the way to increase this limit by a factor of about 100. In these circumstances, activities up to 100 Ci/cmm are feasible, while operating with an efficient structure at liquid helium (LHe) temperatures. Pu based super-conductor alloys can make such structures operational at Liquid Nitrogen (LN) temperatures. For example, PuCoGa₅ has a critical temperature of 18 K and there are many other high temperature supraconductors made from materials with low neutron interaction cross-section. For these application, a recovery mechanism may be conceived when parts of the reactor are raised to higher temperatures to eliminate the fission products and cure themselves by annealing.

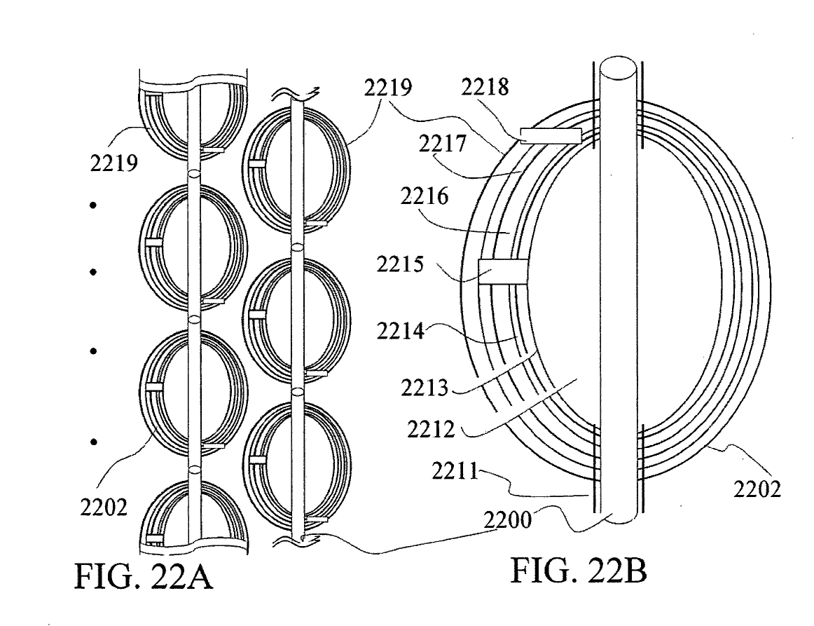

FIG. 22A is a schematic cross sectional diagram of still another embodiment of a device for direct conversion of fission energy into electrical energy in accordance with the present invention. As depicted, a plurality of spherules or voxels 2202 are connected to wires 2200. FIG. 22B is an enlarged schematic cross sectional view of a voxel 2202. The nano-wire like structure in FIG. 22A can be manufactured by metal organic chemical vapor deposition technique. The wires 2200 are formed from conductive material, such as Au, Cu, Ag, W, U, etc. Applying an ion implanted reactive gas to generate covalent insulator structures like oxides, carbides, fluorides, or combinations thereof form the insulating layer 2211. The breakdown value of the insulating layer 2211 is in the range of tens of miliVolts up to several Volts, where the thickness of the layer is in the nm range. The voxel 2202 includes a detector bead 2212, which is made of high electronic density material, such as U, Pu, Np, Am, Cf, etc., has a dimension of few microns, and is capable of generating fission reaction therein. It is preferred that the detector bead dimension is small, or the bead fissile material is integrated in the wires creating fission places all over the material, coated with a harvesting layer.

On the surface of the detector 2212, a faceted and stabilized insulating layer 2213 having a thickness of few nanometers is deposited. The insulating layer 2213 separates the detector 2212 from a low-electron density layer 2214. The low-electron density layer 2214 has a role of electronic shower channeling on the surface's facets.

In order to completely close the electronic loops, a conductive shunt 2215, generated by ion implantation, is disposed. The conductive shunt 2215 is connected to all of the absorbent layers in the voxel 2202 so that the low-electron density layers are at the same electrical potential. Another insulating layer 2216 and a faceted delta layer 2217 that is formed of a high-electron density material surround the low electron density layer 2214. The layers 2213, 2214, 2216, and 2217 form a CIci layer structure. Additional sets of CIci layers may be stacked on the outer surface of the delta layer 2217 until the total thickness of the CIci layers reaches about 90% of the fission product range. Another conductive shunt 2218, which is connected to generator layers, may be grounded. As the voxels 2202 may be immersed in drain liquid during operation, the outermost layer of the voxel 2202 may be formed of a conductive material to enhance the electrical conduction at the interface and stabilizes the voxel content in the drain liquid. Multiple detector-beaded wires 2219 are connected to create a bunch of wires with a macroscopic dimension and to produce power extraction at the level of 1 w/mm³. It is noted that harvesting the energy of a single disintegration at 80% efficiency may generate an electrical current of 3.2 nA at 10 mV. The multiple-beaded wire 2219 is a super capacitor formed of material that is neutron flux compatible. The properties and structure of the detector bead 2219 may be produced for all the shapes defined in FIG. 6-9, the harvesting layers for fission products are looking like an extended fission products insulator layer when the harvesting layers have no actinides in their composition or as a mixture of generator and insulator when the high electronic density materials contains actinides as in the case of PuCoGa₅, etc.

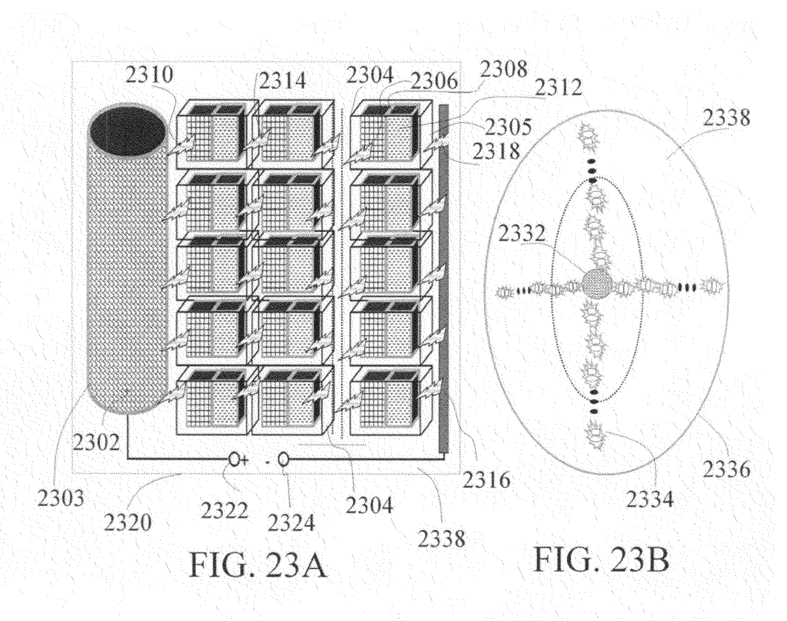

FIG. 23A is a schematic diagram of a further embodiment of a device for direct conversion of fission energy into electrical energy in accordance with the present invention. As depicted, the device includes a cylindrical detector 2302, which is made of high electronic density material, such as U, Pu, Np, Am, Cf, etc., has a dimension of few microns, is capable of generating fission reaction therein, and is covered by an insulating layer 2303. The detector 2302 may have other suitable geometrical shapes. The device also includes a matrix of cells 2304 that are bounded by a layer of low-electron density material 2316. Each cell 2304 includes a box 2305 that holds a low-electron density component 2306 and a high-electron density component 2308. The absorber and generator components are formed as a bimaterial bead in good electric contact and are surrounded by an insulating layer 2312. The insulator separates the beads that are oriented with the absorber from the fission products generator. The detector 2302 generates both the fission products and the knock-on electron showers 2310, which in turn are absorbed by low-electron density components 2306. The high-electron density components 2308 generate electron showers 2314 by interacting with fission products flying therethrough. The absorbent layers 2306 absorb electron showers to have a negative polarization, while the detector 2302 has a positive polarization. A suitable energy harvesting circuit may be connected to the two electrodes 2322, 2324. Optionally, the device may also include an outer shield or case 2320 that encloses the detector 2303, the cells 2304, and drain liquids 2338 flowing around the detector and cells.

It is noted that the device includes only one matrix of cells 2304. However, other suitable number of matrices of cells can be located around the detector, where each matrix extends in a radial direction. FIG. 23B is a schematic top plan view of another further embodiment of a device for direct conversion of fission energy into electrical energy in accordance with the present invention. The device includes an insulated cylindrical detector 2332 and a plurality of cells 2334 positioned around the detector 2332. Each cell 2334 is the same as the cell 2304 in FIG. 23A. Optionally, the detector and cells are enclosed by an outer shield or case 2336, wherein drain liquid 2338 are contained in the case.

Due to the fact that each electronic loop cannot be extended very long, the loop length extends with only few orders of magnitude. In normal ceramic detector the electron micro-loop (electron path) is less than few microns long, in a medium with the resistivity of hundreds of Mohm-m. When this loop is cut by the conductive layers with resistivity of mili-Ohm*m their length may not exceed few meters because the electrons will have same chance of following the long exterior path or traveling back through the insulator (it is called the minimum action principle invented by Fermat) So, from micron long electronic loops in dielectric, the new loops through normal conductors can be about ten millimeter long only. As such, it is beneficial to connect voxels in a pyramidal structure. To harvest electrical energy in nano-wire structured devices, many wires are connected in parallel and assembled in a bunch, wherein the wires are compacted into a structure immersed in drain fluid. The presence of the drain fluid as conductive layer is not a requirement. However, if the drain fluid is missing, an equivalent conductor has to be installed.

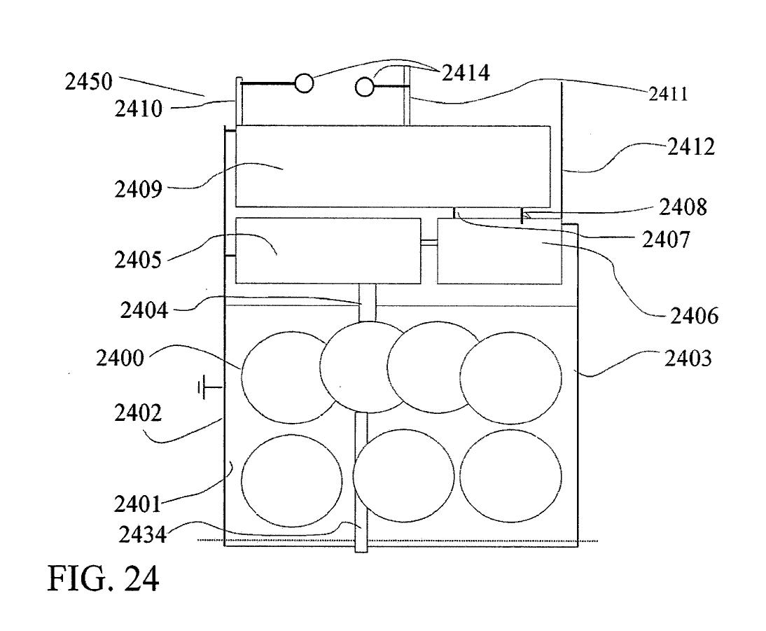

FIG. 24 is a schematic diagram of yet further embodiment 2450 of a device for direct conversion of fission energy into electrical energy in accordance with the present invention. The device or module 2450 includes multiple detector spherules or voxels 2400, each of which is similar to the voxel 2202 in FIGS. 22A-22B. The voxels 2400 are connected in parallel to an optional condenser unit 2405 via a central conductor 2404. Each voxel 2400 has an outer coating layer formed of a conducting material. Drain liquid 2401 operates as conductor, but when it is not used, additional conductor (not shown in FIG. 24) is needed to connect all of the spherules' outer conductive coating layer. The drain fluid, or alternatively conductor coupled to the outer coating of voxels, is grounded by one or more wires 2402, 2403. Each spherule may have other suitable cross sectional geometries, such as triangle, square, hexagon, to provide modularity and interchangeability.

The central conductor 2404 is connected to the optional condenser unit 2405 and to a MEMS switch device 2406 that continuously alternates the polarity of current flowing out of the condenser unit 2405 so as to create an alternating current at a pair of electrodes 2407, 2408. The MEMS switch 2406 is controlled by a synchronization signal 2412 received from a central unit, and delivers alternating current through the switch's conductors 2407, 2408 into a micro-ferrite transformer 2409. The transformer 2409 raises the voltage level by at least 100 times, from millivolts to several volts, before the current is delivered to the conductors 2410, 2411. The current at the electrodes 2414 is also used by a centralized control system to diagnose the reactivity level and, in conjunction with the measured temperature of the voxels, to control the voxel's operation quality.

The voxel elements in FIG. 24 deliver harvested energy to an upper conversion level that sums the energy and transforms into a current of a higher voltage, preferably in the range of tens- to hundred volts. The voltage increase reduces the current that the conductor sections can carry. In superconductor structures, it is possible that this volume can be further reduced if the conversion efficiency is high (about 99%) so that all the fission energy is converted into electricity. The equivalent MEMS DC/AC converter can be achieved by a modified superconductor quantum interface device (SQID) structure using a driving current to control the magnetic field through a Josephson junction. For a harvesting voxel redundant DC/AC converters may be applied in a multiple access fail tolerant structure.

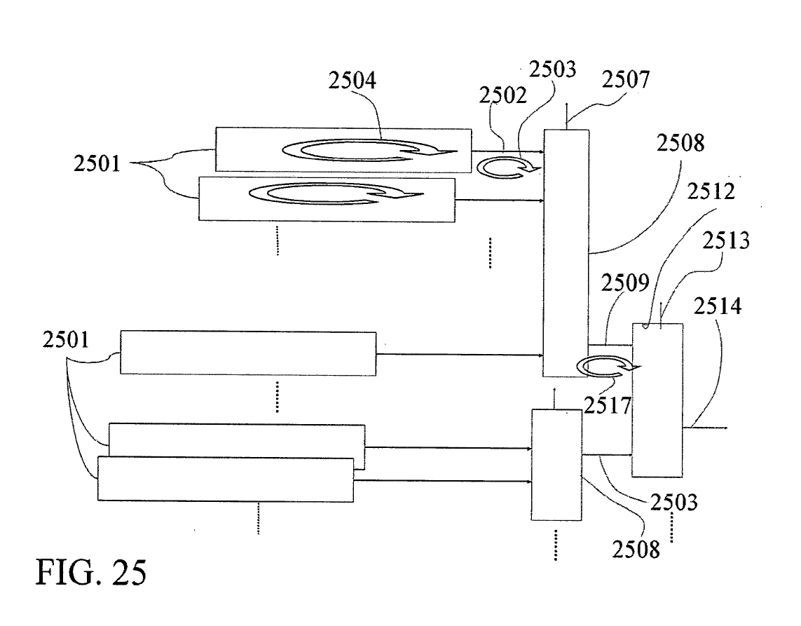

FIG. 25 is a schematic diagram of another embodiment of a device for direct conversion of fission energy into electrical energy in accordance with the present invention. As depicted, multiple units 2501 are connected in parallel to summation devices 2508, which are second level transformer summation units, via the connectors 2502. Each unit 2501 may be similar to the device 2450 in FIG. 24. Each unit 2501 is at the wire-unit level and is connected to one of the second level transformer summation units 2508. At the wire unit level, a current loop 2504 is closed while at the second transformer level the AC current loop 2503 is closed. The second and third level transformer units 2508, 2512 respectively receive transformer control signals 2507, 2513 from a central control unit and transmit this parameters of operation up to their level.

The second level transformer summation units 2508 sum outputs from the units 2501 and send the summed energy to the third level transformer unit 2512, closing a new current loop 2503. The third level transformer summation unit 2512 receives its power through conductor 2509 and may send its output current through a conductor 2514 to a unit at a higher level, where the output current may have tens to hundred of volts at few amps. It also closes the current loop 2517. A converter cascade may be used to transform 1-10 mV at the mm³ level into 100-1000V. It is noted that other suitable number of units 2501, 2508 may be used without deviating from the spirit of the present teachings.

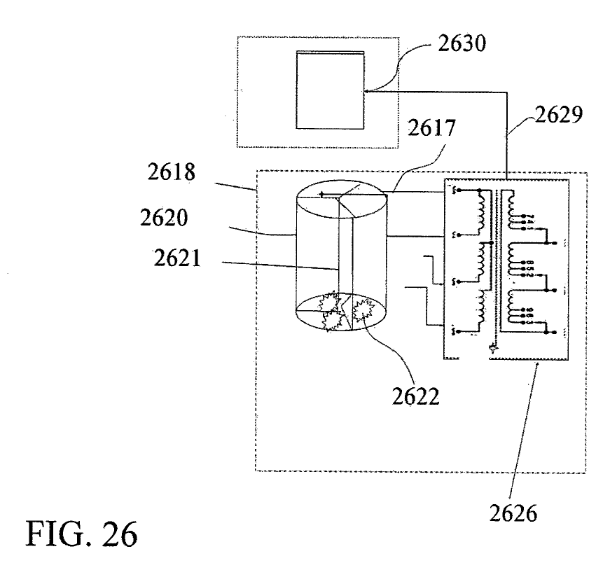

FIG. 26 is a schematic diagram of a radiation detector based on fission in direct conversion nano-structures in accordance with the present invention. As depicted, the detector fuel-like pellet 2620 includes a sector core having three sectors 2621 containing different materials. The sectors 2621, free shown in the pictures but can be more in various construction setups, take neutron flux 2622 that in accordance with the cross section is inducing fissions. Each sector is producing electric energy depending on material and radiation flux particularities applied to the tri-phased transformer adder 2626, and thereby to the spectrum analyzer. The transformer 2626 sends its output to the multi-channel or multi-group spectrometer 2630 via a voltage cable 2629. The measurement detector-like probe 2620 is similar to that of FIG. 16 with the difference as uses directly generated electric power instead of optical signal generated in scintillator.

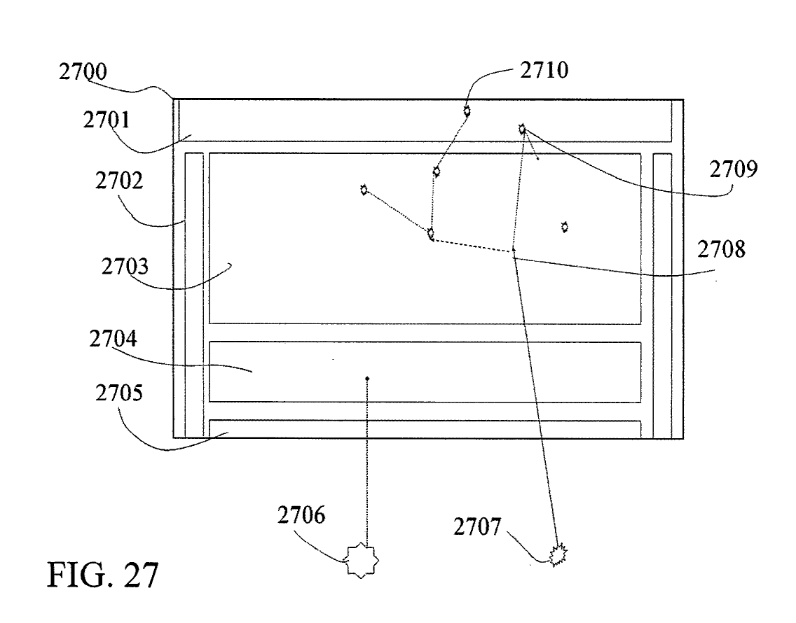

FIG. 27 is a schematic cross sectional diagram of an embodiment of a tile for harvesting moving particles as fission/fusion/cosmic rays and gamma rays energy for complex measurement purposes in accordance with the present invention. The tile 2700 has a blanket-tile structure and can be used in fission and/or cosmic ray energy harvesting. As depicted, the tile 2700 includes an active layer back shield 2701 that provides bio-protection as well as damps any radiation reaching it. To operate in cryogenic conditions, the tile 2700 may have strong lateral conductor-and-cooling separators 2702. Inside the separators, a neutron-harvesting converter 2703 is positioned in close proximity to the shield 2701. The converter 2703 has a lattice structure and is formed of various chemical compounds that have enhanced collision cross sections for neutrons. Optionally, the converter 2703 may contain actinides and selectively amplify through fission the neutrons energy. The converter 2703 may have a nano-hetero structure (i.e., the CIci structure). The next nano-hetero structured layer is a charged-particles-and-gamma-rays-electricity converter 2704. Another nano-hetero structured layer 2705, which is a low-energy-charged-particles-and-photons converter, serves as an outer skin of the tile 2700.

A fusion reaction may generate an alpha particle or a triton, called fusion product (He ion) 2706, with energy less than 6 MeV and/or neutrons 2707 with energies less than 15 MeV. The penetration range of the ion is short; typically, the ions stop in the first and second converters 2705, 2704, while the neutrons may travel into the third converter 2703. Due to the large collision cross section of the actinide content in the layer 2703, the neutrons induce fissions and recoils making visible their presence. The neutrons resulted from a fission reaction 2708 may reach the shield 2701 and thence are reflected at a location 2709, or absorbed by the shield as a location 2710 due to the blanket's high neutron scattering cross-section.

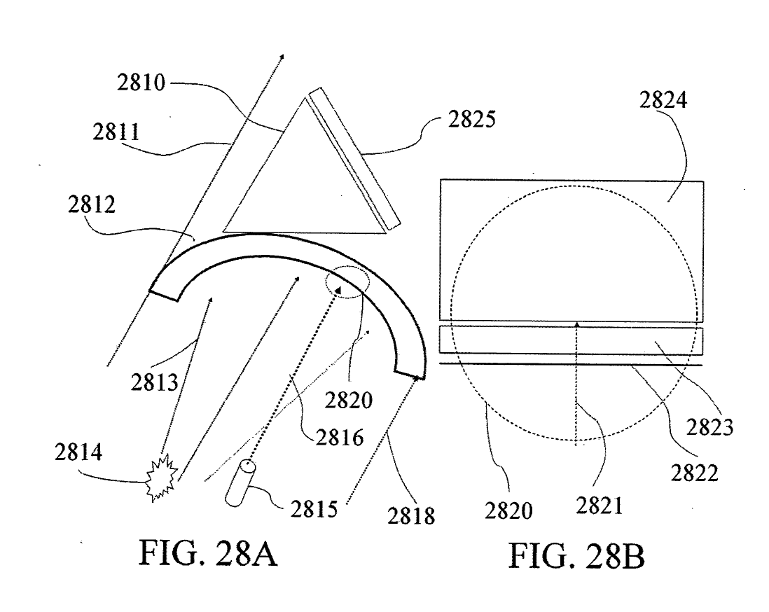

The structure of planar tiles for energy harvesting in space may differ from the hetero-structure used in fission and fusion reactors having another MEMS connector because the voxels, if included in the planar tiles for space application, may be damaged by high-speed dust particles. A space vehicle payload carries protective shields that operate at cryogenic temperature environments and, at the same time, are exposed to high temperatures due to the energy transformation via amorphization in their thermal shield tiles. FIG. 28A shows a schematic diagram of another embodiment of a tile for harvesting fission/cosmic ray energy in accordance with the present invention.

FIG. 28B shows an enlarged view of a portion 2820 in FIG. 28A. As depicted in FIGS. 28A-28B, a space vehicle carries payloads 2810 and includes shields 2812, 2825 for protecting the payloads. When a cosmic particle 2811 hits the shield 2812, it may stop there, giving its energy to the shield that transforms the particle energy into electricity. There is a variety of particles, which are represented by arrows 2813, 2818, 2821, in space that may harm the shuttle and equipment on board. These may have natural origins like cosmic dust, radiations, and particles emitted by sun and stars 2814. Also, an accelerator 2815 outer space located, may emit particles or beams 2816, such as electrons, ions, atoms, or radiations, to power the vehicle or indispose other space vehicles, and its spectral components and direction have to be also analyzed in real time. When the particles interact with the shields 2812, 2825, their energy will be harvested into electricity, and its impulse will be used or compensated.

As depicted, the sensitive shield 2812 has three layers 2822, 2823, 2824 that may have the same structures and functions as the layers 2705, 2704, 2703 in FIG. 27, respectively. The principle of operation is highlighted in the enlarged area 2820. The energy of the beam 2816 is converted by the outer layer 2822 that stops a portion of the beams in a low energy range, or by middle layer 2823 that stops another portion in a medium energies (in MeV range), such as medium range X-ray and soft gamma radiation. If the beam or particle has energy sufficient enough to pass the second layer 2823, it may be stopped in the third layer 2824. The shields 2812, 2825 are made from reconfiguring tiles module and have a complex shape depending on the needs. They may simultaneously measure and harvest the energy.

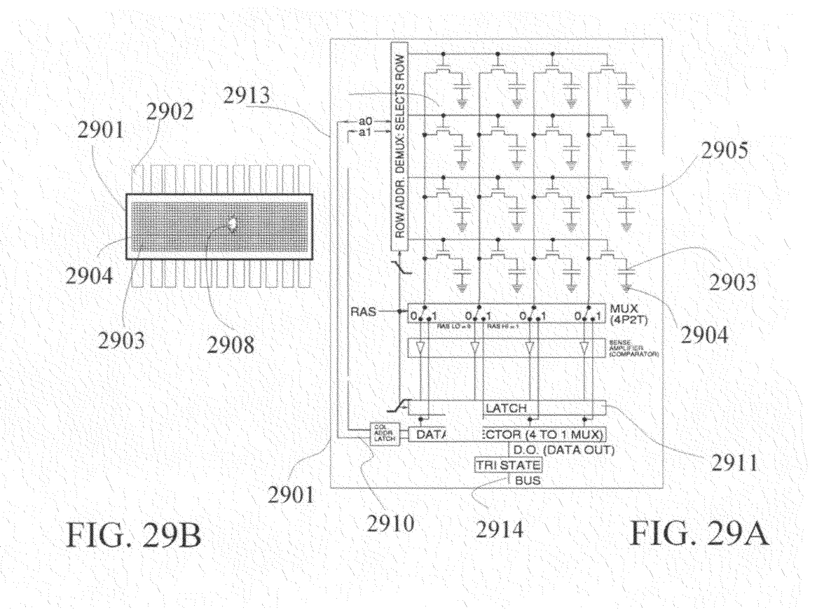

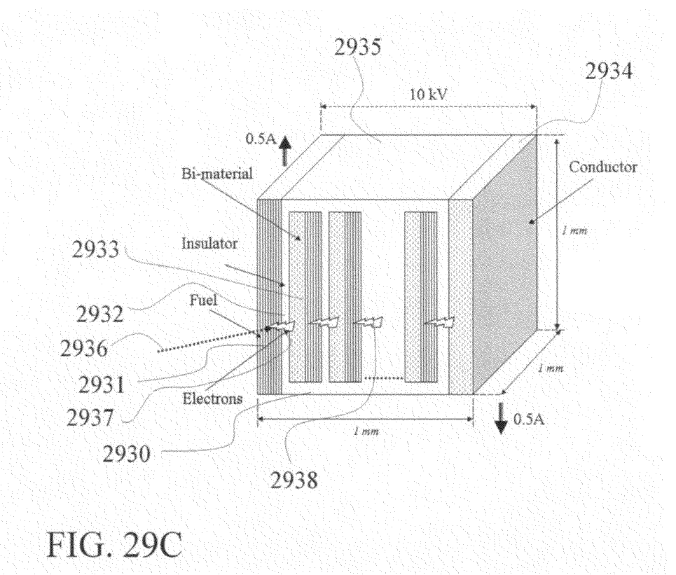

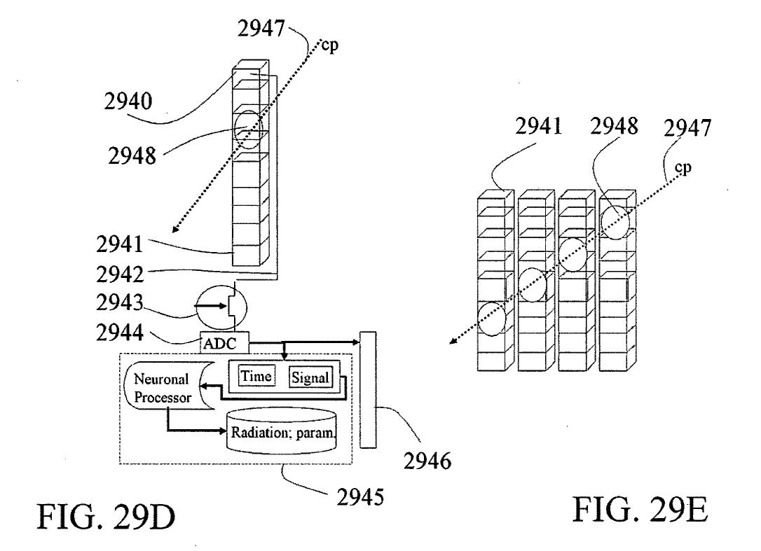

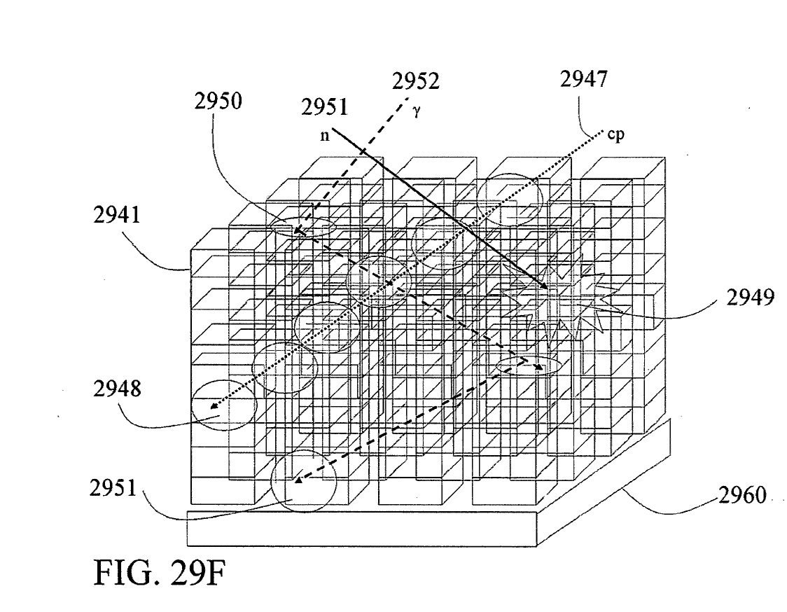

FIG. 29A shows a schematic diagram of an embodiment of a device 2901 for energy harvesting and radiation field measurement in accordance with the present invention. The device 2901 directly converts fission energy; charged particle kinetic energy or neutron and gamma flux into electrical energy readable by a ADC and transmitted to a memory via a BUS. As depicted, the device 2901, follows the principle of operation of DRAM read, for simple 4 by 4 array having the capacitors made of the direct energy conversion structures surrounded by a shield 2900 that may be an active shield for heat shielding or a passive shield similar to the tile 2700 described in conjunction with FIG. 27. The device 2901 includes a plurality of electric connectors 2902 coupled to address bus 2911 or data bus 2910 and accessing directly a memory bus 2914.

The direct conversion devices are small, cubes of “CIci” structures 2903 stacked together and connected to the ground 2904 and to the FET gate 2905.

When a radiation collides on one sensitive element 2908 in FIG. 29B it generates an electric charge accumulated on several sensitive elements 2903 stacked together. It triggers an event time signal and the energy is calculated by integrating the affected structure inside an event time domain. The position is given by the stacked element position while the incidence angle is calculated using the ionization power deposition curve over the stacked elements.

FIG. 29C shows a schematic diagram of a elementary conversion cell 2930 made with a fissile material layer 2931 followed by a sandwich “CIci” nano-structure made of insulator 2932, a bi material voltage floating element “Cc” 2933, and repeated several times up to the end where is terminated by a low electron density plate “c” 2934. The whole assembly is encapsulated 2935 and further connected to a charge amplifier, for detection purposes. When a neutron 2936 strikes the fissile material 2931 a fission occurs and the fission product 2937 propagates along the structure generating showers of electrons 2938.

The electron showers cross the structure reaching the end plate “c” 2934 and their charge is accumulated and propagated along the plate. Each fission contributes to about 15 pJ (pico-Joules) accumulated in the plates. To collect all the ≈30 pJ released fission energy a spherical 4π structure might be needed. The deposited energy is released as the product between charge and voltage; i.e for 1 Volt a 15 pC (pico-Coulombs) are released. The duration of the charge accumulation is of about 50 ps while the discharge time depends on the electric parameters of the circuit, capacitance, Inductance and resistance, forming the Impedance of the electric circuit.

The figure also shows the capability of such a structure to harvest and deliver up to 1 MW/cm³, but at higher rates over 10⁶ fission per second the event mode acquisition of the data may be lost in the favor of the integral mode making the output power proportional with the radiation flux.

FIG. 29D shows another embodiment of the present invention, called detector for radiation identification with energy and direction measurement. It relies on several detection structures 2940 about the same with that from FIG. 29C, but smaller—in the range of 1/10 of the radiation path in that structure. The structures are stacked together forming a column 2941. A cable 2942 to a gate circuit that allows the mode sample hold and release 2943 figured as a FET device, connects each detection structure 2940 underneath. The accumulated charge is applied to an ADC (Analog to Digital Converter) 2944 that may apply the signal to an intelligent event processor 2945 made of a time and signal direct memory access data storage, a neural network calculator that scans all the same time window events and makes radiation, energy and direction identification and stores accordingly for further transmission to a higher rank data processing system. The ADC 2944 may also sent the data to a cumulative memory storage 2946 operating at higher rates or may be simplified and/or bypassed by an analogical device showing the power level of radiation only.

When a radiation 2947, in the present example taken as a charged particle hits the structure 2940 under an angle it crosses several elements living there a part of its energy 2948 accumulated as charge in several cell elements. From this information the solid angle domain may be identified, and the hit. The particle identification and it's energy may not be determined if the hit is not inside the normal incidence solid angle to the column 2941.

FIG. 29E shows another embodiment of the present invention, as the development on one dimension of the detection column 2941 from FIG. 29D. The columns 2941 line is now able to accurately detect direction of radiation coming in the solid angle of the detector plane in the above non-shadowed by electronics detection direction. When the radiation 2947 hits and crosses the structure from this direction it leaves a charge 2948 in several cells of the 2941 detection columns. From the position of the charged voxels the direction cone may be more accurately identified and the energy and particle type if it completely stops in the structure.

FIG. 29E shows a further development of the previous structure using the detection columns 2941 on two directions in FIG. 29E creating a tri-dimensional matrix of sensitive elements also called detection voxels. When a charged particle 2947 crosses the detection volume it leaves on its track the crossed voxels electrically charged 2948. Analyzing the charge distribution along the track in correlation with the incidence angle, it may be possible to identify the particle type, its initial ionization state direction and energy, up to a rate accessible to the processing electronics 2960 underneath.

FIG. 29F also shows a schematic diagram of a neutron 2951 crossing the structure and triggering fission 2949 in one fissile voxel. In part may be possible to say something about n direction and energy by tracking the fission products.

FIG. 29E also shows a schematic diagram of a gamma ray interacting with the structure by a Compton scattering 2950, and finally after successive scatterings by a photo-peak 2951 having all the energy absorbed by the structure. By the energy in the time window the radiation direction and energy might be reconstructed in some cases . . . . The electronics time resolution and overlap probability plays an important role in reconstruction capability.

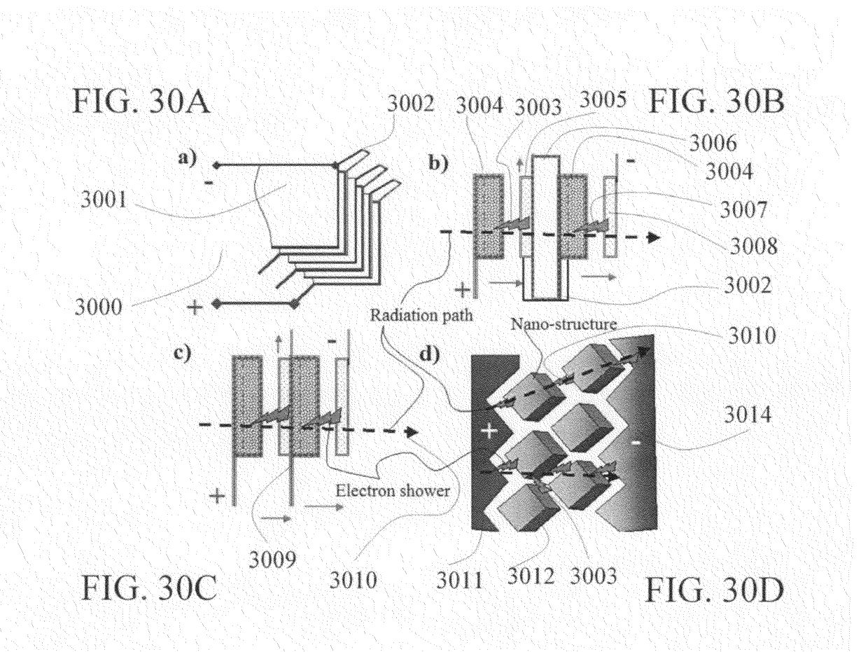

FIG. 30A shows a clarification schematic diagram of the detection devices based on direct conversion nano-hetero structure. The nano-layered direct conversion device 3000 made of a succession of “CIci” layers 3001 may be connected in series by strapping 3002 the minus grid of a cell to the plus grid of the next cell.

FIG. 30B shows the consequence of this connection where the electron shower 3003 generated by the “high electron density” layer “C” 3004 stopped by the “low electron density” conductive layer “c” 3005 after tunneling the “I” insulator, it is going around the insulator “i” 3006 by the conductive strap 3002 reaching the next conductive layer “C” 3004, and compensates for the charge lost in the next electron avalanche 3007 making that the connected group to have a steady null voltage in spite it becomes insulated from the rest and its voltage practically floating. From the technologic point of view a breakdown voltage-regulating circuit will be added for the layers protection. Finally the electron shower reaches the end grid 3008 and the charge is preserved while the voltage is added as in serial connection.

FIG. 30C clearly shows that this connection eliminates the insulator “i” 3005 and drives to a bi-metal electrode layer creation 3009 by consolidating intermediary layers “C” 3004 with “c” 3006. The radiation path have to be longer than the cell length and the intermediary cell have to be customized to deliver equal consecutive showers.

FIG. 30D is a schematic diagram of an embodiment of a device for harvesting the radiation energy, called nano-bead hetero-structure. This is a natural development obtained by slicing in nano-squares the structure from FIG. 30C. The bi-metal cubic nano-beads obtained in the process may be replaced successfully by a suspension of nano-clusters that suppresses some of the phonon modes.

The new structure is now made of a “high electron density” grid working as primary generator 3011, an insulator embedded with nano-beads 3012 and a final electron shower 3003 absorber grid 3014. The special material inside operates as a radiation triggered switch.

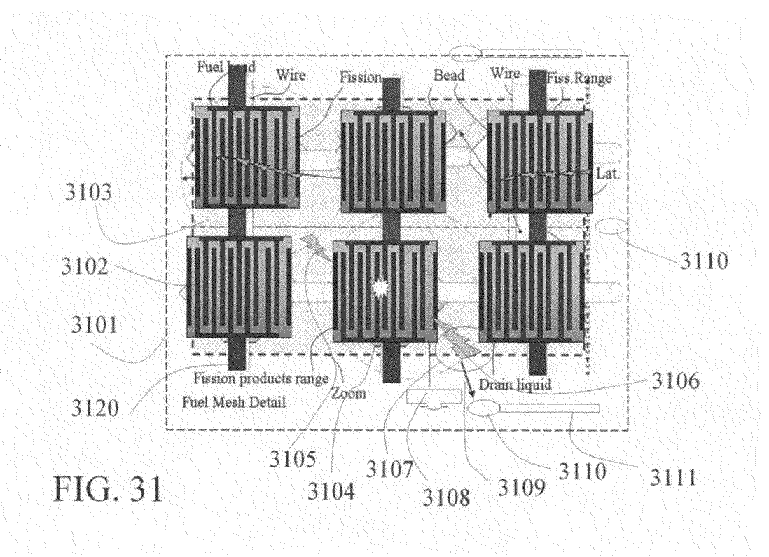

FIG. 31 is a schematic diagram of an embodiment of a device combining the micro-hetero structural detectors with the nano-hetero structured direct harvesting structures generating a micro-nano-hetero structure for radiation detection 3101.

The micro-beads 3102 are made of a direct conversion nano-hetero-structure conducting the charge out using the wires 3120. The beads 3102 are immersed in the transparent scintillator liquid 3103.

The “high electron density” material “C” is made of actinides and neutrons crossing the structure may trigger fission 3104. The fission products 3105 and 3106 are crossing the micro-bead's nano-hetero-structure leaving a part of energy there and get out in the scintillator liquid depositing the thermal spike that is accompanied by acoustic shock waves 3107 and the optical signature 3109.

The pressure shock-wave is measured by the transducer 3108 while the optical signal is collected by the device 3110 and transported in an fiber-optic 3111 to the measurement array. All the assembly is surrounded by the signal collection measurements able to track and localize multiple radiations.

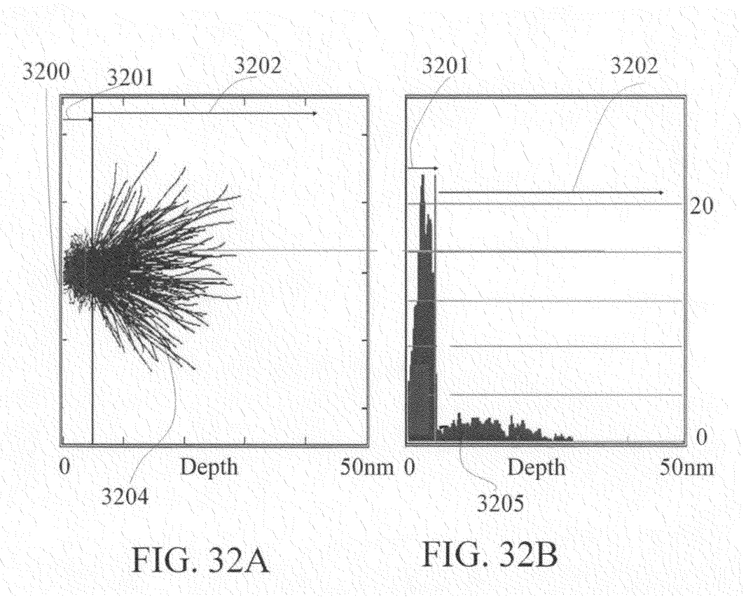

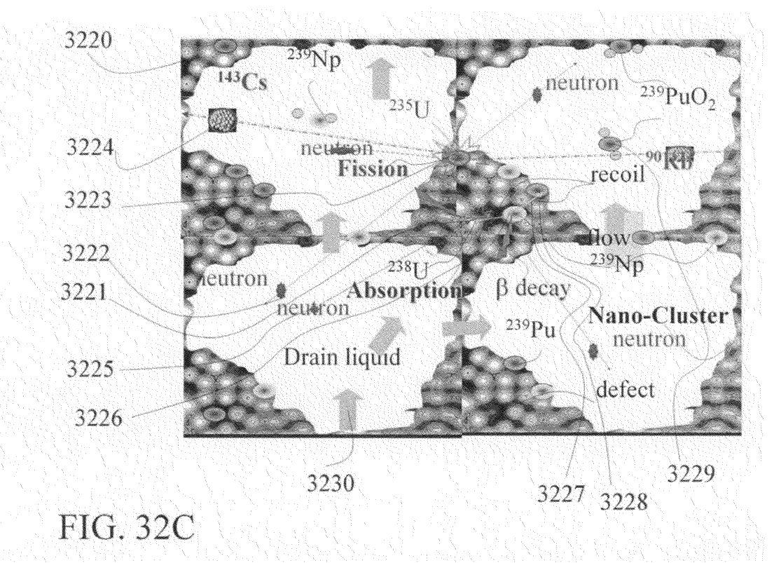

FIG. 32A shows numerically simulated paths 3204 of recoils injected into a bi-layer target. ²³⁹U recoils with 10 KeV energy each are injected into the target having uranium metal or grain 3201 washed by water 3202. The uranium metal 3201 and water 3202 are assumed to have thickness of 5 nm and 45 nm, respectively. A Monte-Carlo technique has been used to simulate the recoils. The reactions to generate the 239-Uranium compound nucleus are assumed to take place at the initial point 3200 that is in proximity to and outside the surface of the uranium metal. FIG. 32B shows a distribution of 239U recoil stopping density 3205 in the target of FIG. 32A. It is seen that 50% of the compound nuclei do not penetrate the grain and remain as Frenkel defects inside the grain 3201. The extraction efficiency in this case is about 50%-70%, due to uniform distribution of the collision centers all over the grain volume. If the grains are bigger than 5 nm, only a fraction may escape the grain and the extraction efficiency may lower.

FIG. 32C shows an artistic view of an embodiment of a device using the recoil based, nano-cluster enhanced direct separation of the transmutation products as a measurement tool. It shows a nano-cluster array zoomed-in with the dimensions less than 25 nm, where a central nano-cluster is seen 3221.

An incident neutron 3222 triggers fission in the nano-cluster material 3223. The fission products 3224 fly apart several thousands of lattice constants stopping far away from the nano-cluster that had supported the fission. The instant energy release there will drive to nanocluster reorganization with fragmentation and recovery.

The nano-cluster material is a fertile one, and another neutron 3225 is triggering an absorption 3226, followed by a short recoil 3227 inside the nano-cluster 3221 latice generating a Frenkel pair. The interstitial defect is diffusing under nano-cluster kinematics mechanisms (shape, dimension and defect location accelerated diffusion, hopping, ruby-cube permutations) influence towards the boundary 3228, where is the nano-cluster-fluid interface. The interface makes the transmutation product being absorbed into fluid by a chemical reaction 3229 being smoothly transported by the drain fluid flow 3230 through the open pores of the nano-cluster sinter outside the radiation area. This description is fundamental in understanding the nano-cluster special mechanisms.

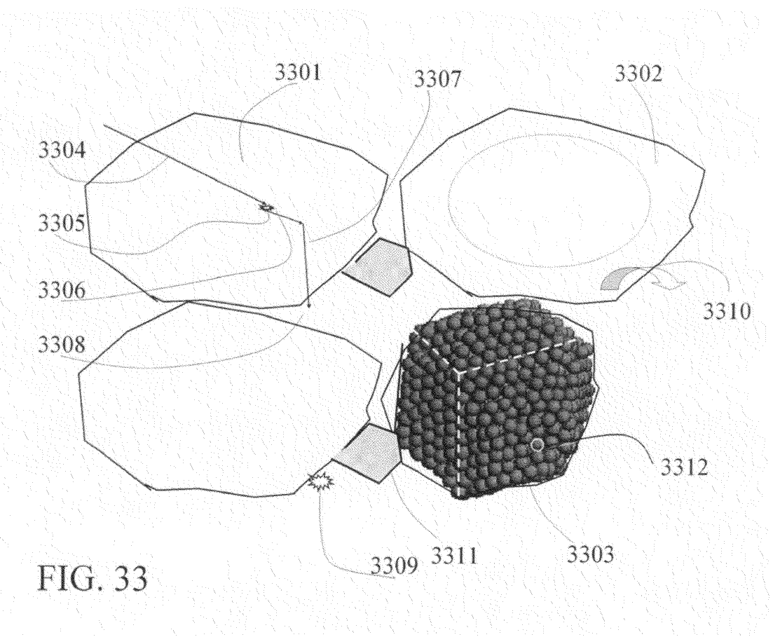

FIG. 33 shows grains 3301 of nuclear detector immersed in drain liquid 3302. As depicted, the drain liquid 3302, such as water, flows around the nano-sized grains 3301, such as depleted uranium grains in the nanometer range, and thereby washes the grains and carries out the recoiled nuclei 3306. A neutron flying in a direction 3304 interacts with target nuclei 3305, generating an unstable nucleus or recoil that is dislocated from his position in the lattice as indicated by an arrow 3305 and creates an interstitial Frenkel type defect. The interstitial position of the recoil diffuses outside the grain boundary as indicated by an arrow 3307 to meet the drain fluid 3302 and to react with chemicals 3308 floating in the fluid 3308 and thence to be carried outside the nuclear reactor. Depending on the dimensions of the grain, not all of the recoils may reach the grain boundaries but a fraction of them remain in the interface 3310 between the grain and fluid affecting the extraction efficiency. The insulator has the role to prevent the precipitation of the capture and fission products 3309 on the grain's boundary 3303.

The nano-cluster 3312 may be a magic number having special properties and putting all impurities on its boundary. The nano-cluster sinter may be bound by other ligand materials 3311 making a tiny bridges among main nano-clusters but living the pores in connection with nano-channels where a tiny nano-flow of drain liquid makes the drainage of the transmutation products.

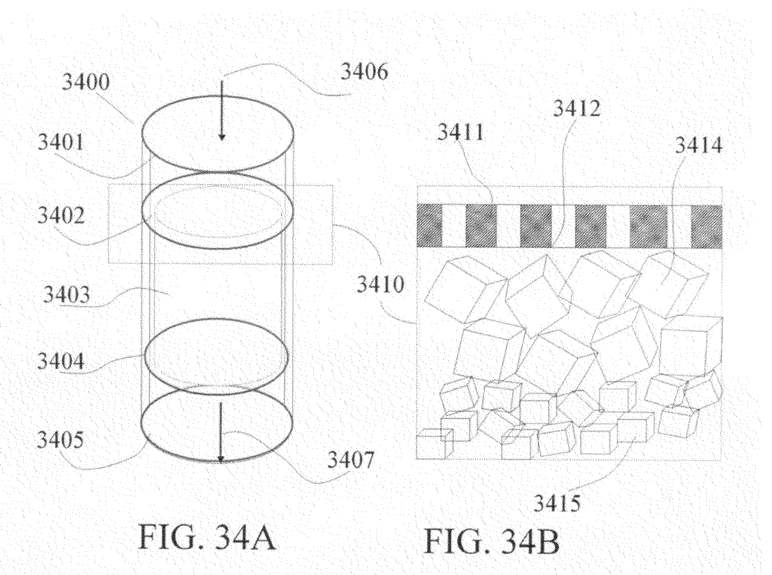

FIG. 34A shows an embodiment of a nuclear pellet 3400 that is compatible with the reaction channel of a nuclear reactor in accordance with the present invention. FIG. 34B is a schematic enlarged view of a portion 3410 of the pellet in FIG. 34A. The pellet 3400 includes detector grains 3403 having a nano-hetero structure and a cladding 3401 for surrounding the detector grains. Liquid flow 3406 is introduced inside the cladding so that the liquid washes the grains. The pellet 3400 also includes a metal grid 3402 that stabilize the detector and are preferably made of aluminum or stainless steel foil 3411 with pores 3412 having a diameter of 100 nm or less.

The grains 3403, made from depleted uranium, Thorium, etc., are contained in the space between the metal grid 3402 and a lower support 3404. The pellet 3400 ends with a connection termination that can be coupled to an input 3401 of another identical pellet. At the bottom of the pellet 3405, the drain liquid exits the pellet as indicated by an arrow 3407 to a purification unit.

The mechanical stability, the grains is obtained by using bigger PM (particle magnitude) grains 3414 near the metallic foil 3411 and smaller grains 3415 in the center as shown in FIG. 34B. The grains are material clusters or can have various shapes and sizes. The drain liquid needs have a good fluidity and does not chemically react with the base isotope but stabilize the recoiled isotope.

The detector breeding tube gets slightly warm from the incident neutron and the subsequent beta and gamma disintegrations whose energy is few thousand times lower than that in the fission requiring slight cooling system. Its role is to produce controlled nuclear transmutation of the 238-Uranium and 232-Thorium that do not burn in the reactor but are highly abundant in the ore into the highly fissile 239-Plutonium and 233-Uranium extending the planet's nuclear detector resources by more than 150 times. The advantage of this structure over the actual breeding technology consists in the fact that after the first capture reaction the compound nucleus is removed from the reactor hot zone into separator area and the unwanted reactions of neutron capture driving to 240-Plutonium, 234-Uranium are avoided, giving an extra pure isotope, easy to separate.

While the invention has been described in detail with reference to specific embodiments thereof, it will be apparent to those skilled in the art that various changes and modifications can be made, and equivalents employed, without departing from the scope of the appended claims.

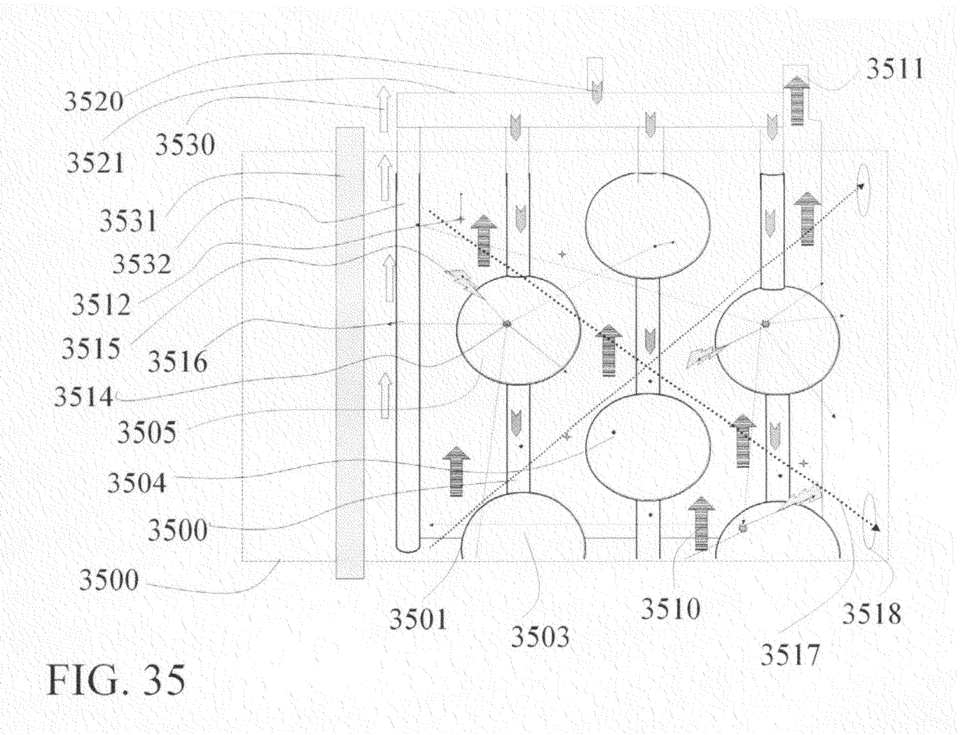

FIG. 35 shows an embodiment of the present invention, representing a combination between the micro-hetero-structure and the nano-clustered structure generating a robust measurement instrument with multiple application. The zoom-in assembly 3500 has about 50 microns size. The structure is made of micro-beads with size of about 10-40 microns large 3501, supported and connected by a bunch of nano-tubes or a micro-tube 3502 sealing the inside 3503 of the bead from its outside 3510.

The inside of the beads and micro-tubes 3503 are fulfilled with a nano-structure containing products that can produce transmutation in certain radiation exposure conditions similar to the structure presented in FIGS. 32-34, and sunken in a specific washing solution, as water, methanol, other organic solvents and extractors.

There are 3 fluidic circuits functioning simultaneously and independently. An outside detection pellet cooling system 3530 adapts an adiabatic insulation 3531 to the inside detector operation temperatures applied on the cladding 3532. A second fluidic circuit 3510, 3511 having the role to drain out the fission products 3512 and to scintillate at their thermal spike 3515. The inner content of the nano-beaded structure 3503 generates fissions 3514 triggered by the neutron absorption 3516. The scintillations travels the fluid 3517 and reach the optical collector 3518 that drives them to the optical analyzer outside the reaction zone. The same structure may generate transmutation products 3505 that are carried outside in the measuring unit by the drain nano-flow 3520.

This measuring cell combines the effect of fission detection by scintillation, fission being a process to increase the sensitivity to radiation fields like neutrons and hard gamma by several orders of magnitude, with transmutation induced long term integration chemical measurement able to deliver very fine spectral details. The method is used in real time covering micro-second response time of scintillator, with hour response time of the transmutation analyzer.

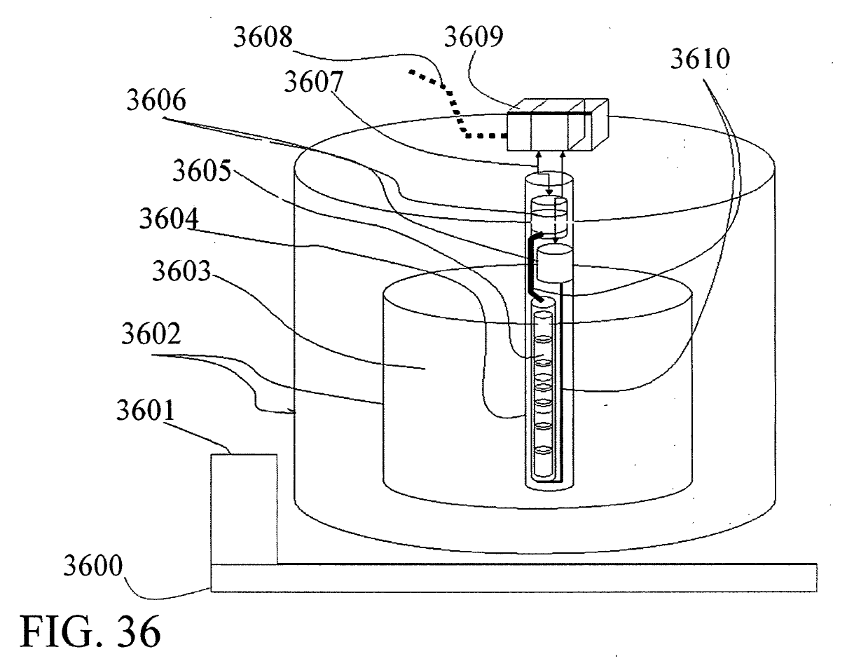

The FIG. 36 shows an example of application of the radiation field measuring device for neutrons field characterization and as safeguard in non-proliferation applications in a nuclear environment 3600 that may be a nuclear reactor channel or a detector pool. The measuring environment may have a shielding 3601, a containment vessel 3602 than may be the pool or the nuclear reactor vessel, and some nuclear detector inside 3603.

The measurement device may look like an insertion rod 3604 containing a mixed assembly of materials and pellet like detection devices 3605, stacked together. The nano-breeding structure recirculates the fluid in the breeding fluid tanks 3606 while the scintillator is driving the optical signal to the analyzer, a part in the process control unit above 3609, while the scintillator is recovered in a specialized system 3607. An assembly of pipes and pumps 3610 makes the fluidic systems operate optimally.

The Process control system 3608 placed outside the measurement area controls the entire process and acquires and process the data.

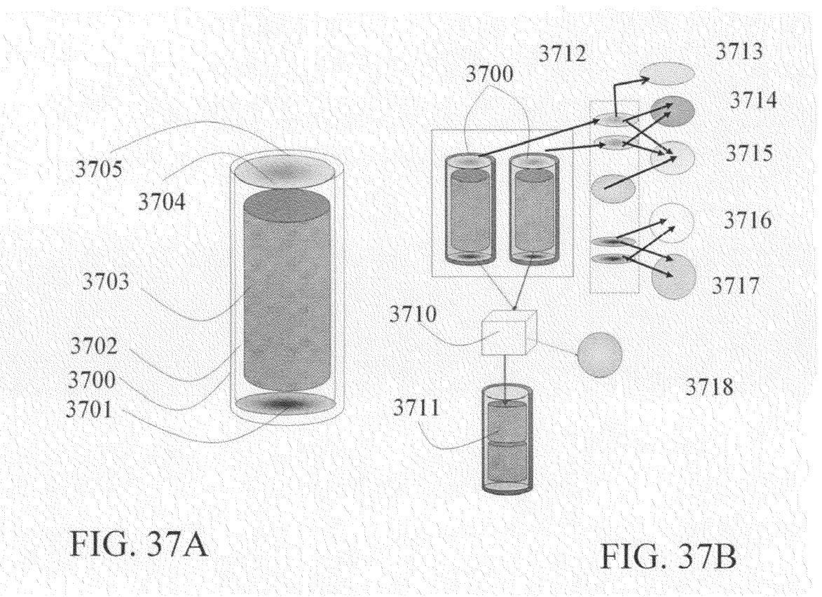

FIG. 37A presents the case of a measurement device, another embodiment of the present invention made as a sealed micro-hetero detector similar to that used for PWR (Pressurized Water Reactor) 3700, made of an outer cladding, sealed cylinder 3701 containing liquid 3702 inside for drain orf the fission products purposes. The micro “cer-liq-mesh” structure 3703 is placed soaked in the drain fluid, that may be a liqiod after the purpose—a liquid metal like LBE or NaK for reactor fluid or heavy water for measurement purposes. It contains an upper space 3704 for dilatation and light fission products agglomeration and a upper lid 3705. This pellet is inserted in the reactor, having same reactivity as detector and operates tracking the process. After some burnup it is taken out with used detector and reprocessed in an advanced mode to give an accurate information about the content of actinides and other isotopes in spent detector.

FIG. 37B presents the fast reprocess in of the reactor burnap tracking capsule 3700. It is a cryogenic based process, based on cooling several capsules together down to liquid helium, a little bit under 4K. At this temperature the lid is opened and by punching a hole and the lid is connected to a gas collector—and smoothly wormed up. The first collected will be hydrogen, deuterium and tritium followed by helium gas collected in gas recipients 3713. The process is called cryogenic distillation and the worm-up is continued up to 400K all gas fractions collected in specialized recipients 3713. The capsules are returned at normal temperature or a temperature where the drain fluid inside is still solid and the cladding is removed and deposited.

The solid drain liquid and pellet is smoothly warmed up until the drain liquid is extracted 3715 leaving the light fractions and the bottom fractions 3717. The cleaned liquid is saved in the tank 3716 for reprocessing and analyze. The microstructure free of fission products and drain liquid is reinstalled in the device 3710 in a new pellet 3711 with low radioactivity and sent for actinide content measurement. All the residual components resulted in the reactive wash out of the micro-bead coating is stored in 3718 container and analyzed. The same type of structure may be used as detector with fast reprocessing to assure a deep burnup factor, to minimize the actinides content and proliferation risk. In this way a clear fast assessment of the reactor waste detector content is made and further instrumental calibration of the safeguards is enhanced, for detector monitoring purposes.

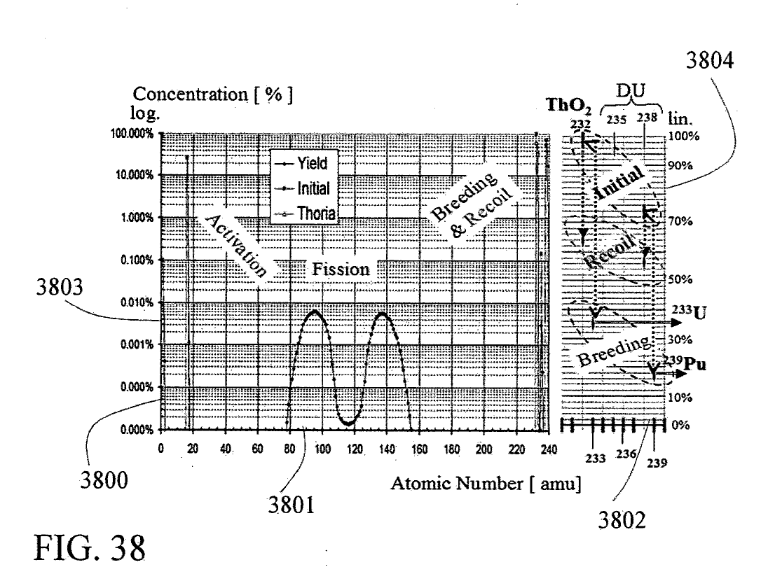

FIG. 38 presents the case of a the transmutation products measurement in drain liquid effluent a DU (Depleted Uranium) or Thorium nano-beaded-hetero structure as a mixed result of numeric simulations and preliminary experiments.

The chart 3800 shows the mass distribution of the fission products contamination in effluent liquid due to the fission reaction cross sections of ²³²Th and ²³⁸U at high energy neutrons and the ²³³Pa, ²³³U, ²³⁵U, ²³⁹Np, and ²³⁹Pu large fission cross sections. It is observed that the fission products contamination of the extraction liquid is several orders of magnitude smaller than that of the solid detector and so is its radioactivity that makes the extraction work possible.
The concentration in relative logarithmic scale 3803 shows also the presence of the structural transmutation products from oxide and solution, generically called activation. The high mass in the domain of 230 to 240 is not visible on the chart 3801, and a zoom in have been made nearby.

The right side chart zoom-in 3802 show the actinide mass of interest region expanded and the concentration 3804 is given in linear scale, comparing the presence of the isotope in the solid state nano-clustered detector and its relative concentration in the extraction solution that shows a contamination with elastic recoils of the main host material but a high concentration of the transmuted product—called breeding—easy to extract by light chemistry even placed on online micro-chemistry extraction devices similar to those used on PET (Positron emission Tomography) Cyclotrons.

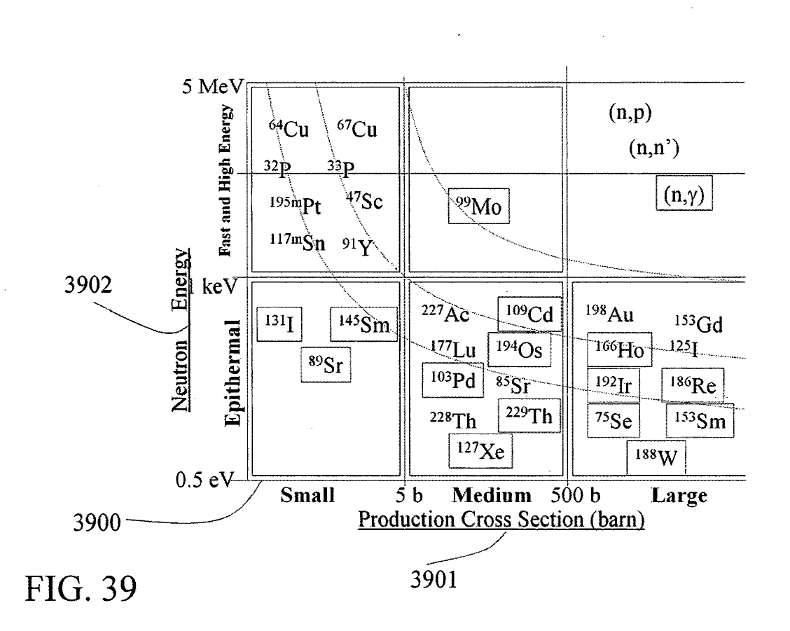

FIG. 39 presents another important chart 3900 used in nano-clustered direct transmutation measurement cells, for non-proliferation purposes. It presents the production cross-section size 3901 versus the type of the neutron flux 3902. It is seen that there is no easy candidate that to have large production cross section in fast neutron domain. The isotopes in frames are those that remain in the nano-cluster structure, being difficult to be extracted by fluids. The measurement method may contain an extractable isotope for current measurements and a mon extractable isotope for integral measurements over the entire irradiation period using separation methods as those described in FIG. 37.

What is claimed is:

1. A method to make the design and calculate the optimal dimensions of a radiation field measurement detector cell structure used in a nuclear application involving fission, fusion or decay, based on a plurality moving entity specific (fission products, charged particles, electrons, recoils, neutral atoms or molecules) elemental modules made of three components and interfaces with generic functionality operating over one (as single elemental module type) or more moving entities or sub-processes (as composite or overlapped elemental modules) in nuclear structure wherein each component has a generic functionality that is:
Generator component defined as that volume of space and/or material that generates the moving entity of interest by a nuclear process (fission or fusion generating moving elements, ionization during stopping generating knock-on electrons, absorption or collision generating recoils). The elements leave the generator space without being auto-absorbed. This component has maximal generation and transmission and minimal absorption and reflection for the selected moving element.
Insulator component defined as that volume of space and/or material adjacent to generator that separates the generator entity from the rest of the entities with respect to the sub-process element. This element has maximal transmission and minimal absorption, reflection and generation.
Absorber entity defined as that volume of the space adjacent to insulator that absorbs the selected moving element without generating it. This element has maximal absorption and minimal reflection, generation and transmission. This is applied to separate repeated elemental modules.
The interfaces between the components and elemental modules that are processed by faceting and coating in order to improve the properties.
The dimensions of the components in each elemental module are calculated such as to maximize the predominant characteristic of the sub-cell element by using an effective length of the component with respect to the selected moving entity defined that such length for which a reasonable amount of selected moving entities have been generated and/or absorbed.

2. A method according the claim 1 applied repeatedly to all the process' moving entities acting simultaneously over the same space and elemental modules that take part in the process.

3. A method according the claim 1 allowing that the elemental module's volume to be shaped and dimensioned by applying the effective length on 1 or 2 or 3 directions or dimensions of the space, generating structures, generically called linear, like wires, bi-dimensional structures called layers or surfaces like foils and fabrics and three-dimensional structures, with variable local dimensions called beads or clusters forming layers, meshes or felts.

4. A cell according to claim 3 where the method is applied for a plurality of sub-process entities simultaneously in overlapped space-entities, generating composite micro-nano-hetero-structures.

5. A nuclear detector assembly for a nuclear reactor or radiation field, resulted according to claim 1 comprising:
a variable diameter tube having an inlet and an outlet defining an operative portion and separating the outer cooling agent from the inner detector structure;
a drain tube disposed within tube and extending from inlet through operative portion to outlet, said drain tube having openings at its ends and along its length said pores or small holes for circulating drain scintillator fluid; and
a detector structure, having a fine sub-structure that can be made of a plurality of continuous layer, mesh or felt disposed within operative portion of the tube, being operative to generate fission products by fission reactions to enhance the radiation detection;
whereby drain fluid caused to enter in the operative portion through inlet end passes over the surfaces of said detector structure, scintillates at fission spike, captures the fission products and passes through openings or pores inside the drain tube and thence along the drain tube for discharge there from.

6. A nuclear detector assembly as recited in claim 5, wherein detector structure includes a plurality of separated disk like detector elements having a fine structure that can be layer, mesh or felt-like stacked along the axial direction of the drain tube and configured to circumscribe the drain tube, equipped with optical cables and pressure wave detectors to measure and localize the scintillation.

7. A nuclear detector assembly as recited in claim 5, wherein the detector detector load structure has a substantially conical shape that extends along the operative portion to allow the signal transport systems to cover the entire length of the measurement device.

8. A nuclear detector assembly as recited in claim 5, wherein the detector layer includes a plurality of rectangular elements, each element having one side aligned along the axial direction of the drain tube.

9. A nuclear detector assembly as recited in claim 5, wherein the cross-sectional diameter of the tube decreases as an axial distance from the inlet increases.

10. A nuclear detector assembly as recited in claim 9, further including one or more radial levers for pushing the disks along the axial direction toward the inlet end thereby compensating for a loss of reactivity due to a detector burnup process.

11. A nuclear detector assembly as recited in claim 6, wherein the thickness of each fission enhanced detecting element embedded in the structure is less than a effective length, said effective length being a distance that the fission products can move in a detector element formed of the detector structure.

12. A nuclear detector assembly as recited in claim 11, wherein each detector element includes a detector film coated with at least one CIci layer unit and wherein the CIci layer unit includes a higher electron density among available electricity conductive materials layer, a first insulating layer, a lower electron density layer than the first conductor, and a second insulating layer.

13. A nuclear detector assembly as recited in claim 5, wherein the disk like detecting structure is formed of one or more sub-layers, each sub-layer including a two dimensional mesh made of conducting wires and detector beads located in knots of the mesh.

14. A nuclear detector assembly as recited in claim 13, wherein each detecting bead is coated with at least one CIci layer unit and wherein the CIci layer unit includes a conductive layer “C”, a first insulating layer “I”, a lower than “C” electron density conductive layer “c”, and a second insulating layer “i”.

15. A nuclear detector assembly as recited in claim 6, wherein the disk like structure is formed of one or more sub-layers, each sub-layer including a three dimensional mesh made of conducting wires and detector beads located in knots of the mesh.

16. A nuclear detector assembly as recited in claim 15, wherein each detector bead is made of different materials with different spectral radiation response.

17. A device for converting fission energy into electrical energy developed according claim 1, comprising:
a detector layer for generating fission products by fission reactions;
one or more CIci layer units stacked on the detector layer, each said CIci layer unit including a higher electron density among available electricity conductive materials layer, a first insulating layer, a lower than the first conductor electron density layer, and a second insulating layer; and
an electrical circuit coupled to the high and low electron density layers and operative to harvest electrical energy,
wherein the fission products generate electron showers in the detector layer and the high electron density layer and wherein the low electron density layer absorbs the electron showers.

18. A tile for converting particle and radiation energy into electrical energy, comprising:
a first layer including one or more CIci layer units, each said CIci layer unit including a higher electron density among available electricity conductive materials layer, a first insulating layer, a lower than the first conductor electron density layer, and a second insulating layer, the first layer being operative to absorb a first portion of particles and radiations moving toward the surface thereof and to convert the energy of the first portion into electrical energy;
a second layer formed over the first layer and including one or more CIci layer units and being operative to absorb a second portion of particles and radiations that have passed through the first layer and to convert the second portion into electrical energy; and
a third layer formed over the second layer and including one or more CIci layer units and operative to capture neutrons that have passed through the first and second layers and to convert the energy of neutrons into electrical energy.

19. A tile as recited in claim 18, used to cover a micro-bead scintillation neutron, gamma detector measuring the particles hitting the surface thereof.

20. A tile as recited in claim 19, wherein the third layer includes actinides and wherein the neutrons and actinides generate fission reactions to amplify the energy of neutrons.

21. A detector tile as recited in claim 18, wherein the tile operates under a cryogenic environment, further comprising one or more lateral conductor-and-cooling separators surrounding the side edges of the first, second and third layers.

22. A device for detecting radiation direction type, energy and position according to claim 18 based on a Direct Energy Conversion Matrix plate detectors, and nano-structured direct extraction detector units integrated in a electronic assembly.

23. A device as recited in claim 22, wherein the fissile material is used in correlation with scintaillation liquid and detectors to enhance the detection sensitivity for neutrons, hard gamma and protons able of inducing fission or transmutation.

24. A nuclear detector pellet, comprising:
a generally cylindrical cladding layer;
a metal grid covering a first transverse cross section of the cladding layer;
a lower support covering a second transverse cross section of the cladding layer; and
nuclear detector nano-grains filling a space bounded by the cladding layer, metal grid and lower support and capable of generating transmutation reactions,
wherein liquid flows through the cladding layer and thereby washes the nano-grains and carries recoils generated by the transmutation reactions.
